(19) United States
(12) Patent Application Publication
(10) Pub. No.: US 2015/0302766 A1
(43) Pub. Date: Oct. 22, 2015

(54) RECOVERY SYSTEM AND METHOD

(71) Applicant: Trainer RX, Inc., Alamo, CA (US)

(72) Inventors: Michael Albert Oberlander, Alamo, CA (US); Allison Brook Campbell, Danville, CA (US); Bruce Edward Morgan, San Jose, CA (US); Christopher J. Hughes, Alamo, CA (US)

(21) Appl. No.: 14/690,782

(22) Filed: Apr. 20, 2015

Related U.S. Application Data
(60) Provisional application No. 61/981,925, filed on Apr. 21, 2014.

(51) Int. Cl. G09B 19/00; G09B 5/00

(52) U.S. Cl. CPC G09B 19/003; G09B 5/00

(57) ABSTRACT

A recovery system and method which enables healthcare providers to provide customized interactive on-demand exercise sessions to their patients for the recovery of their patients suffering from injuries. The recovery system and method assists each patient in that patient's recovery by electronically providing the patient a customized series of individualized dynamically created exercise sessions. Each exercise session provides the patient exercises for the patient's recovery based on that patient's specific injury and the feedback provided by the patient during and after each previous exercise session. The recovery system and method enables the healthcare provider to prescribe an individual recovery pathway for each patient, monitor the patient's progress through the recovery pathway, monitor how the system changes the recovery pathway for the patient based on feedback from the patient during the recovery process, communicate with the patient during the recovery process, and document the recovery process for necessary electronic health records.

### PRIORITY CLAIM

This application claims priority to and the benefit of U.S. Provisional Patent Application No. 61/981,925, filed on Apr. 21, 2014, the entire contents of which are incorporated herein by reference.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND

Millions of people incur or develop physical injuries or ailments such as musculoskeletal injuries every year. A musculoskeletal injury typically includes an injury to one or more bones, joints, muscles, ligaments, and/or tendons. People who are more physically active or participate in more sporting or athletic activities (including professional, amateur, and recreational athletes) tend to incur more musculoskeletal injuries.

For example, in the United States, there are thousands of healthcare providers who either treat musculoskeletal injuries in the form of orthopedic injuries exclusively or see orthopedic injuries as a significant percentage of their medical practice. Approximately 28,000 healthcare providers in the United States are orthopedic surgeons. Orthopedic surgeons in the United States performed approximately 5.3 million surgeries in 2010. By 2020, that number is projected to grow to approximately 6.6 million surgeries in the United States. These numbers significantly increase throughout the world. Many of these orthopedic surgeries require the patient to undergo post surgery rehabilitation and recovery.

Many musculoskeletal injuries do not require surgical treatment. According to a 2009 National Hospital Ambulatory Medical Care Survey, approximately 136.1 million people in the United States sought care in approximately 4,900 hospital emergency departments. Approximately 45.4 million of those people sustained injuries (the majority of which were orthopedic in nature). Many of those injuries did not require orthopedic surgery, but required the patient to undergo some form of recovery (which in various instances includes rehabilitation for purposes of this application).

It is literally impossible for any healthcare provider to know the best recovery treatment for every patient that incurs any single type of injury. Thus, there is a need for an automated system that assists each patient in the patient's recovery, and that provides the appropriate recovery instructions for the patient at the appropriate speed for that injury of that patient.

Another related problem with recovery from musculoskeletal injury is that when a person suffers a musculoskeletal injury, the person faces many questions, decisions, and issues regarding the person's diagnosis, activities, treatment, and recovery. These questions, decisions, and issues include, but are not limited to: (1) whether to seek medical treatment; (2) who to seek medical treatment from; and (3) which medical treatment option(s) are viable. After a musculoskeletal injury occurs, a person (whether or not an athlete) may: (1) ask for the opinions on how to treat the musculoskeletal injury from family, friends, coaches, or other influential people; and (2) conduct their own research (such as by searching on the Internet).

The questions, decisions, and issues the injured person faces also include, but are not limited to: (1) how to recover from medical treatment(s) (such as surgery); (2) how to know that the person is taking the correct steps in the person's recovery on a daily basis what to do and equally important what not to do; (3) how to communicate with the person's healthcare provider(s) regarding the person issues related to recovery; and (4) how to know when it is safe and appropriate for the person to resume normal activities, work activities, and sporting or athletic or physical activities.

For example, in many instances, the healthcare provider advises the injured patient to refrain from continued participation in the activity that caused or could have caused the musculoskeletal injury. While rest can be an appropriate short-term recovery strategy, it is most often not the solution to recovery. Patients must ready themselves to return to the activity that caused the injury, so as to avoid reinjures. During a period of protracted inactivity, the patient is likely to become de-conditioned. This situation makes the patient vulnerable to re-injury upon the attempted return to the activity that caused the original injury. While this is especially true in sports, it too has application to the more traditional work environments.

Determining safe and appropriate guidelines for each patient's return to a physical activity (such as an athlete returning to a sport) is far from an exact science. In many instances, the decision is based on the patient's own subjective assessment of the patient's ability to return to the physical activity (such as athlete's own subjective assessment of the athlete's ability to play a sport). Relying on such self-assessment is fraught with problems for both the patient (and for certain athletes the team for which the patient plays). This is especially true for those whose injuries that require surgical treatment. In such cases, the short term aftercare and longer term recovery must be especially methodical.

Thus, there is a need for an automated system that assist patients in addressing these questions, decisions, and issues regarding recovery and resumption of physical activities, and specifically, there is a need for an automated system that breaks this cycle of injury-reinjury and increases the likelihood that the patient's return to the physical activity that caused the injury will not be marred by a recurrence of the original injury or another related injury.

Two additional related problems with recovery from musculoskeletal injury are: (1) the healthcare provider's potential failure to provide the patient with appropriate post-operative or other patient guide to recovery or self care instructions; and (2) the patient's ability to understand and follow such instructions. These instructions are often given both orally and in writing so as to minimize confusion related to what the patient should, and should not do. Topics typically covered with these instructions are typically very brief and poorly delivered but include: (1) self-care activities; (2) diet recommendations; (3) medication schedules; (4) home exercise programs; (5) the use of slings, braces, or other supportive devices; and (6) follow-up appointments. In spite of the healthcare provider's best intentions, it is not uncommon for the patient to fail to understand or comply with one or more of those instructions. Thus, there is a need for an automated system that assists patients in recovery of musculoskeletal injury while providing enhanced patient instructions thus increasing the likelihood of patient compliance.

Another related problem with recovery from musculoskeletal injury is the ability of the healthcare provider to have the time or the ability to properly monitor the patient's recovery. For example, many orthopedic surgeons treat fifty to one hundred fifty patients per week. In addition to treating these patients, orthopedic surgeons have many other time consuming responsibilities including but not limited to: (1) administrative duties within the office or hospital; (2) emergency room coverage; (3) medical supervision of athletic participation in the training room or on the athletic field; (4) clinical or bench research projects; (5) review of ancillary diagnostic tests; (6) teaching; and (7) participation in committee meetings within the hospital or ones within a doctor's practice. This makes it physically impossible for the many healthcare providers such as orthopedic surgeons to use the known or current systems and methods to monitor the day to day recovery of each of their patients and to participate in the determinations of when each patient is ready to return to a designated physical activity (such as the physical activity that caused the injury to the patient), or to advance activities within a rehabilitative course.

Another related problem with recovery of a musculoskeletal injury is the fact that each healthcare provider is influenced (if not dictated) by the healthcare providers own past experience with that specific type of injury. It is literally impossible to keep up on the literature for each musculoskeletal injury and modify ones individual or group protocols on a regular basis. Thus, there is a need for an automated system that assists patients, doctors, and all medical personnel in regularly updating their recovery treatment protocols and evidence based research for musculoskeletal injury. Likewise, there is a need for a regularly updated automated system for providing enhanced instructions and education to patients and for monitoring patients review or participation thus encouraging increased patient compliance. There is also a need for a automated system which enables patients to take a more active role in the recovery and treatment of their own injuries and assume responsibility in their ultimate outcome. A patient who is passive about rehabilitative participation will typically have a less ideal result than one that actively engages in the understanding their injury and actively participates in their own recovery. There is thus a need for an automated system which provides the patient with the ability to monitor the patient's progress in real time with programs that encourage engagement of patient participation in recovery while also providing educational material regarding the do's, don'ts, and frequently asked questions to improve patient outcome by improving clarity of the vast amount of novel material essential for understanding ones illness or injury.

Another problem with recovery from musculoskeletal injury is the current electronic medical record (“EHR”) systems. Regardless of the perceived purposes of EHR systems, and in spite of the obstacles to universal acceptance of EHR systems, EHR systems will in the near future be part of almost all medical practices in the United States and many other parts of the world. Thus, there is a need for an automated system that assists patients in recovery of musculoskeletal injury while properly operating with or communicating with the EHR systems. There is a need for an automated system recovery system that records data for the patient, makes that data available to the healthcare provider that has collected and entered various patient data into the system, and makes the data available to any and all healthcare providers deemed appropriate by the patient to view and add to the database. Only when these systems are made to communicate with one another shall a truly universal electronic medical record (EHR) exists which benefits the patient anytime, anywhere, and anyplace. When such a shared record exists, the patient, doctor and health system at large will benefit in improved care and tremendous health care savings.

Another problem with recovery from musculoskeletal injury is the current methods of communication between healthcare providers and patients. Presently, the most common method of communication is in office visits and over the telephone with the doctor or healthcare provider and the patient directly. This is expensive and time inefficient for the doctor and patient alike. Thus, there is a need for an automated system that assist patients in recovery of injury while providing enhanced communication between the patients and their healthcare providers to enhance the recovery process. There is also a need for an automated system that provides the ability to communicate a patient's progress to the patient, therapist and doctor or healthcare provider to encourage ideal monitoring of a patient's condition and advancement through their rehabilitative or recovery process. It is equally if not more critical to be able to communicate with all members of the healthcare provider team if an untold situation arises such as a complication or mal occurrence. Such situations can more easily, efficiently and effectively be treated at the early onset of an event before a full-blown complication occurs. This can easily prevent an unwanted trip to the emergency room or readmission to the hospital. Existing secure Health Insurance Portability and Accountability Act (known as “HIPAA”) compliant email and messaging currently enables certain efficient and appropriate remedies to medical questions, urgencies, or emergencies. However, presently, only large institutions and teaching facilities have such tools available to their patients. Thus, there is a need to for an automated recovery system that provides such communication tools to patients during the recovery process.

Another problem with recovery from musculoskeletal injury is the current healthcare provider compensation and reimbursement systems and methods. Patient participation in formal physical therapy is effective yet often expensive and time consuming. Patients must obtain a prescription from the healthcare provider to see a physical therapist. The patient must then find a therapist that is contracted with his/her health plan, make an appointment and take time off of work or school to attend such an appointment. Ideal times to minimize time lost from these activities are difficult to obtain. Patients are also now being required to pay more out of pocket expenses for each visit in addition to cost related to time lost from work, school and other activities. There is also the expense and inconvenience of travel to such appointments. Insurance companies are not authorizing treatment or payment of certain conditions and if they do, the number of visits/year and per diagnosis is being significantly diminished. Thus, there is a need for a system that assists patients in recovery of musculoskeletal injury while operating within healthcare compensation and reimbursement systems. An automated system that enables patients to be seen by physical therapists at critical time periods during the recovery process while monitoring a patient's progress through the process is thus needed by all parties. There is also a need for an automated system that advances the patient through a recovery process in real time based on patient responses to questions posed by the system after completing each exercise.

Another problem with recovery from musculoskeletal injury is that healthcare provider compensation or reimbursement systems are increasingly being tied to achieving established performance standards, outcomes, and benchmarks. Whether generated by the government, private insurance companies, or their own specialty societies or groups, healthcare providers (such as physicians) are increasing being held more accountable for meeting or exceeding these metrics. In the next three to five years, orthopedic societies (such as AAOS, AANA, and AOSSM) are informing the members that orthopedic doctors must incorporate validated outcome measures within their practices to be able to maintain their present reimbursement or more notably less decreases. Such information will be essential to present to third party payors to limit much greater decline in reimbursement. Such programs are now being purchased to begin collection of this soon to be requisite data. So too will be the need to implement patient satisfaction surveys to demonstrate the personalized care and compassion for patients with in practice settings. Thus, there is also a need for an automated system that assists patients in recovery of musculoskeletal injury while operating within the declines of healthcare compensation and reimbursement systems that are tied to achieving and proving achievement of established performance standards, outcomes, and benchmarks.

### SUMMARY

Various embodiments of the automated recovery system and method of the present disclosure solve the above problems by providing healthcare providers a system and method to employ for their patients which provides customized on-demand interactive rehabilitative sessions to their patients for the recovery of the patients suffering from injuries or other physical ailments such as but not limited to musculoskeletal injuries (including patients suffering from one or more diseases which cause injury or inhibit recovery from injury). Musculoskeletal injuries are used in this application as a primary example of how the recovery system and method of the present disclosure operates; however, it should be appreciated that the present disclosure is not limited to being used for recovery for musculoskeletal injuries.

Generally, the recovery system and method of the present disclosure enables the healthcare provider to: (1) select, provide, and/or prescribe an individual recovery pathway for each patient; (2) monitor the patient's progress through the recovery pathway; (3) determine how the recovery system changes the recovery pathway for the patient based on feedback from the patient during each exercise session; (4) communicate with the patient during the recovery process; and (5) document the recovery process for necessary medical records (such as for EHR systems).

More specifically, the recovery system and method of the present disclosure assists each patient in that patient's recovery by providing a customizable recovery pathway for that patient which is used to dynamically form a series of individualized exercise sessions for the patient that are then part of and make up the recovery pathway. The recovery system and method utilizes an initial recovery pathway (selected by the healthcare provider of the patient), dynamically selects exercises for each exercise session based on the then current recovery pathway and the exercises of that the recovery pathway available to be selected for that exercise session, receives feedback from the patient regarding each exercise of each exercise session (and/or each exercise session), and after receiving such feedback, modifies as necessary the current exercise session being provided to the patient and the then current recovery pathway for future exercise selection for future exercise sessions (in part by adjusting the availability of exercises to be selected from). Each exercise session provided by the recovery system and method to the patient provides the patient specific instructions on how to conduct each exercise of the exercise session, which is part of the recovery pathway. For purposes of this application, the term “exercise” includes any physical activity including but not limited to a range of motion exercise, a strengthening exercise, a stretching exercise, a proprioception exercise, and therapeutic modalities or supporting procedures (such as but not limited to stimulation activities, massaging activities, heating activities, cooling activities, ultrasound treatment activities, and electrical stimulation activities). Each of these different types of exercises has a specifically different purpose in the recovery process. The recovery system provides the patient specific instructions for performing each exercise of the exercise session of the recovery pathway in one or more forms such as audio-video instructions, audio instructions, video or visual instructions, and textual or written instructions.

The recovery system and method of the present disclosure employs an exercise selection algorithm to dynamically select each exercise for each exercise session for the patient from the recovery pathway for that patient. More specifically, the exercise selection algorithm applies a predefined set of rules or rule set applicable for the exercise selection to an exercise organizational structure of the recovery pathway. In one embodiment, each recovery pathway has an exercise organizational structure that includes or is made up of exercises organized in a plurality of exercise categories, where each category includes or is made up of one or more exercises, and each exercise is associated with a predefined level of difficulty (in that recovery pathway for that patient). This exercise organizational structure of the recovery pathway and the rule set are configured to take into account: (1) the patient's specific injury; (2) known proven exercises which are useful for recovery of the patient's specific injury; (3) the prescription for the recovery pathway selected or provided by the healthcare provider treating that patient; (4) any modifications to the prescribed or selected recovery pathway for the patient provided by the healthcare provider treating that patient and monitoring the results of each of the exercise sessions of the patient; (5) information and feedback provided by the patient after the patient conducts or performs each exercise of the each exercise session; and (6) the progress of the patient during each previous exercise session.

The recovery system and method of various embodiments of the present disclosure automatically takes the biology of healing into account by placing a governor on the recovery pathways so that a patient cannot progress or access rehabilitative information/exercise in advance of an acceptable time period and/or recovery stage. This time period and/or recovery stage is based on the literature and body of knowledge on the subject of tissue healing for that particular recovery pathway. In various embodiments, the only way for the patient to advance beyond that stage of exercise delivery is for the healthcare provider themselves to override the recovery system.

The exercise selection algorithm is thus based in part on the biologic feedback from the patient in the performance of the selected exercise of the patient's recovery pathway provided by the recovery system and method of the present disclosure as described in further detail below. It should be appreciated that the exercise selection algorithm may not select every exercise from every category of the recovery pathway for the exercise sessions provided to the patient and that the patient may complete the recovery pathway without performing one or more exercises in one or more categories of the recovery pathway in accordance with the present disclosure. It should also be appreciated that for different patients with the same injury, the recovery pathways may be different based at least on that patient's physical characteristics.

The recovery system and method of the present disclosure breaks the cycle of injury-reinjury (described above) by: (1) selectively guiding the patient through exercises of the patient's recovery pathway; (2) preparing the patient to meet the physical demands of at least one designated activity (such as the activity that caused the injury); (3) testing the patient's ability to meet the physical demands of the designated activity; (4) dynamically adjusting the patient's recovery pathway based on the patient's progress during each exercise session and after each exercise session; (5) keeping the patient informed of the patient's progress; and (6) keeping the patient's healthcare provider informed of the patient's progress. This information enables the patient's healthcare provider to determine and inform the patient when the patient is ready to resume the designated activity and when the patient's recovery is complete.

The recovery system and method thus serves as an automatically operated comprehensive bridge between the gap between physical therapy and a return to a physical activity (such as work or a sport) in part by providing the patient specific instructions on how to perform each of the selected exercises needed for recovery and intended to assess a patient's readiness to resume the pre-injury activity, and obtaining biologic feedback from the patient on each exercise and/or each exercise session.

The recovery system and method also enables the healthcare provider to utilize existing exercise modules and to create a customized dynamic recovery pathway where each exercise session for the patient's recovery is based on that recovery pathway.

This recovery system of the present disclosure adjusts patient's recovery program dynamically based on the patient's responses to questions posed after each exercise and/or after each exercise session. If the patient provides feedback after each exercise in an exercise session, the recovery system can also dynamically adjust the rest of that exercise session (including exercises available for selection for that exercise session).

More specifically, the recovery system of the present disclosure asks the patient appropriate subjective questions during the recovery process that have been shown to provide accurate measurement of patient's outcome. Disease specific outcome measures via subjective questionnaires' have been validated in the literature in peer reviewed journals and are incorporated into the recovery system in an understandable method that encourages rapid recognition with color coded responses. Such techniques encourage increased participation and accuracy in completing the questionnaires especially for the marginally literate patient. The patient's ability to quickly and accurately answer these subjective questions improves the ability of healthcare professionally and others interested in such data to understand outcomes of both conservative and operative treatment alternatives. In various embodiments, the recovery system also collects, collates, and shares such information in a non patient specific identifying fashion to increase collective understanding of various treatment methodologies.

Various embodiments of the recovery system of the present disclosure provides peer reviewed medical information from the literature as well as direct links to the American academy of orthopedic surgeons web site based on the patient's diagnosis and/or surgical procedure. In various embodiments, recovery and surgical recovery programs are all audio, video and text based with explanations with copy written at the sixth grade level by professional copywriters to ensure that the majority of patients can understand the information provided by the recovery system. Studies have been done that show that only about ten to fifteen percent of information delivered at a doctor's office is comprehended. Much of the reason for this is that the vocabulary exceeds that of most patients. The present recovery system is thus configured to reverse that trend.

The recovery system and method of the present disclosure is configured to work for various different types of patients such as: (1) an athlete recovering from injury; (2) a worker returning to the job following injury; or (3) any other person trying to rehabilitate or recover from an injury or medical condition.

Various embodiments of the recovery system and method of the present disclosure are configured to work in conjunction with any suitable healthcare provider(s) including but not limited to: (1) a physician (such as a surgeon) overseeing the patient's recovery; (2) a physician assistant overseeing the patient's recovery; (3) a nurse overseeing the patient's recovery; and (4) a physical therapist monitoring a patient's recovery. For purposes of this application, the term healthcare provider is meant to include one or more of these people.

Other objects, features and advantages of the present invention will be apparent from the following detailed disclosure, taken in conjunction with the accompanying sheets of drawings, wherein like reference numerals refer to like part.

### BRIEF DESCRIPTION OF THE FIGURES

FIG. 1A is a schematic high level diagram of one embodiment of the recovery system of the present disclosure, and illustrating that the recovery system configured to communicate through a data network with a plurality of healthcare provider access devices, a plurality of patient access devices, a plurality of monitors, and at least one electronic health records system.

FIG. 1B is a high level chart showing the database scheme and the database model relationships of one example embodiment of the recovery system of the present disclosure.

FIG. 1C is a table illustrating the recovery pathway exercise structure or configuration of one example embodiment of the recovery system of the present disclosure.

FIGS. 1D to 1U are a table illustrating an example simulated recovery pathway for knee arthroscopy created by one example embodiment of the recovery system of the present disclosure.

FIGS. 2A and 2B are flowcharts generally illustrating the operation of one example embodiment of the recovery system of the present disclosure from the perspective of the patient.

FIG. 3 is a flowchart generally illustrating the operation of one example embodiment of the recovery system of the present disclosure from the perspective of the healthcare provider.

FIGS. 4A to 4V are a series of example interfaces or screen shots caused to be displayed to a patient via the patient access device by one example embodiment of the system of the present disclosure.

FIGS. 5A and 5B are flowcharts generally illustrating the operation of one example embodiment of the recovery system of the present disclosure, and specifically the process the recovery system uses to select exercises from the recovery pathway for the patient to build exercise sessions and to run or provide the built exercise sessions.

FIGS. 6A to 6K are a series of example interfaces or screen shots caused to be displayed to a healthcare provider via the healthcare provider access device by one example embodiment of the recovery system of the present disclosure.

### DETAILED DESCRIPTION

### System Configuration of Example Embodiment of Recovery System

Various example embodiments of the present disclosure provide a recovery system and method which generally includes one or more computers (such as servers) configured to communicate with one or more patient access devices and one or more healthcare provider access devices as further described below. For purposes of simplicity and brevity, this application primarily describes the recovery system and method of the present disclosure with respect to one healthcare provider and one patient. However, it should be appreciated that the recovery system of the present disclosure is meant to simultaneously work with many healthcare providers, many healthcare provider access devices, with many patients, and many patient access devices. The recovery system and method of the present disclosure is expandable to large quantities of healthcare providers and patients. It should be appreciated that, for implementation with multiple different healthcare providers and patients, the recovery system and method of the present disclosure will provide suitable secure segregation of patient data for patient privacy and security in accordance with applicable privacy and other legal or regulatory requirements (such as HIPAA compliance). It should also be appreciated that each exercise session and each exercise can be provided to the patient in accordance with applicable privacy and other legal or regulatory requirements (such as in a HIPAA compliant manner).

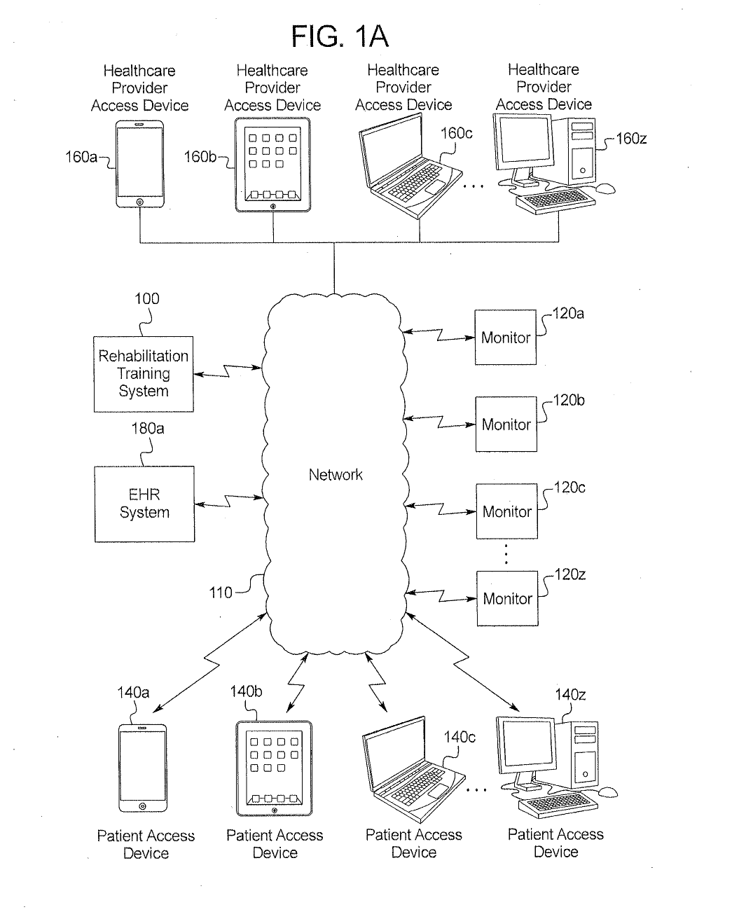

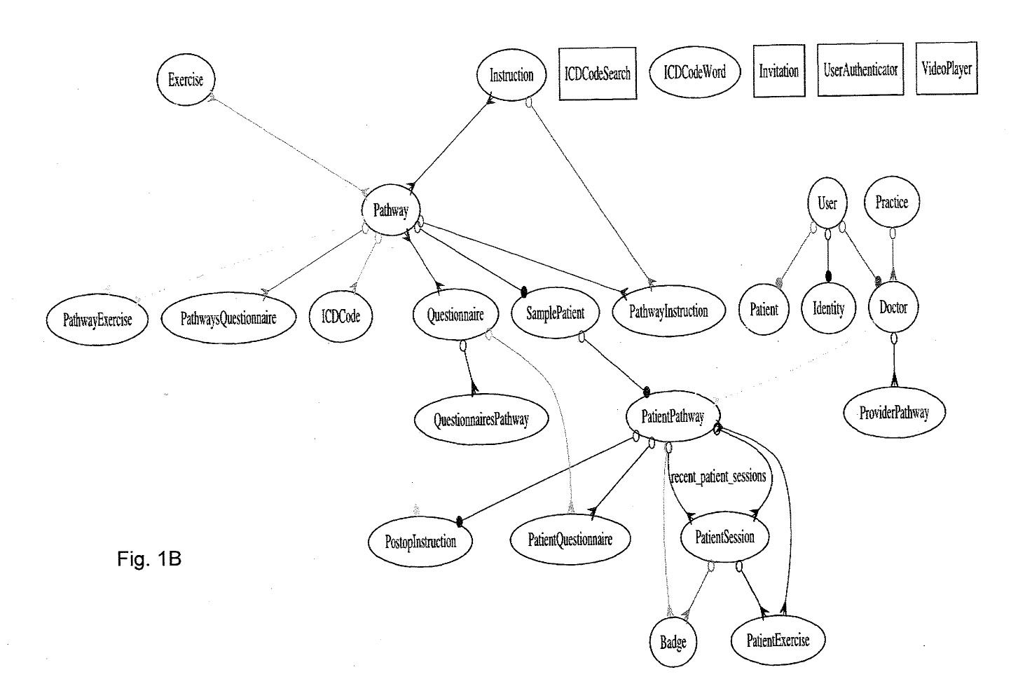

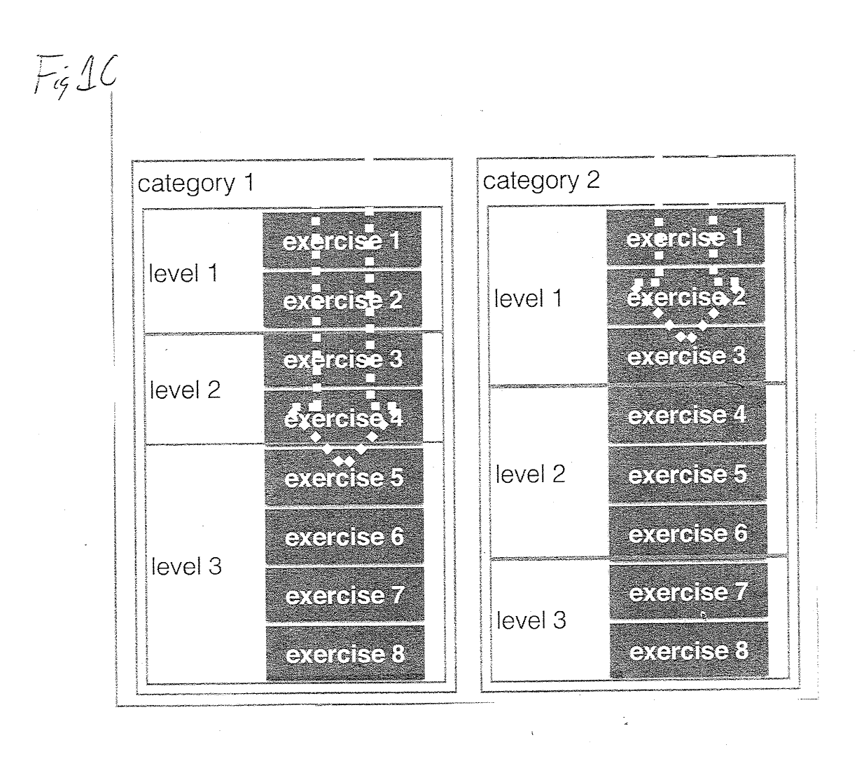

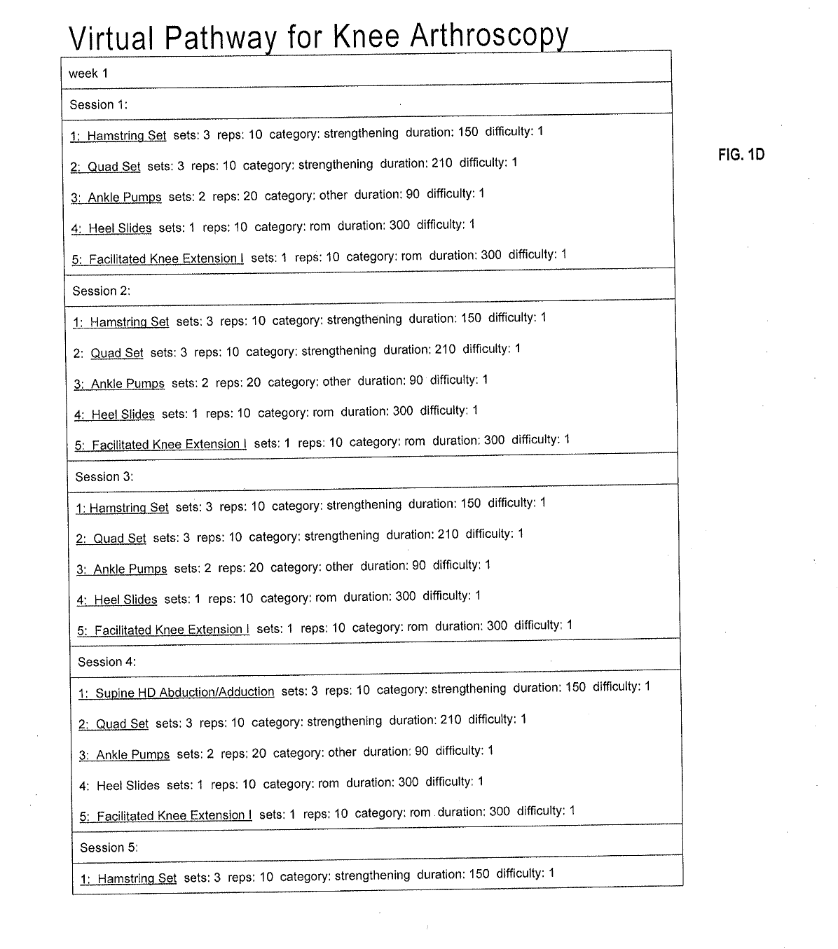

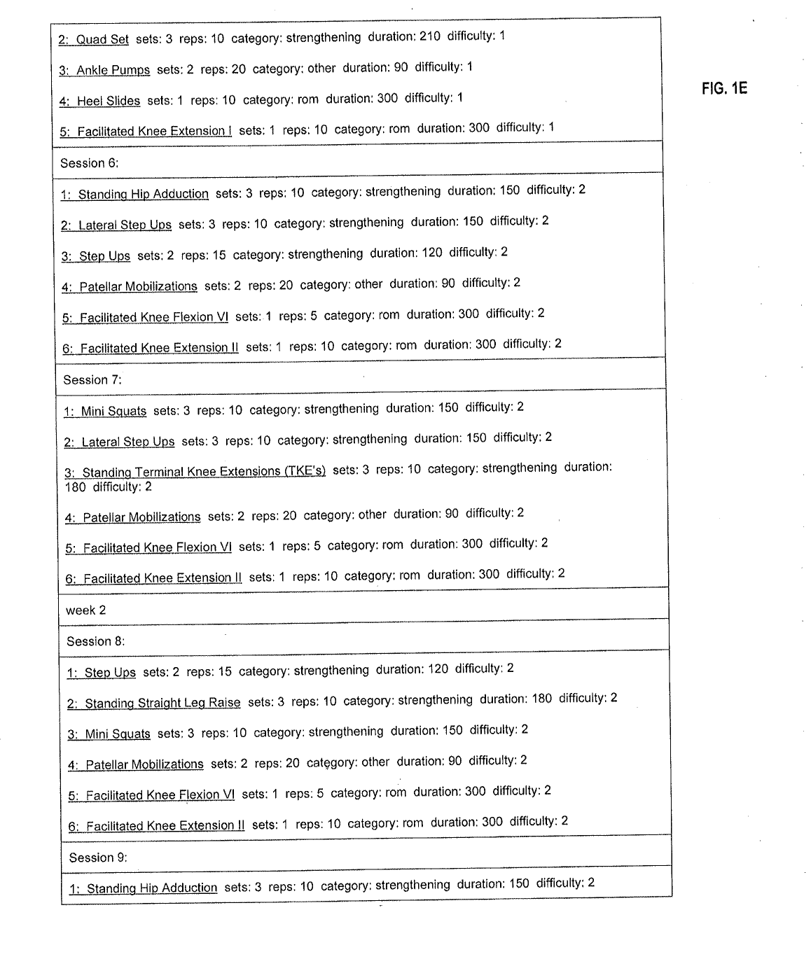

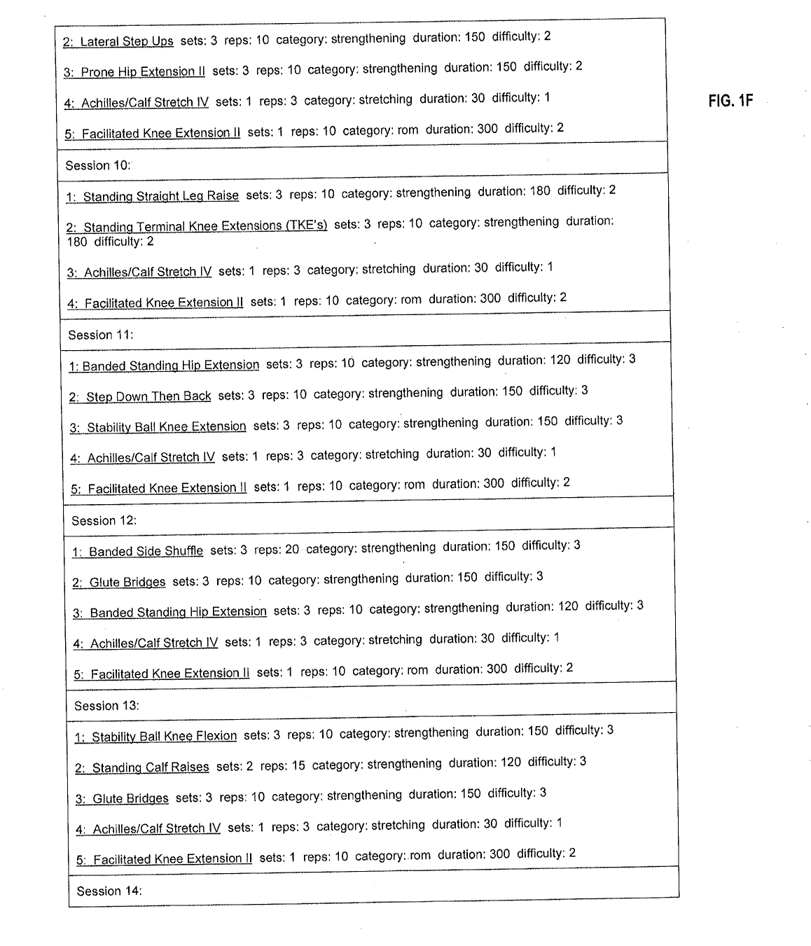

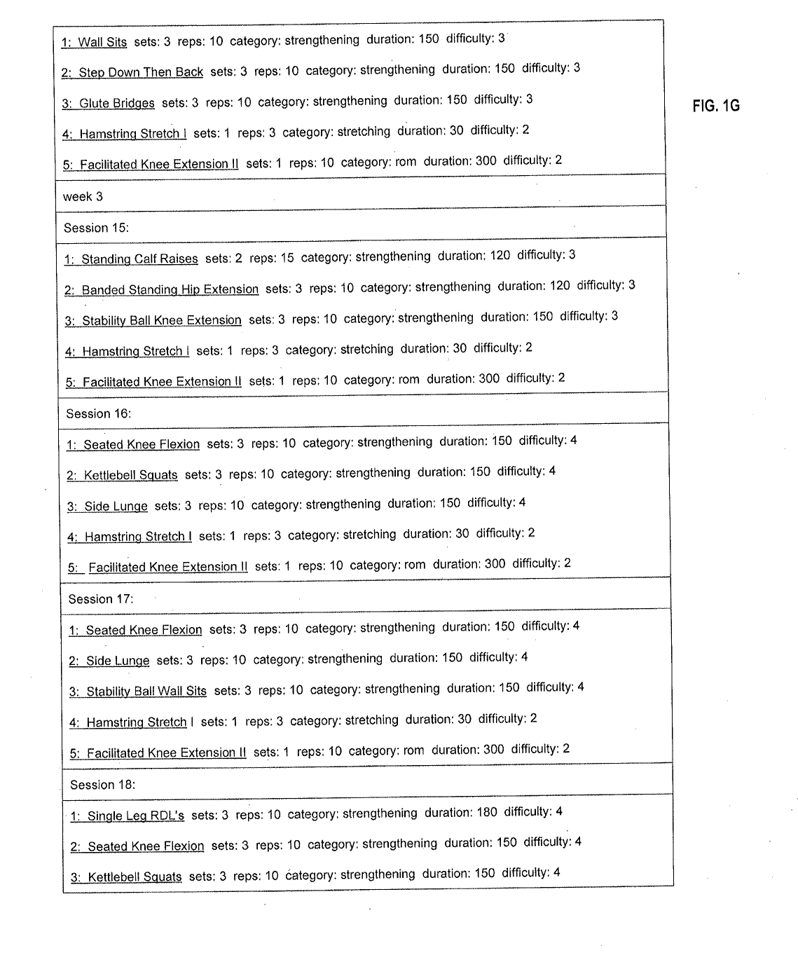

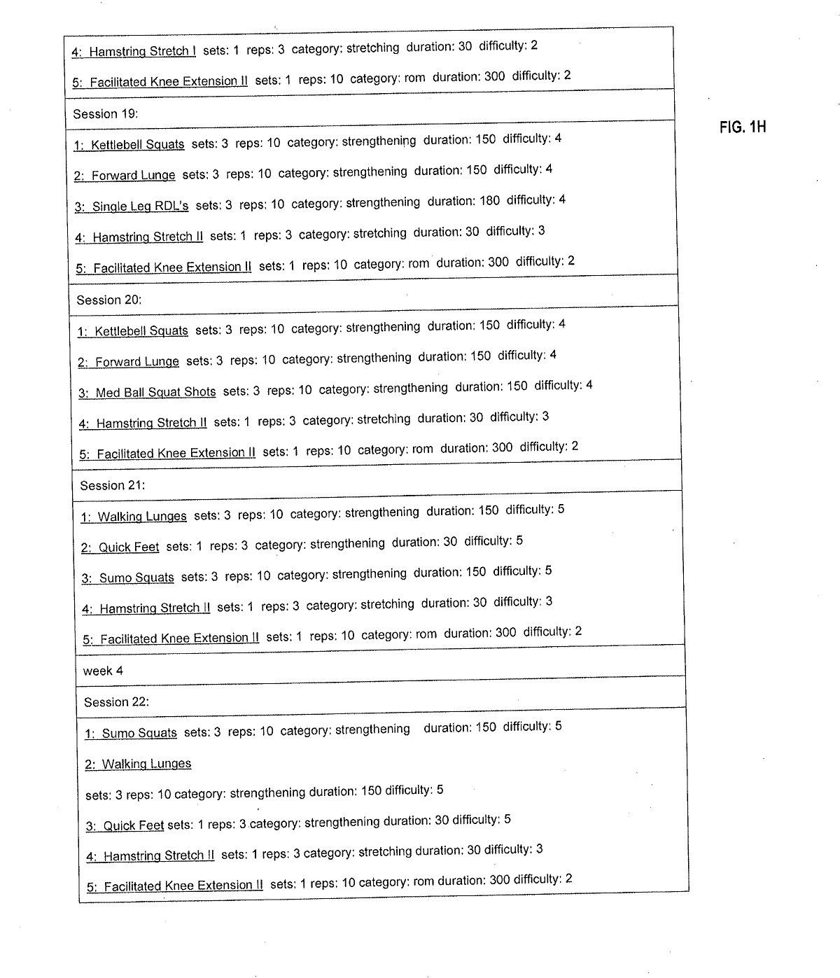

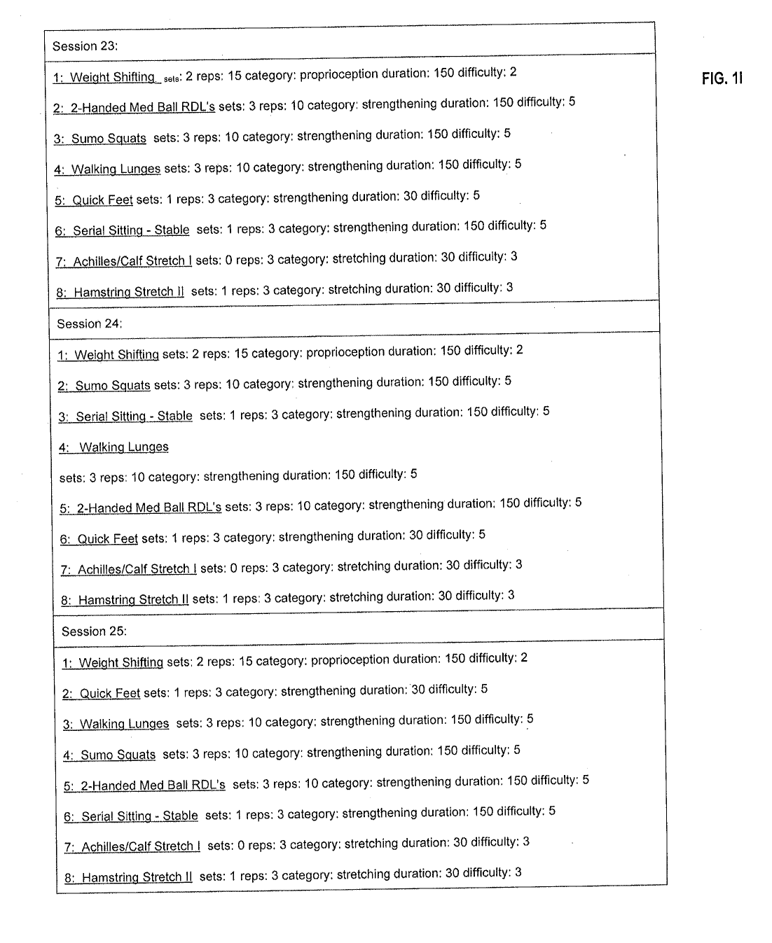

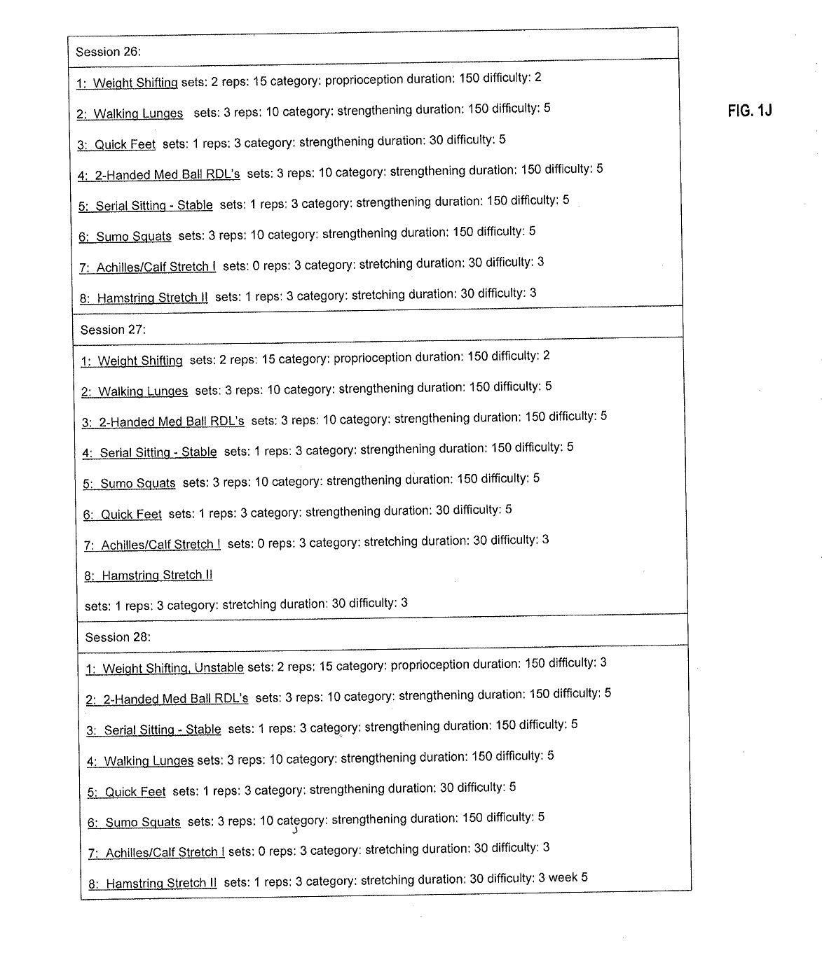

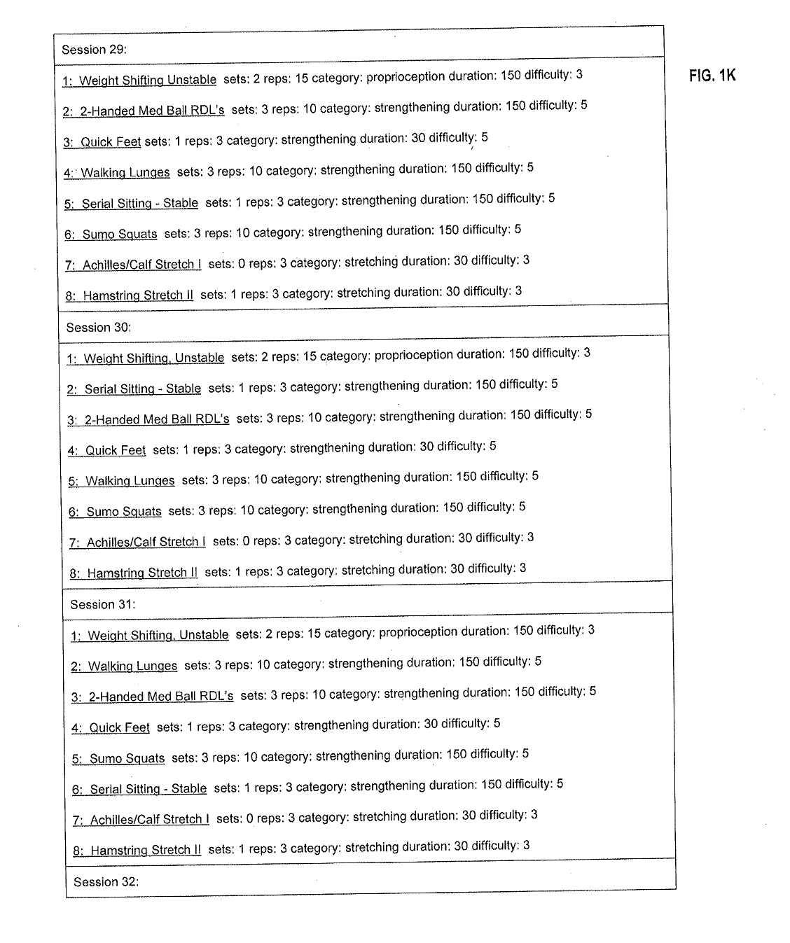

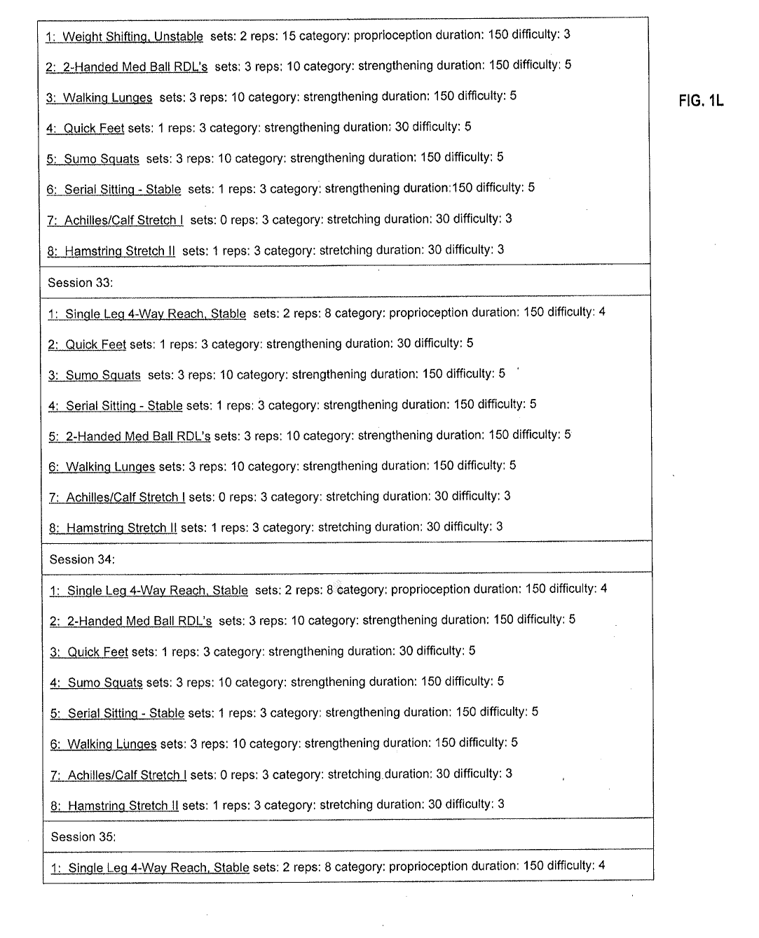

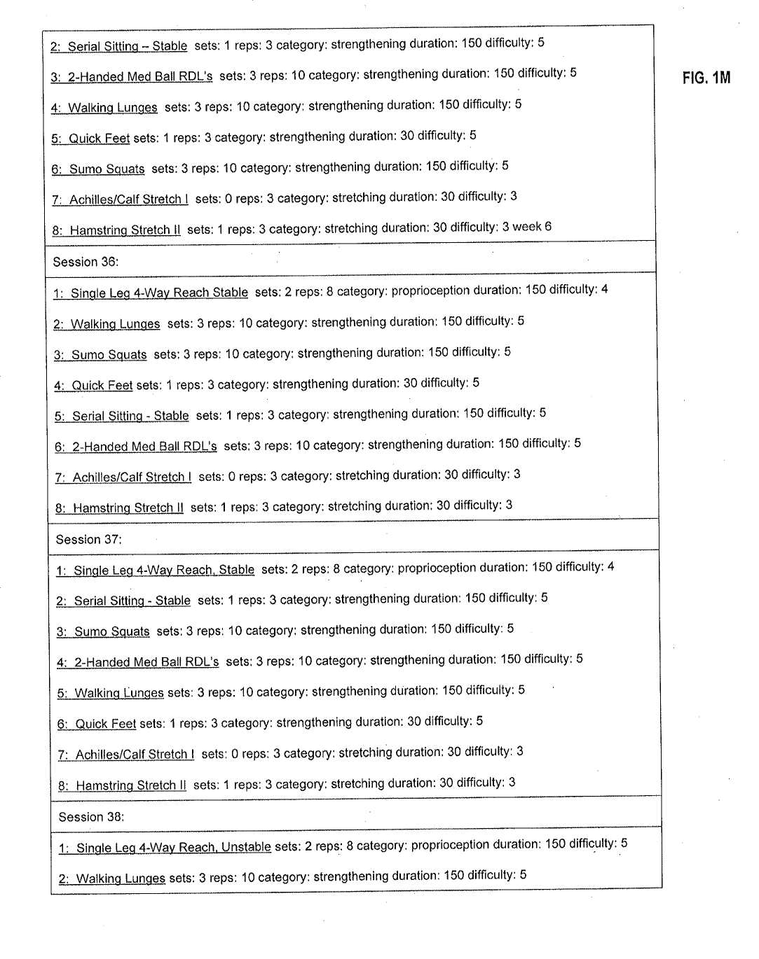

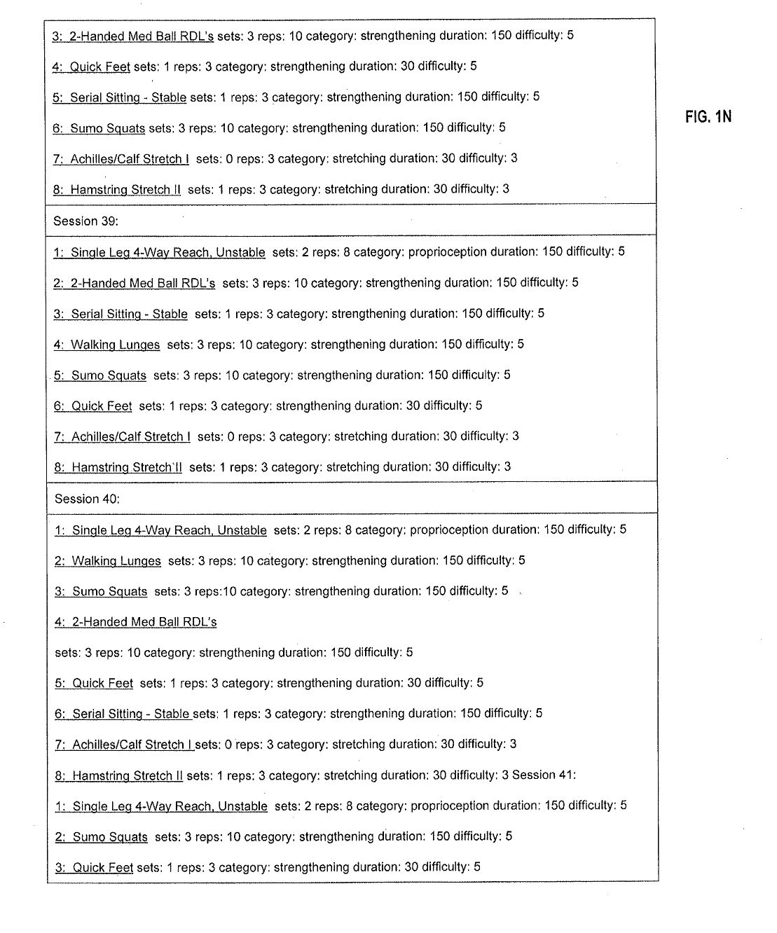

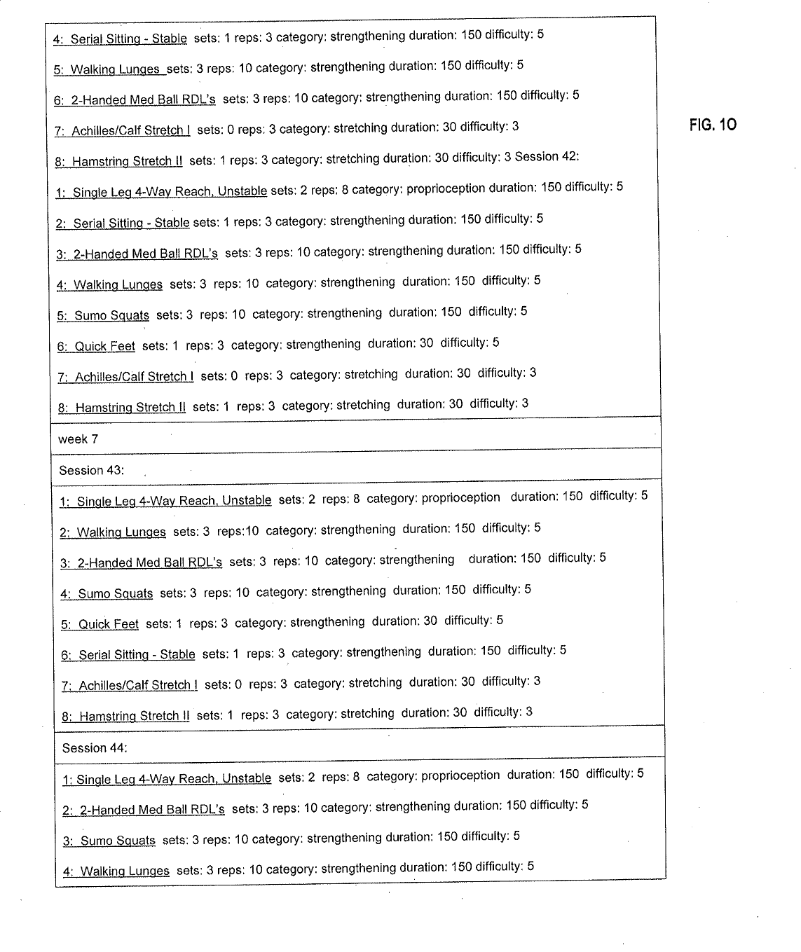

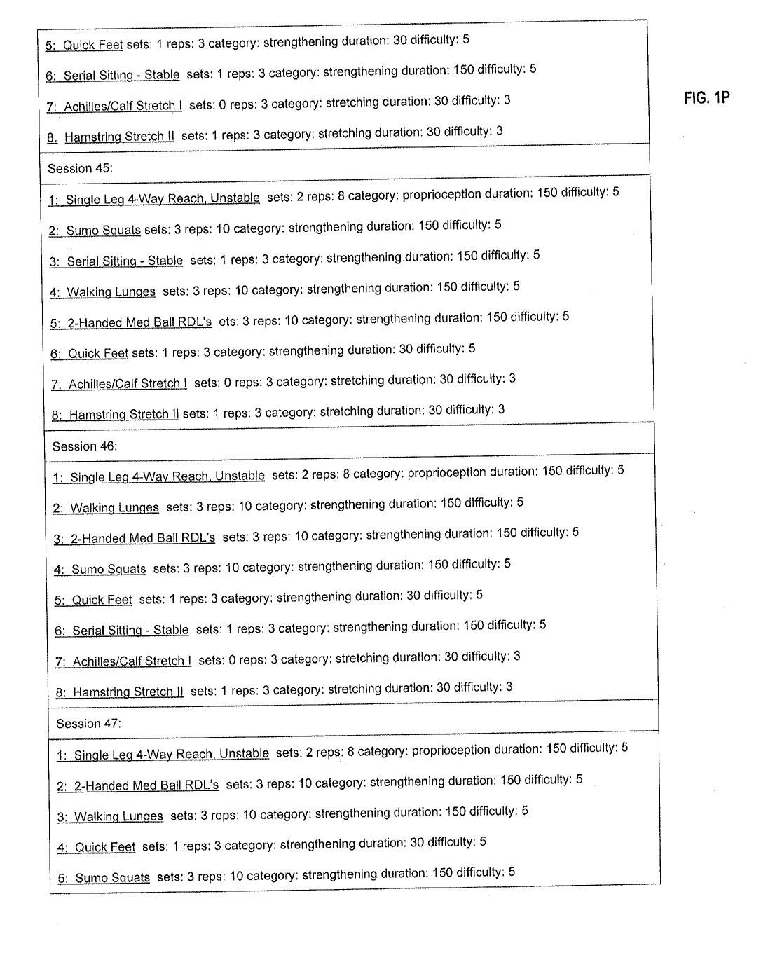

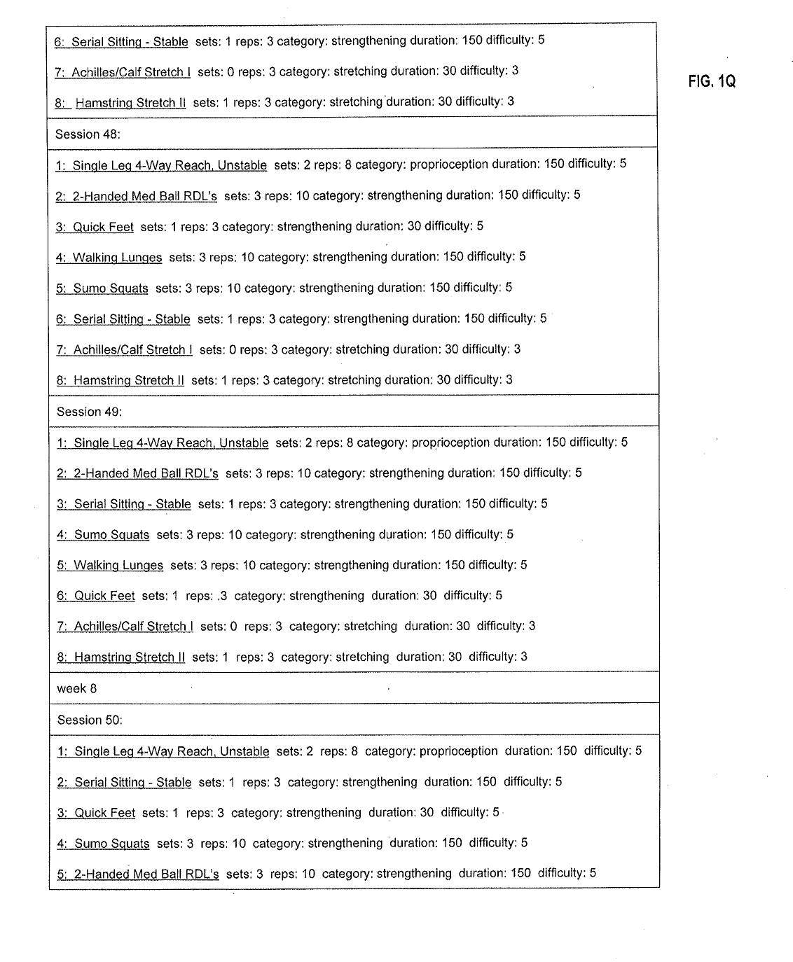

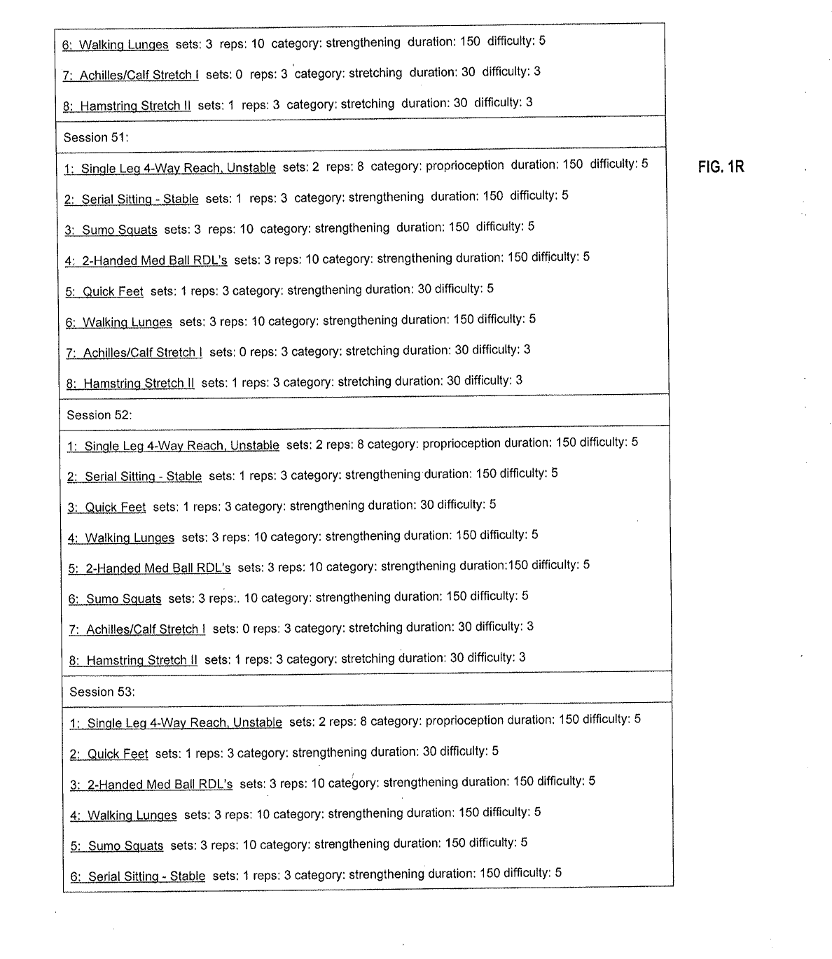

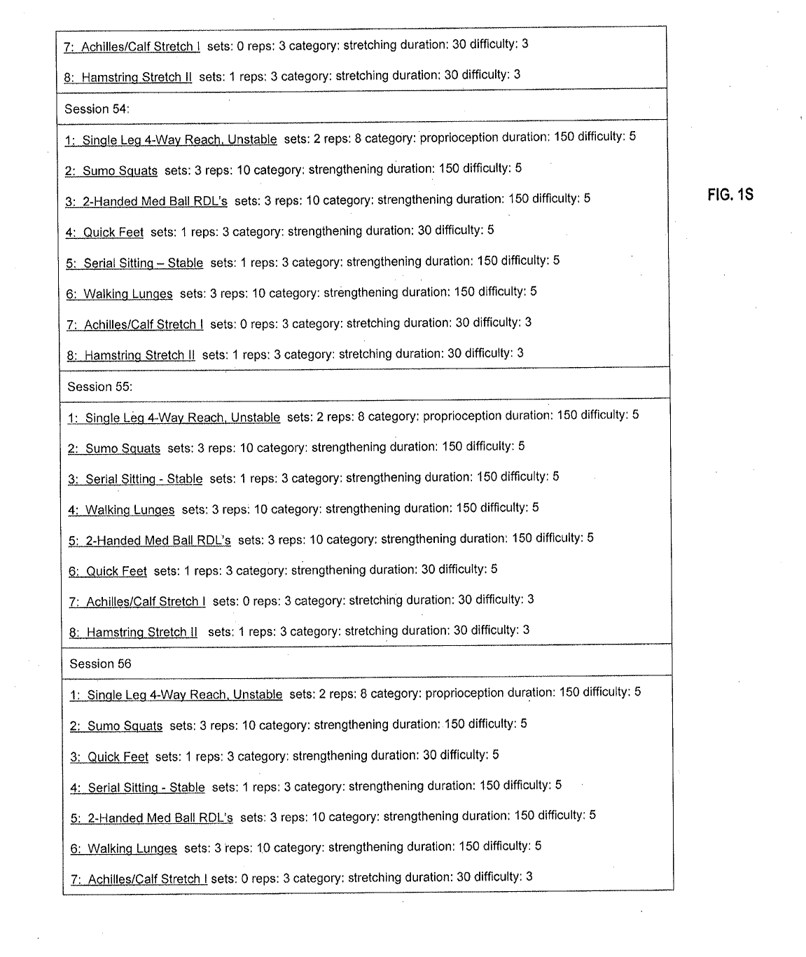

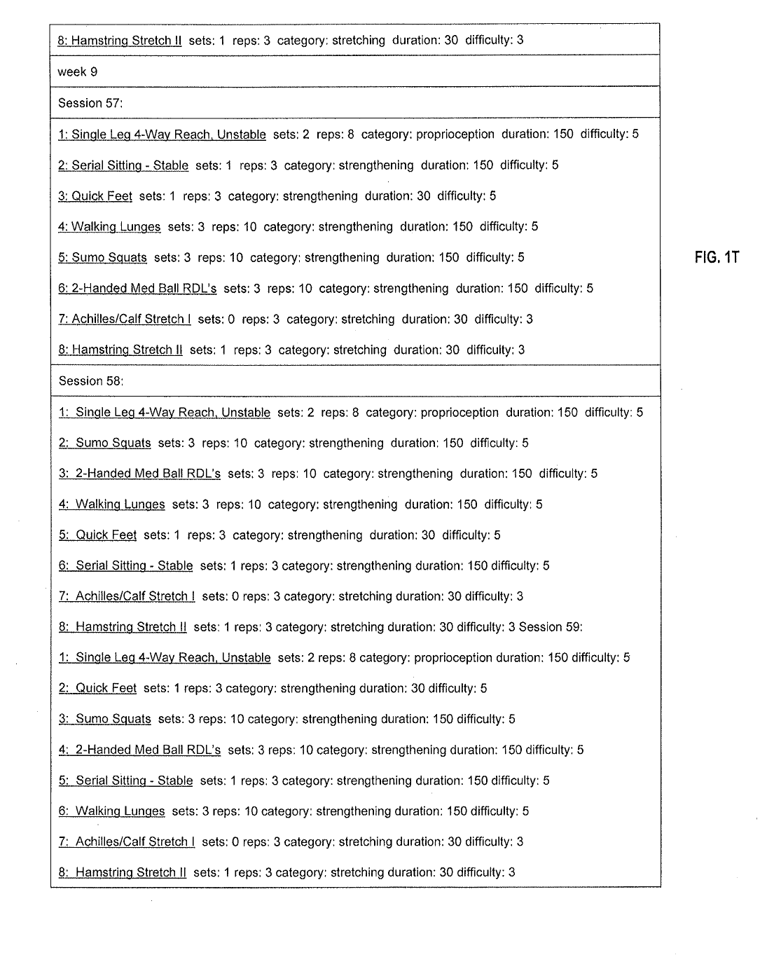

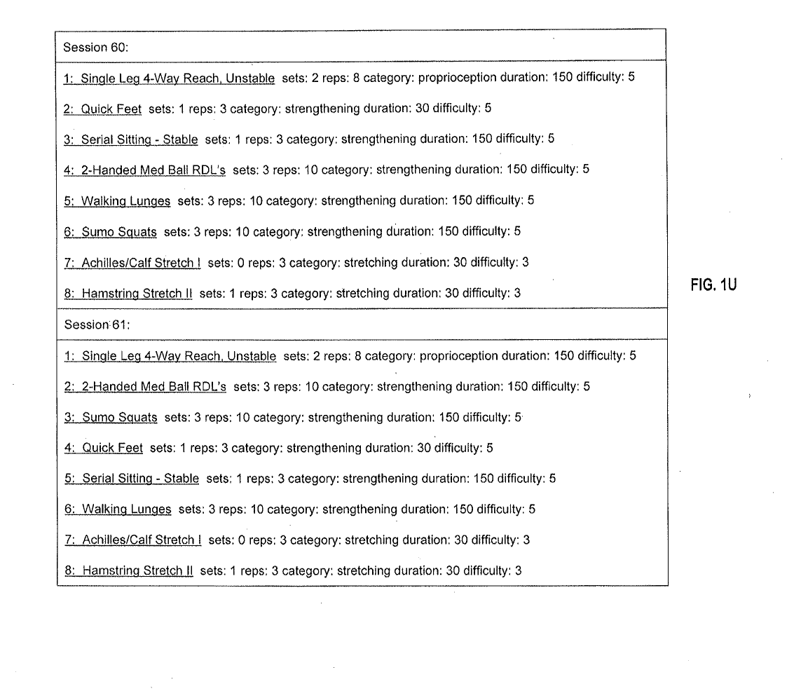

Referring now to FIG. 1A, one example embodiment of the recovery system of the present disclosure is generally illustrated and indicated by numeral 100. In this illustrated embodiment, the recovery system 100 includes one or more computers such as one or more servers (not shown in FIG. 1A) configured to communicate through a data network 110 (such as the internet) with: (a) a plurality patient exercise monitors 120a, 120b, 120c . . . 120z (such as personal wearable devices; (b) a plurality of patient access devices 140a, 140b, 140c . . . 140z; (c) a plurality of healthcare provider access devices 160a, 160b, 160c . . . 160Z; and (d) one or more EHR systems such as EHR system 180a. The recovery system 100, which is sometimes referred to herein as the system, is configured to enable patients and healthcare providers to use access devices to access and communicate with the computer(s) or server(s) of the recovery system 100 through the internet or any other suitable data network 110.

As further described below, in various embodiments, the recovery system 100 includes a relatively large collection of interactive instructional audio-visual exercise modules and other data and information that are selectively used to provide the exercise sessions to the patients using the patient access devices. The recovery system enables the patients to use any one of a plurality of different patient access devices (i.e., any one of a plurality or variety of different platforms through which access to the system and the exercise sessions), and thus the recovery system 100 makes it possible for the patients to perform the selected exercises from the recovery pathway for the exercise sessions while at home, in the office, at school, at the gym, at a healthcare provider's office or facility, or almost anywhere.

The computer(s) (such as the server(s)) includes one or more central processing units (not shown) and one or more memory devices (not shown in FIG. 1A) which store instructions (not shown in FIG. 1A), exercise modules (not shown in FIG. 1A), and one or more databases (not shown in FIG. 1A). It should be appreciated that computers or servers employed in the recovery system 100 of the present disclosure may have various configurations such as the example configuration described below. It should also be appreciated that the recovery system can be cloud based.

The present disclosure contemplates that the plurality patient monitors 120a, 120b, 120c . . . 120z can be various suitable electronic devices which monitor the activities of the patients and communicate data related to the activities of the patients back to the recovery system 100. For example, such patient monitors include but are not limited to: (a) heart rate monitors; (b) blood pressure monitors; and (c) oxygen monitors. It should be appreciated that various embodiments of the present disclosure do not need to use, include, or communicate with such monitors.

The present disclosure contemplates that the patient access devices 140a, 140b, 140c . . . 140z, and the healthcare provider access devices 140a, 140b, 140c . . . 140z, can include any suitable user computer and/or computerized communication device. Such devices include, but are not limited to: (a) a cellular telephone (such as a smart phone); (b) a tablet-computing device; (c) a laptop computer; (d) a desktop computer; and (e) a data network connectable television. Users operate these access devices to access or communicate with the recovery system 100 through the data network 110. It should be appreciated that in various embodiments, the recovery system 100 operates with the access devices through one or more software programs or applications downloaded to those access devices (i.e., commonly called “apps”). It should be appreciated that in other various embodiments, the recovery system 100 operates with the access devices through one or more software programs or web sites accessible by those access devices. It should be appreciated that in various embodiments, the recovery system 100 operates with the access devices through one or more software programs or applications downloaded to those access devices and through one or more software programs or web sites accessible by those access devices. It should be further appreciated that the recovery system 100 and the user access devices can co-act in other suitable manners in accordance with the present disclosure.

In various embodiments, the recovery system 100 requires each of the healthcare providers to register with the recovery system 100. In such embodiments, each healthcare provider has a user identifier (such as a name or e-mail address) and a password or other identifier to access or use the recovery system 100. In various embodiments, the healthcare provider must become a customer of the company or organization that operates the recovery system 100 to use the recovery system 100 and to have the healthcare providers' patients use the recovery system 100.

In various embodiments, the recovery system 100 requires each of the patients to register with the recovery system 100. In such embodiments, each patient has a user identifier (such as a name or e-mail address) and a password or other identifier to access or use the recovery system 100.

The recovery system 100 of the present disclosure causes the patient access device to display: (a) certain images and/or information to the patient regarding treatment of the patient; and (b) enables the patient to make certain inputs as further described below. Similarly, if the recovery system is implemented in whole or part through an application downloaded to the patient access device, the application causes the patient access device to display certain images and/or information to the patient and enables the patient to make certain inputs. For brevity, instead of stating that the system (or application thereof) causes the patient access device to display images and/or information to the patient, the present application sometimes simply states this by stating that the recovery system displays images and/or information to the patient. Similarly, for brevity, instead of stating that the system (or application thereof) causes the patient access device to enable the patient to make inputs (such as making other inputs), the present application sometimes states this by stating that the recovery system enables the patient to input information. It should be appreciated that such statements are for brevity and not meant to limit the present disclosure.

Likewise, the recovery system 100 of the present disclosure causes the healthcare provider access device to display: (a) certain images and/or information to the healthcare provider regarding treatment of the patient; and (b) enables the healthcare provider to make certain inputs as further described below. Similarly, if the recovery system is implemented in whole or part through an application downloaded to the healthcare provider access device, the application causes the healthcare provider access device to display certain images and/or information to the healthcare provider and enables the healthcare provider to make certain inputs. For brevity, instead of stating that the recovery system (or application thereof) causes the healthcare provider access device to display images and/or information to the healthcare provider, the present application sometimes simply states this by stating that the recovery system displays images and/or information to the healthcare provider. Similarly, for brevity, instead of stating that the recovery system (or application thereof) causes the healthcare provider access device to enable the healthcare provider to make inputs (such as making other inputs), the present application sometimes states this by stating that the system enables the healthcare provider to input information. It should be appreciated that such statements are for brevity and not meant to limit the present disclosure.

In various embodiments, the recovery system communicates with the various patient monitors (if employed) and the access devices through one or more suitable wired, partially wired, or wireless data networks. Thus, it should be appreciated that the recovery system of the present disclosure can operate through a suitable central or remote network such as but not limited to one or more local area networks (LANs), one or more wide area networks (WANs), one or more cellular networks, one or more intranets, and/or the internet.

In various embodiments, the recovery system of the present disclosure suitably stores data needed to operate the recovery system in one or more suitable recovery system databases. FIG. 1B illustrates a high level example database scheme and the database model relationships of one example embodiment of the recovery system of the present disclosure. It should be appreciated that any other suitable database schemes and relationships can be employed in accordance with the present disclosure.

It should be appreciated that the recovery system suitably stores data regarding each of patients in suitable recovery system databases. In various embodiments, all such patient data and communications regarding patient data are encrypted. For example, in certain embodiments, the recovery system encrypts (using 256-bit AES encryption) all patient related data at rest, in transit and in use. It should be appreciated that the recovery system and method of the present disclosure can encrypt the patient data in other suitable methods.

In various embodiments, the recovery system is configured to communicate with one or more EHR systems as further described below. However, it should be appreciated that the recovery system of the present disclosure does not need to communicate with such EHR systems.

In various alternative embodiments, the recovery system can also be configured to communicate with one or more medical reimbursement systems. However, it should be appreciated that the recovery system of the present disclosure does not need to communicate with any medical reimbursement systems.

In various embodiments, the recovery system provides one or more suitable communication abilities between the healthcare providers and the patients. For example, as further explained below, the recovery system provides messaging abilities between the healthcare provider and the patient. In various alternative embodiments, the recovery system stores such communications for possible use in EHR systems. In various alternative embodiments, the recovery system stores such communications for use in medical reimbursement systems.

### Recovery Pathway Exercise Configuration and Exercise Selection of Example Embodiment of the Recovery System

The recovery system of the present disclosure stores a plurality of customizable predefined or predetermined recovery pathways. Each recovery pathway is designed using peer reviewed literature and published protocols. The recovery pathways are regularly updated by one or more expert teams of experts including one or more experienced orthopedic sports medicine specialists, orthopedic physician assistants, physical therapist, and certified athletic trainers all with significant experience in their respective fields.

In various embodiments, as generally illustrated in FIG. 1C, each recovery pathway includes or is made up of a plurality selectable exercises organized by or into a plurality of different categories (such as category 1 and category 2 of FIG. 1C). At any point in time, each exercise is the recovery pathway is either available for selection or not available for selection for an exercise session. In certain embodiments, the categories include a range of motion category, a stretching category, a strengthening category, a therapeutic modality or support procedure category, and a proprioception category. Each category includes or is made up of one or more different exercises (such as exercises 1 to 8 of category 1 and exercises 1 to 8 of category 2 of FIG. 1C). Each exercise has or is associated with a predefined level of difficulty selected from a plurality of different difficulty levels (such as levels 1, 2, and 3 respectively associated with exercises 1 to 8 of category 1 and levels 1, 2, and 3 respectively associated with exercises 1 to 8 of category 2 of FIG. 1C). In other words, in various embodiments, the recovery system delineates exercises by their level of difficulty (such as the lower level exercises being easier to perform and occurring earlier in recovery process and the higher level exercises being harder to perform and occurring later in the recovery process). It should be appreciated that in accordance with the present disclosure: (1) the quantity of categories in each recovery pathway may vary; (2) the quantity of exercises in each category may vary; and (3) the quantity of levels associated with each of the exercises in each category may vary. It should further be appreciated that an exercise in one recovery pathway may be associated with one level and that the same exercise may be assigned to a different level in a different recovery pathway.

It should further be appreciated that recovery pathways for the same type of injury or diagnosis or surgical procedure may be different for different patients. For instance, a professional athlete may have a different recovery pathway than a senior patient. In such cases, a recovery pathway for the athlete may have higher level exercises in the same category then the senior patient. The recovery system enables the healthcare provider to select the appropriate recovery pathway for each different patient even if the type of injury or diagnosis or surgical procedure is the same. It should be appreciated that in the alternative embodiments where the recovery system is provided directly to the patient without a healthcare provider, the patient would need to select the recovery pathway best suited to their physical abilities.

It should also be appreciated that one or more exercises in one or more categories in each recovery pathway can be identified as a priority for selection at its level within a category. In certain embodiments, the exercise selection algorithm of the recovery system is guaranteed to select priority exercises from the recovery pathway to build the exercise sessions at designated points in the patient's recovery process (such as when the patient has reached certain levels in one or more of the categories).

It should also be appreciated that one or more exercises of the recovery pathway may not be selected by the exercise selection algorithm of the recovery system for any of the exercise sessions. In other words, as mentioned above, the exercise selection algorithm may not select every exercise from every category of the recovery pathway for the exercise sessions provided to the patient and that the patient may complete the recovery pathway without performing one or more exercises in one or more categories of the recovery pathway in accordance with the present disclosure.

FIGS. 1D to 1U illustrate a simulated set of exercise sessions selected by the exercise selection algorithm based on an example predefined recovery pathway (for recovery by a patient after undergoing a knee arthroscopy) of one example embodiment of the recovery system of the present disclosure. In this example, this simulated recovery pathway extends for seven weeks and includes sixty-one exercise sessions. This simulated set of exercise sessions is based on a set of assumptions including that the patient is able to perform each exercise without pain or difficulty in each of the exercise sessions and to perform each exercise in the scheduled timeframes. This example over-simplifies patient compliance. It is expected that very few or no patients will be able to perform all of the initially selected exercises of all exercise sessions without difficulty or pain, and thus without causing the exercise selection algorithm to select alternative exercises for one or more exercise sessions. Thus, in various embodiments as further described below, the actual exercises in the exercise sessions are not pre-set according to a predefined order, but are rather selected dynamically by the exercise selection algorithm based on feedback from the patient after each exercise or each exercise session and the availability for selection of each exercise in the recovery pathway. In this example, it should be appreciated that the duration is in seconds.

In various embodiments, the exercise selection algorithm of the recovery system enables a patient to advance through the selected exercises of each category of the patient's recovery pathway independently from advancement through the selected exercises of one, a plurality, or all of the other categories of the patient's recovery pathway based on the patient's specific performance results. In alternative embodiments, two or more of the categories may be linked with respect to advancement through those categories.

In various embodiments, for one or more exercise sessions, the exercise selection algorithm of the recovery system can substitute one exercise for another different exercise if both exercises are at the same level and priority in one of the categories.

In various embodiments, the exercise selection algorithm of the recovery system does not provide or select any exercises for an exercise session from a category with all exercises in that category starting at level N (or higher) until the exercise selection algorithm of the recovery system determines that the patient has successfully completed all of exercises at the level N−1 (and below) in all of the other categories in the recovery pathway for the patient.

In various embodiments, the recovery pathways include or are made up of varied length recovery stages (such as but not limited to an early recovery stage, a middle recovery stage, a late recovery stage, and a return to activity stage) through which exercises belonging to or part of the recovery pathway are delivered to a patient for the patient to perform. Each recovery stage has a specified quantity of successful exercise sessions required for the patient to advance to the next recovery stage.

In various embodiments, the recovery system defines how many successful exercises need to take place per exercise category in each recovery stage for the level of difficulty of that category to advance to the next exercise level of difficulty in that recovery stage.

In various embodiments, each recovery stage specifies or has an associated weighting or percentages for each of the available exercise categories (such as range of motion, strengthening, stretching, therapeutic modality or support procedure, and proprioception). The exercise selection algorithm of the recovery system uses these weightings to create a list of exercises for each patient exercise session occurring in that recovery stage as further described below. In various embodiments, one or more of the percentages can be modified based on requests by the healthcare provider.

In various embodiments, the recovery system enables a patient to set or reset a goal for the patient's recovery pathway that is related to a maximum level of exercise difficulty.

In various embodiments, the recovery system enables a healthcare provider to block one or more specific exercises from a patient's assigned recovery pathway permanently, for a limited period of time, until a triggering event occurs, or until the healthcare provider removes the block for the patient.

In various embodiments, the recovery system enables a healthcare provider to block one or more specific exercises from a group of or from all of their patients' assigned recovery pathways permanently, for a limited period of time, until a triggering event occurs, or until the healthcare provider removes the block for the respective patients.

In various embodiments, the recovery system enables a healthcare provider to add one or more specific exercises to a patient's assigned recovery pathway permanently, for a limited period of time, until a triggering event occurs, or until the healthcare provider removes the exercise for the patient.

In various embodiments, the recovery system enables a healthcare provider to add one or more specific exercises for a group of or from all of their patients' assigned recovery pathways permanently, for a limited period of time, until a triggering event occurs, or until the healthcare provider removes the exercise for the respective patients.

In various embodiments, the recovery system enables a healthcare provider to access or evaluate a specific patient, setting that patient's starting point, goal, and the patient's recovery pathway length.

In various embodiments, the recovery system is configured to be linked to or communicate with one or more other systems which includes or stores patient specific data which the exercise selection algorithm of the recovery system uses to customize the exercises or exercise sessions it will provide for or to the specific patient. In one example, the recovery system receives either an altered set of exercises for the recovery pathway for a patient based on an evaluation of the patient by the healthcare provider. In other examples, the recovery system links with another system (such as a functional movement assessment system) to obtain patient specific information that the exercise selection algorithm uses to alter one or more of the exercise sessions for the patient, or recovery pathway. In various embodiments, the recovery system enables these systems to obtain information back from the recovery system to monitor patient progress during the recovery process and to communicate with the patient.

In various embodiments, the recovery system enables a healthcare provider to adjust exercise meta-data to best meet the needs of their patients. For example, the adjusted exercise meta-data can be one or more of sets, reps, duration, level of difficulty, and frequency.

In various embodiments, for each patient exercise session provided to the patient, the exercise selection algorithm of the recovery system selects exercises across a plurality or all of the available categories of the recovery pathway at the patient's then current levels to create that patient's exercise session as further described below.

In various embodiments, as mentioned above, the exercise selection algorithm of the recovery system selects, for a given level in a given category of the recovery pathway, exercises marked or identified as priority before non-priority exercises.

In various embodiments, the exercise selection algorithm of the recovery system selects the identified percentage for exercises from each category of the recovery pathway to be selected for the exercise session.

In various embodiments, the exercise selection algorithm of the recovery system determines the patient's current level based on the patient's performance history for the same category of exercises.

In various embodiments, the exercise selection algorithm of the recovery system defines the category percentages for each recovery stage, and various alternative embodiments can modify the category percentages based on prior exercise performance by the patient.

In various embodiments, for each exercise session, the exercise selection algorithm of the recovery system selects and provides or presents the exercises of the exercise categories of the recovery pathway in an order defined by the recovery pathway.

In various embodiments, the exercise selection algorithm of the recovery system advances the patient from the current level in a category to the next level of exercise difficulty in that category when a predetermined quantity of prior exercise sessions have successfully completed an exercise from that category and the current level.

In various embodiments, the recovery system determines successful completion of an exercise based on the collection and analysis of category specific biologic responses provided by the patient or other feedback from the patient. In alternative embodiments, the recovery system determines successful completion of an exercise based at least in part on the collection and analysis of data from one or more of the monitors.

In various embodiments, if the patient reports pain at at least a designated level of pain (such as at moderate or more pain) from an exercise, the exercise selection algorithm of the recovery system may: (a) not alter the future exercise selection at all; (b) prevent advancements at that category for a limited time or duration; (c) reduce the current level of difficulty for that category for the next exercise session (if possible); (d) stop further exercise sessions from being provided to the patient for a specified time period (such as a day); (e) temporally stop further exercise sessions from being provided to the patient until the healthcare provider authorizes such exercise sessions to be again provided to the patient; or (f) stop providing exercises from that category for exercise sessions until the healthcare provider authorizes such exercises to be again provided to the patient.

In various embodiments, if the patient reports pain at at least a designated level of pain (such as at moderate or more pain) from an exercise for a designated quantity (such as two or more sessions), the exercise selection algorithm of the recovery system takes additional patient protection action such as preventing all further exercise sessions from being provided to the patient until the healthcare provider authorizes such use. It should be appreciated that the additional patient protective action can be any other suitable actions (such as notifying the healthcare provider of patient incurred pain higher than an expected level).

In various embodiments, after the recovery system determines that a category reaches the highest level of difficulty available, the exercise selection algorithm of the recovery system will continue to select exercises from that level of difficulty until the recovery pathway is complete. In various embodiments, the exercise selection algorithm may rotate or select exercises of the highest level in a category once reached.

In various embodiments, after the recovery system determines that a recovery pathway is complete, if the patient has set a pathway goal that does not map to the highest difficulty level of available exercise, the recovery system prompts the patient to reset to a higher level goal.

### Operation of Example Embodiment of Recovery System

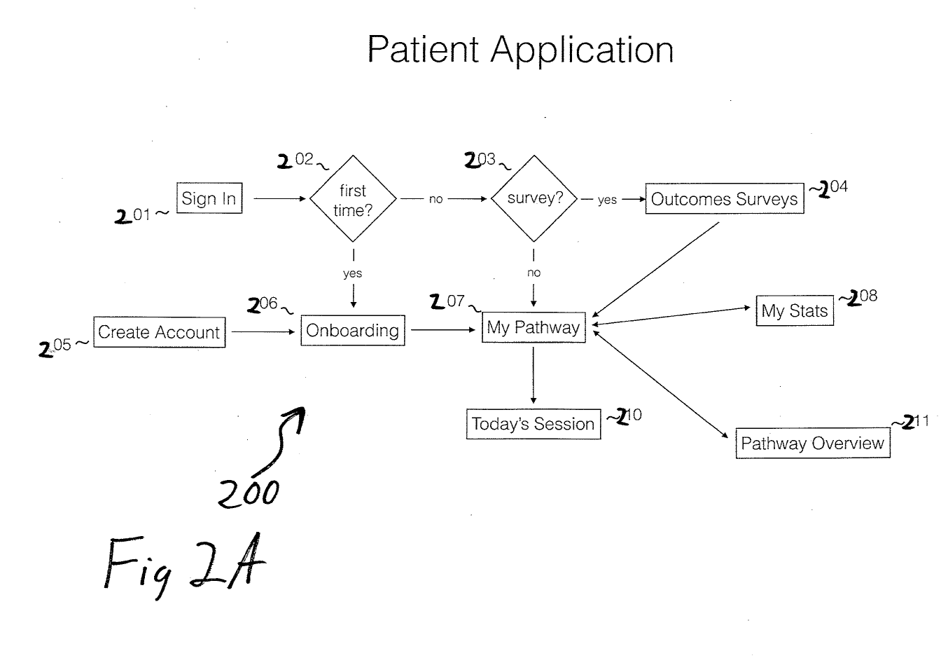

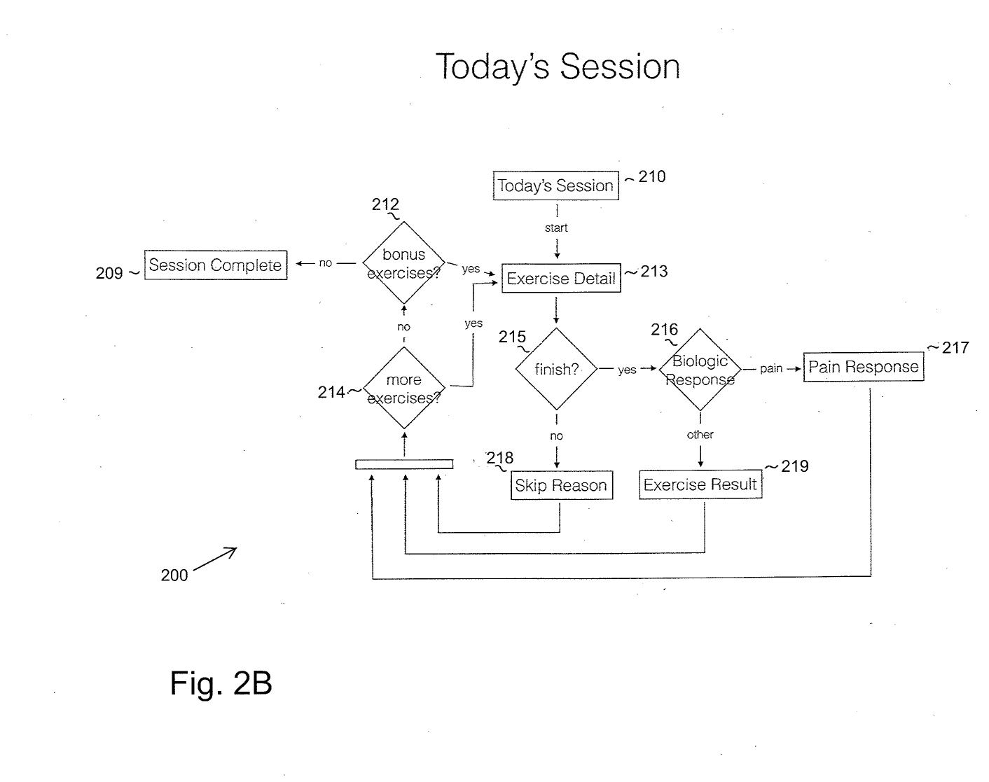

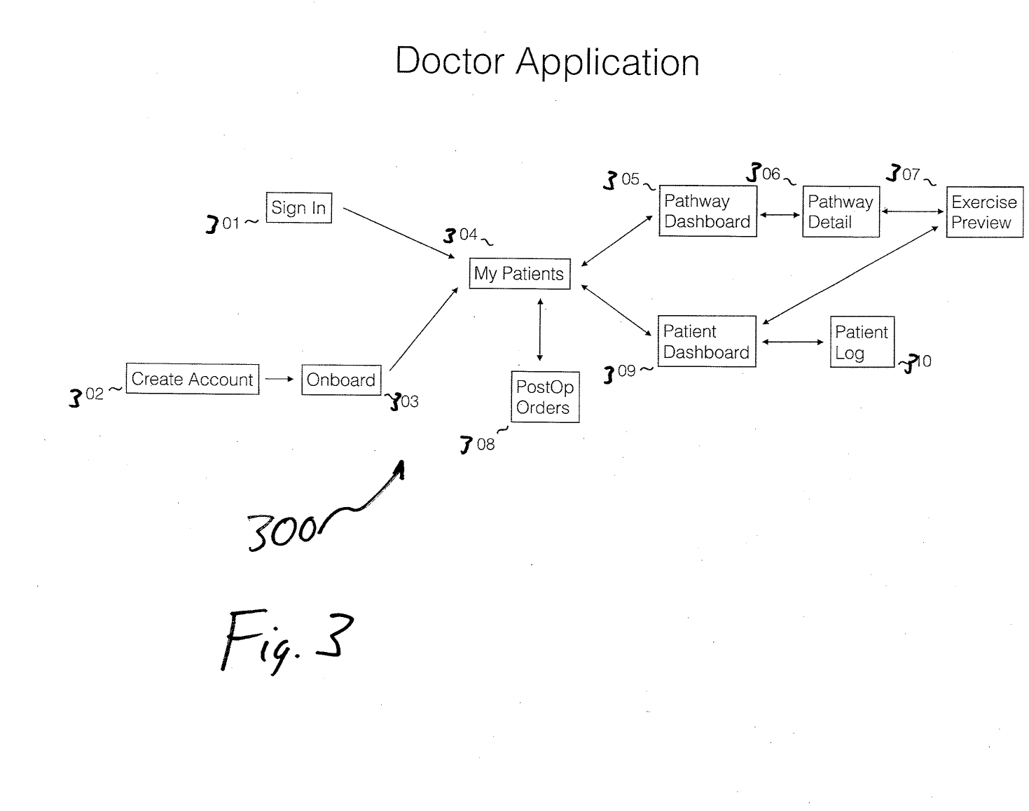

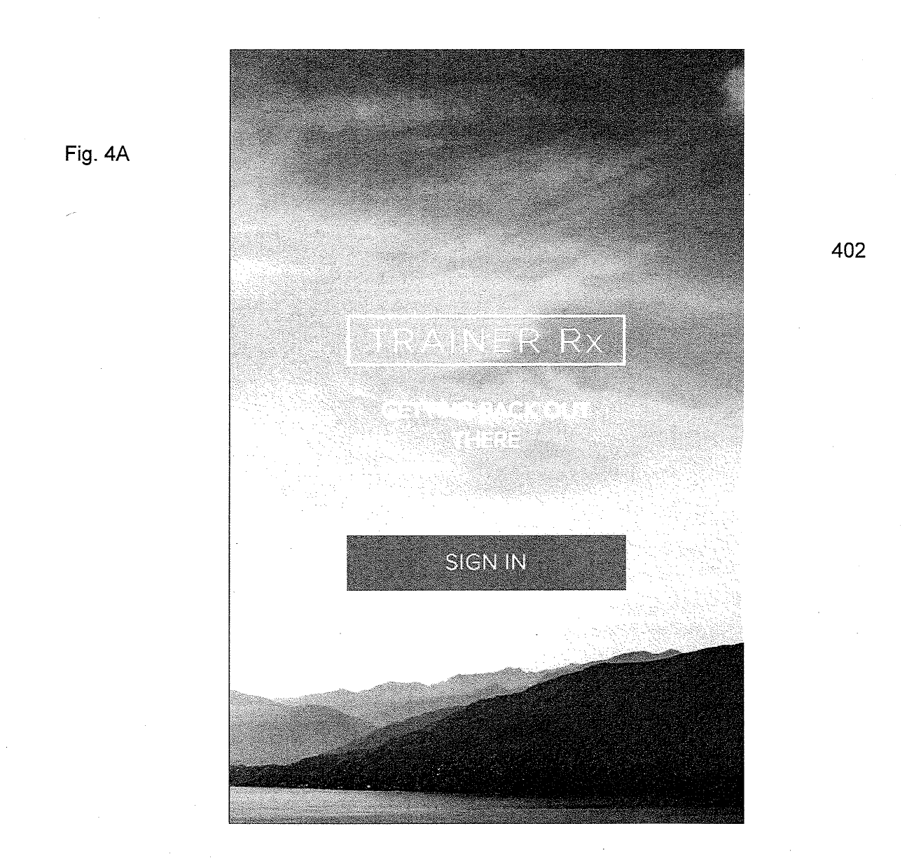

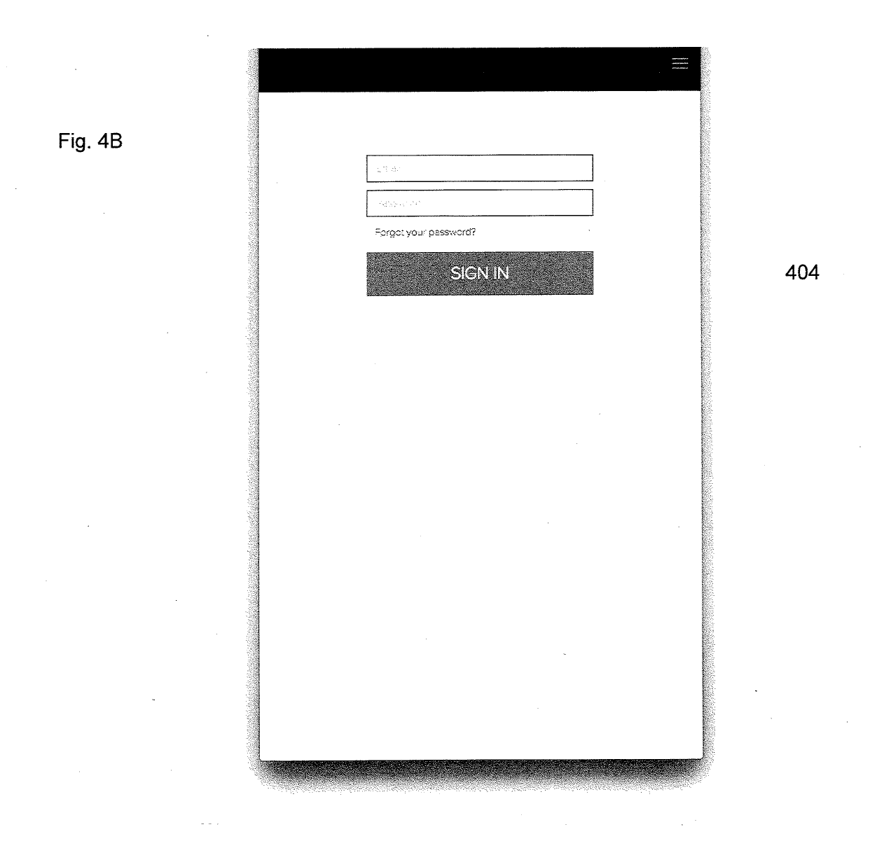

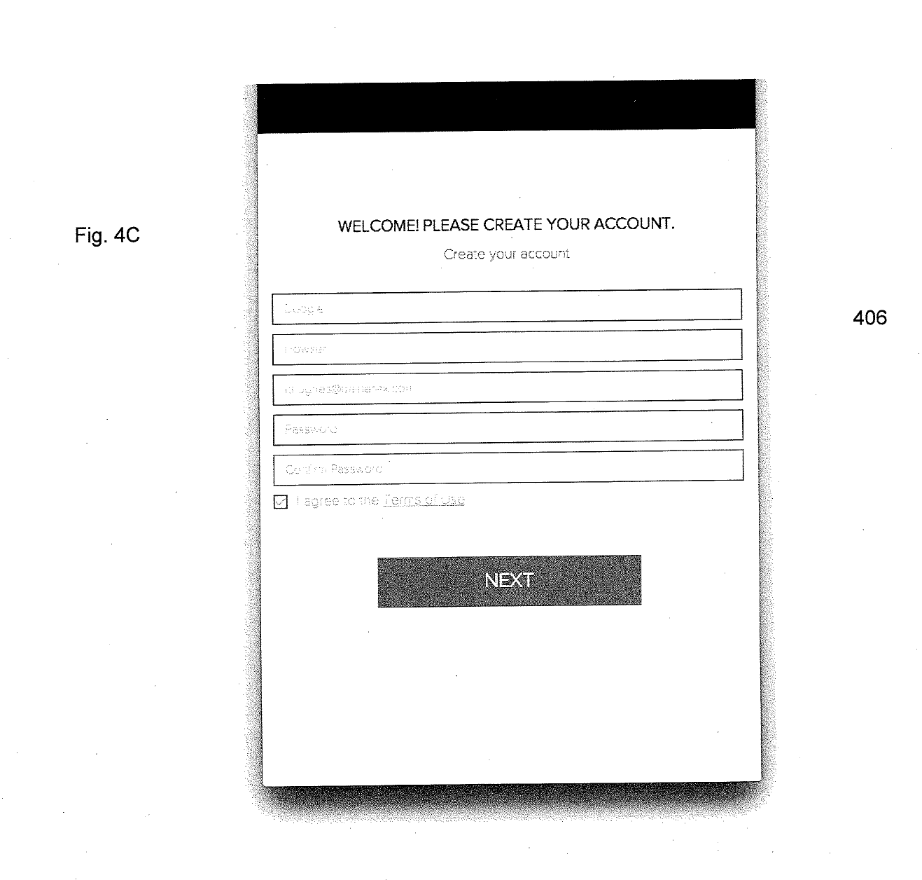

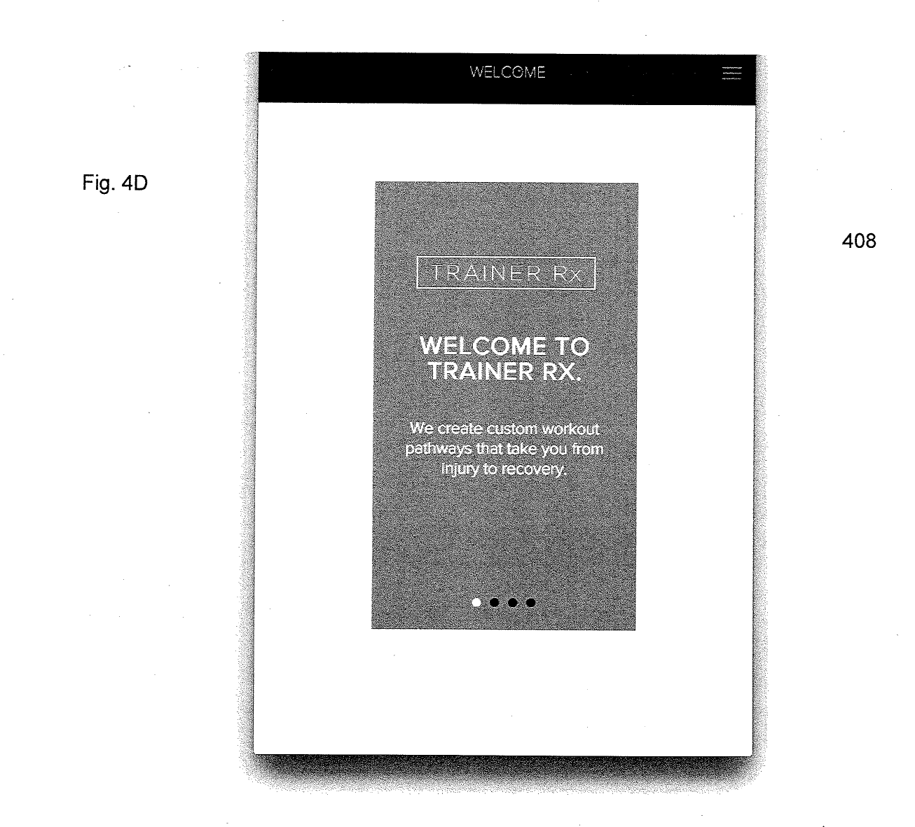

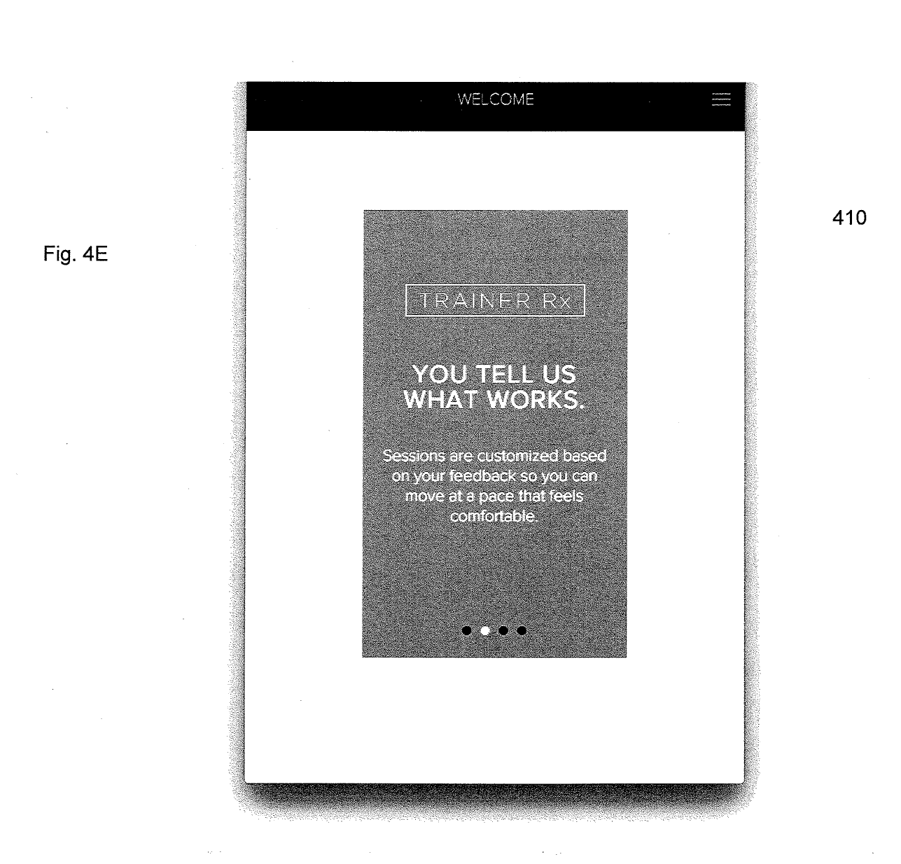

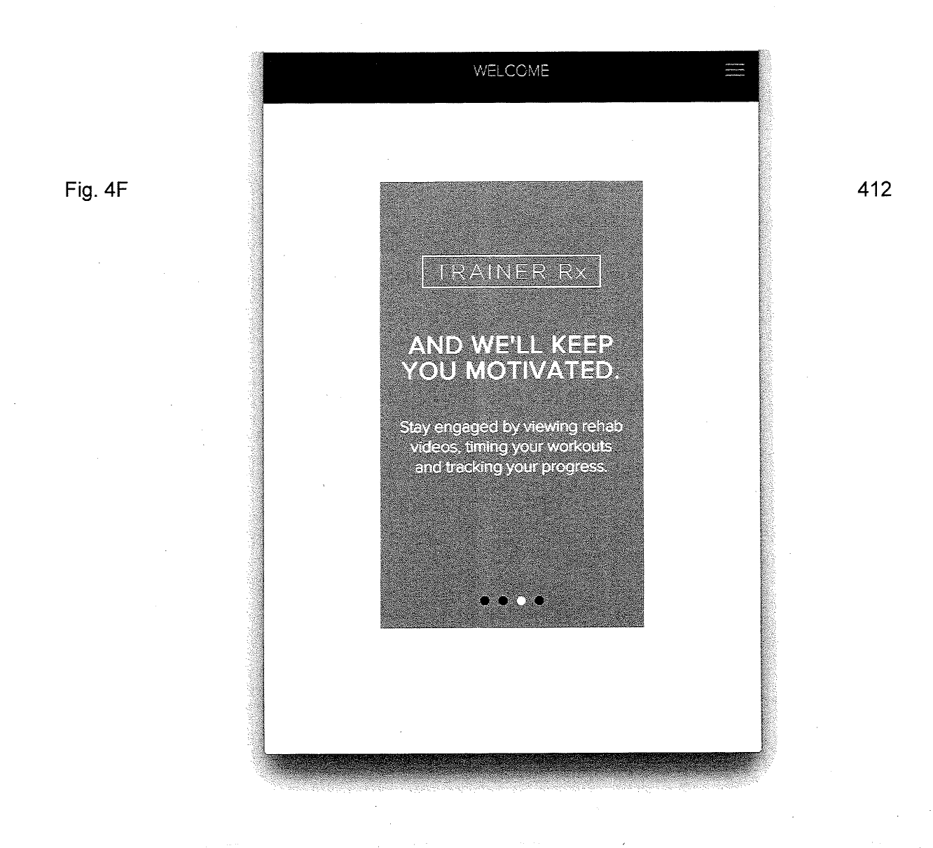

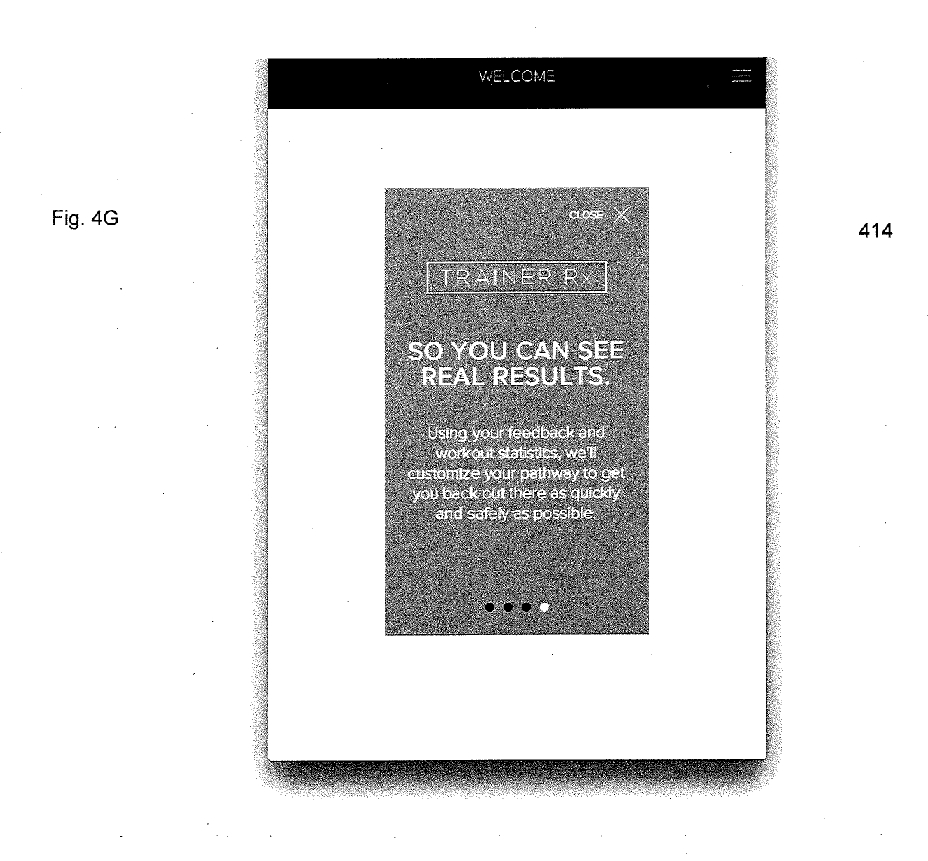

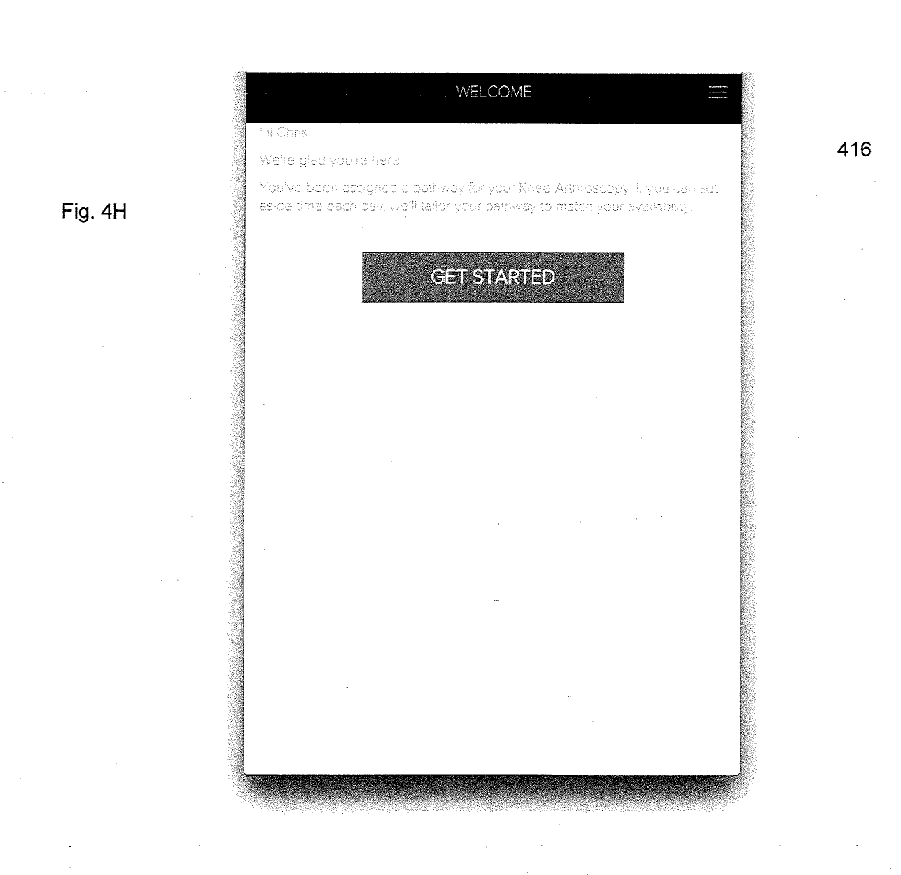

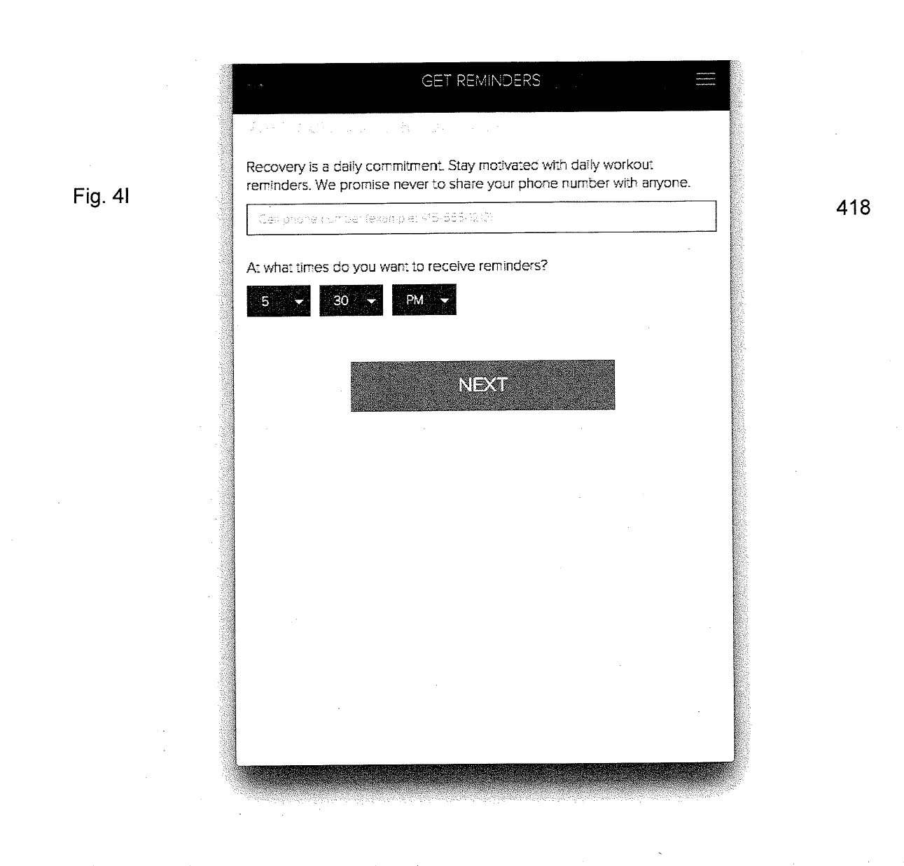

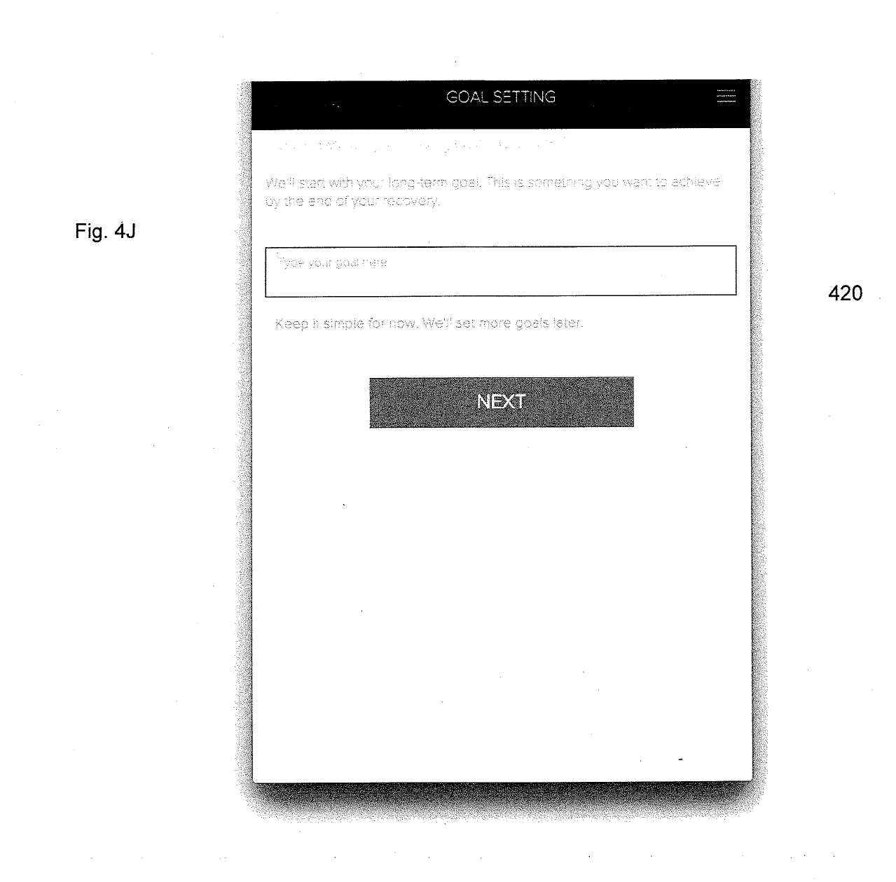

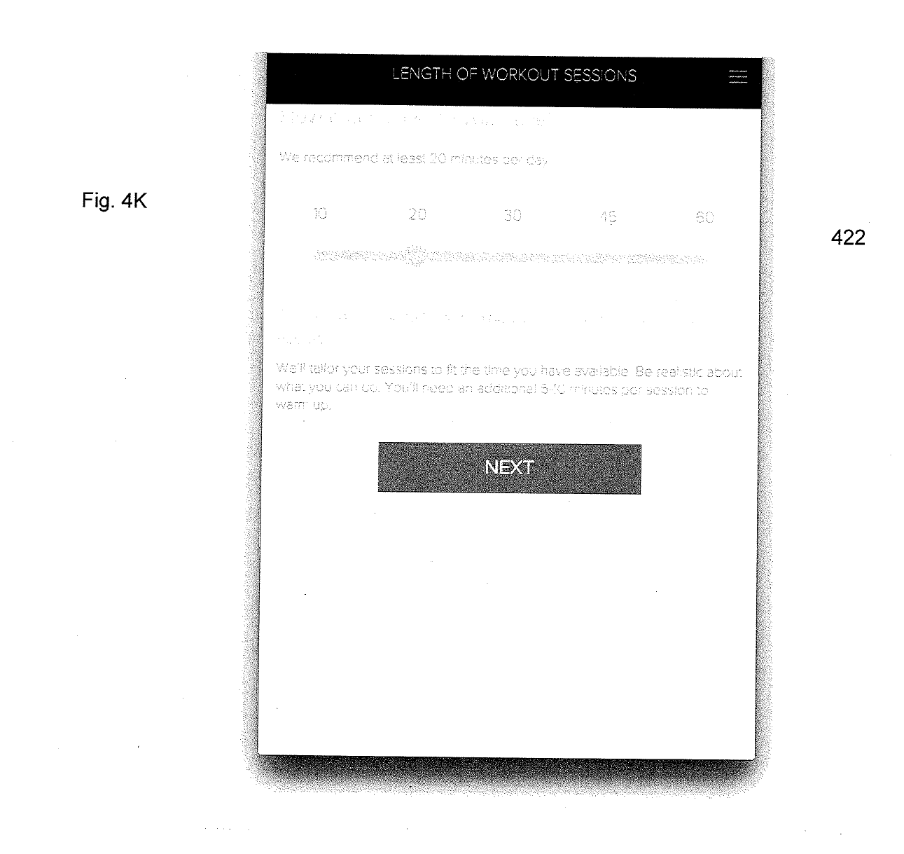

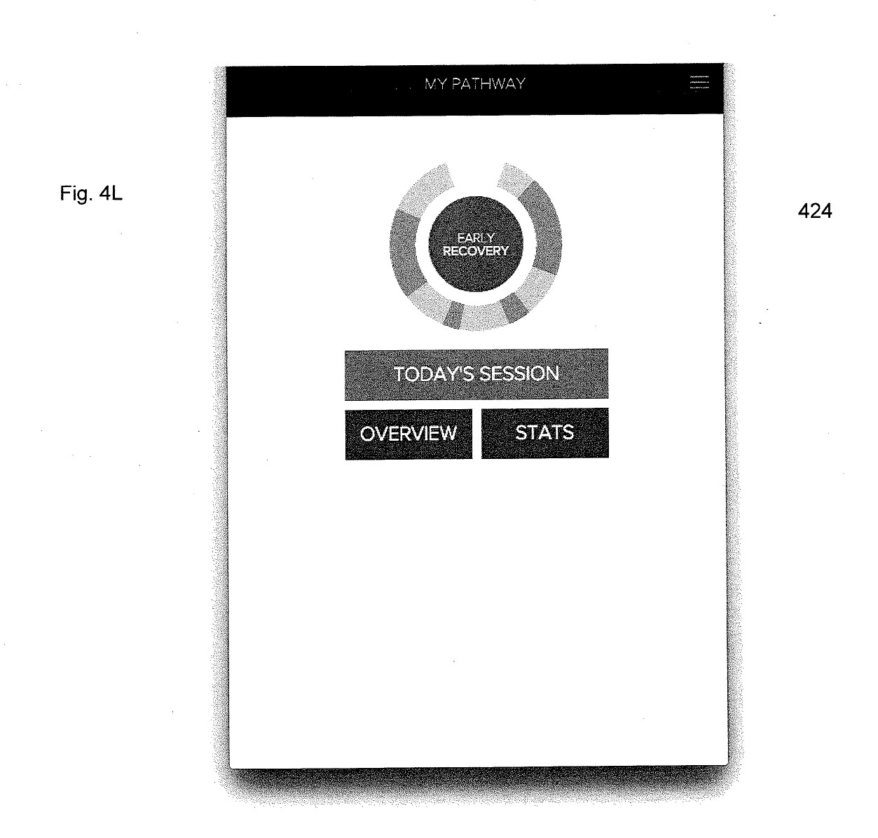

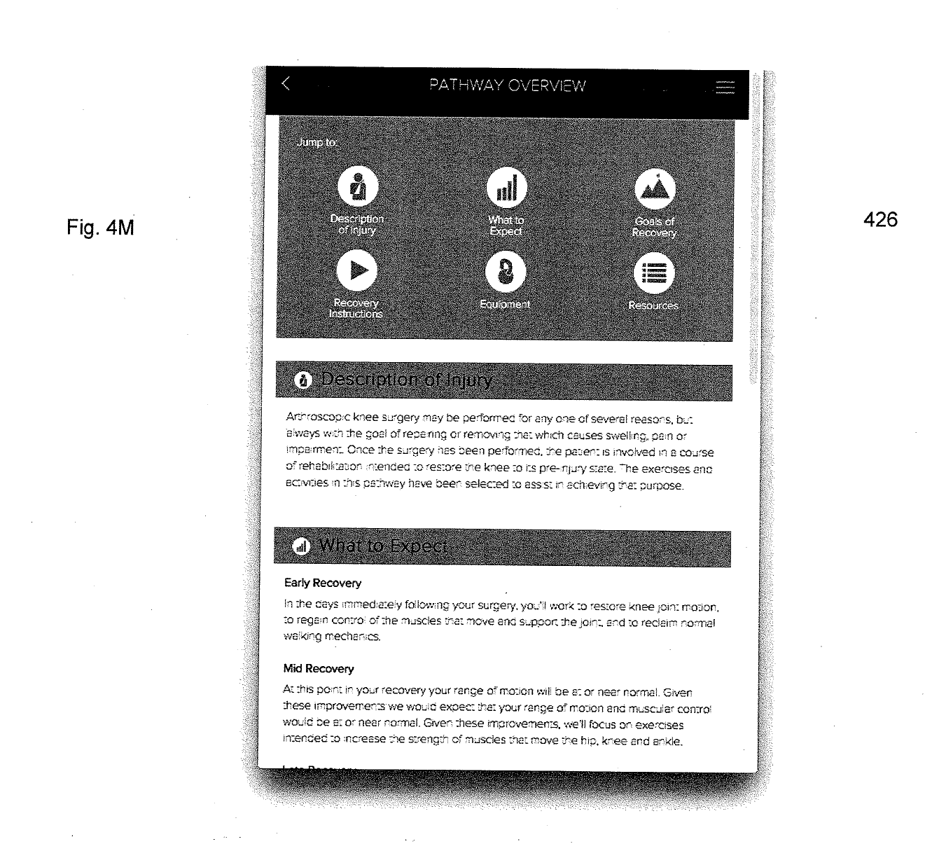

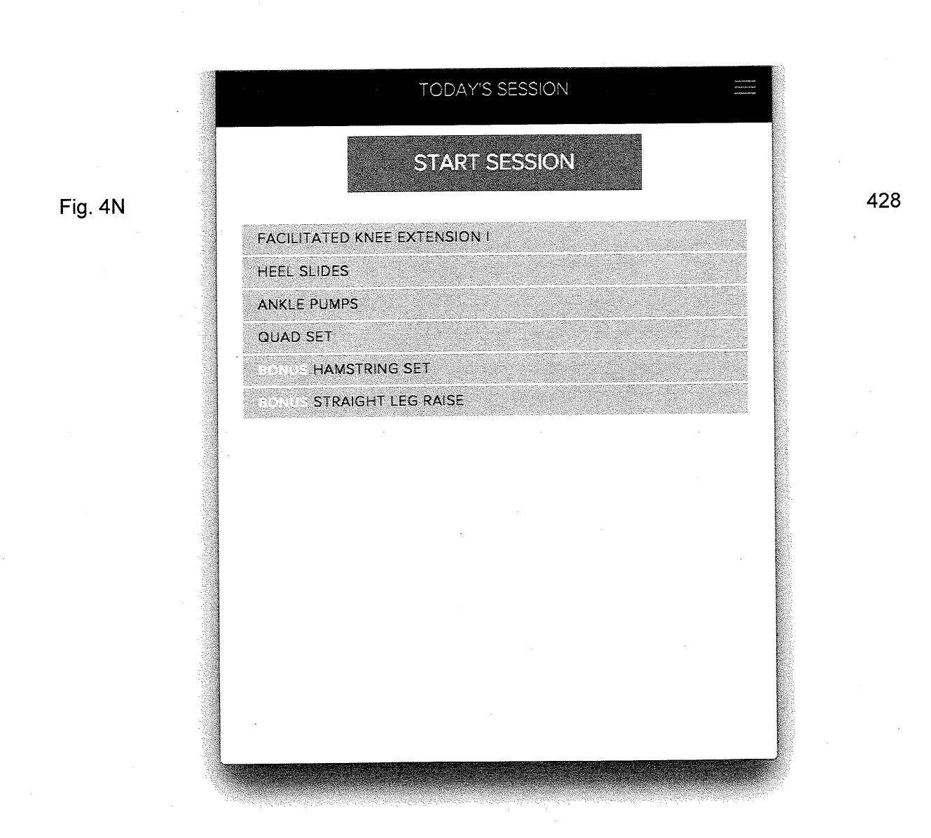

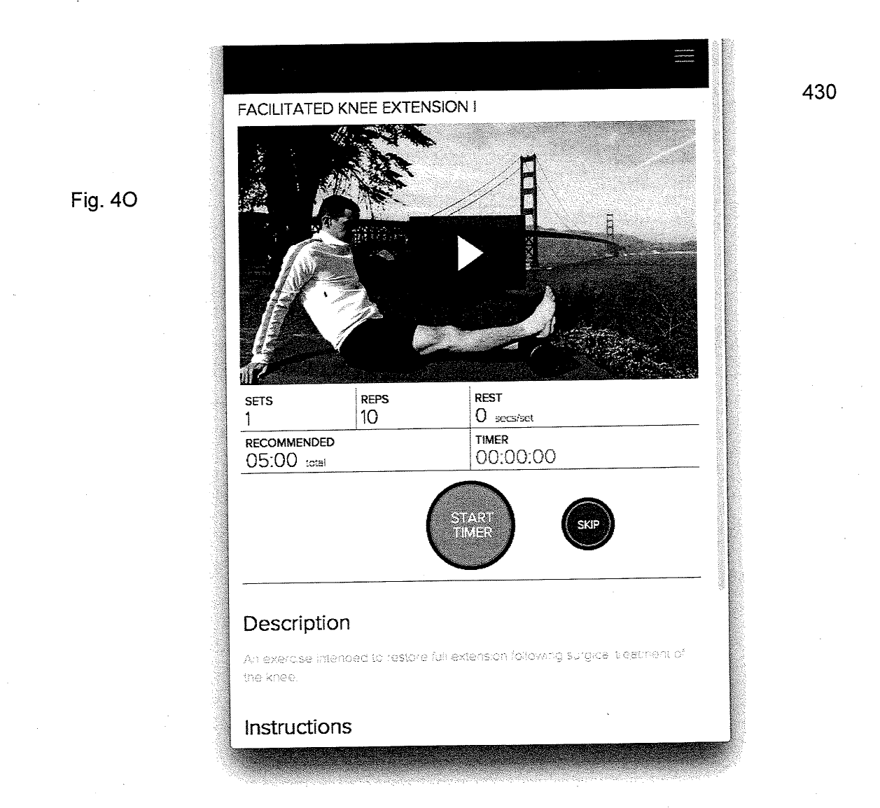

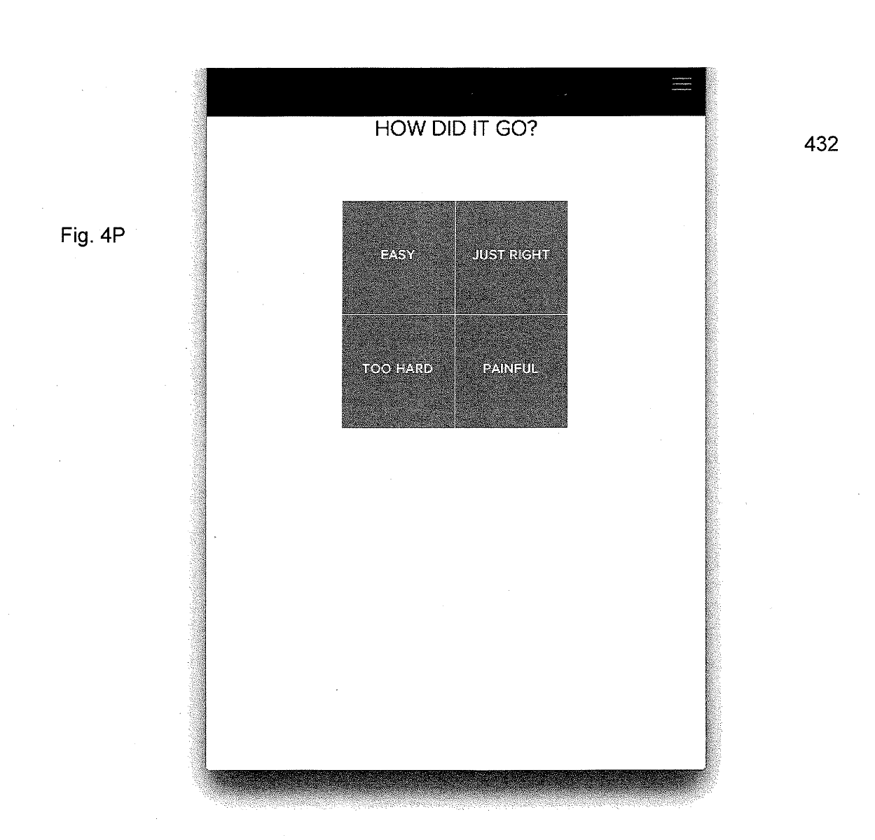

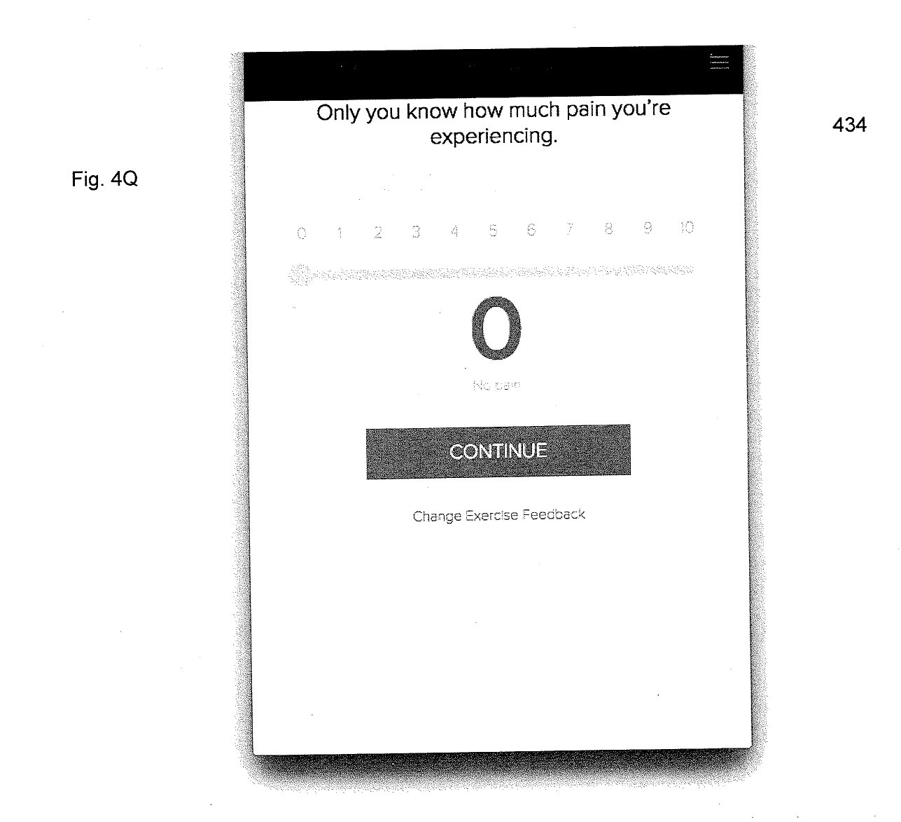

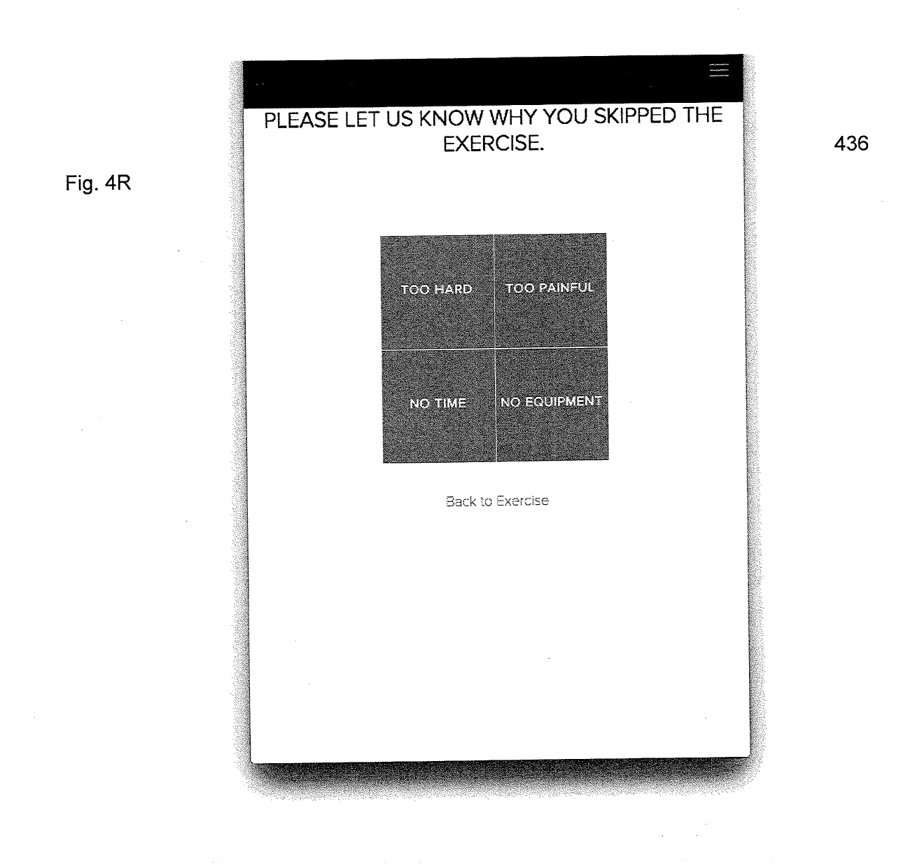

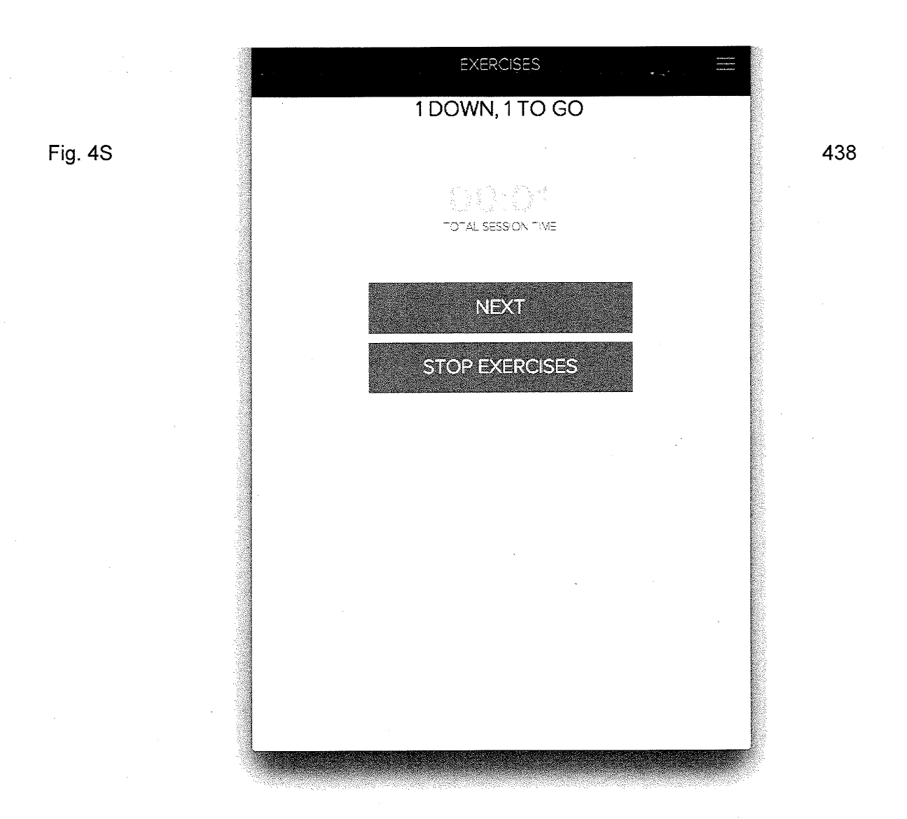

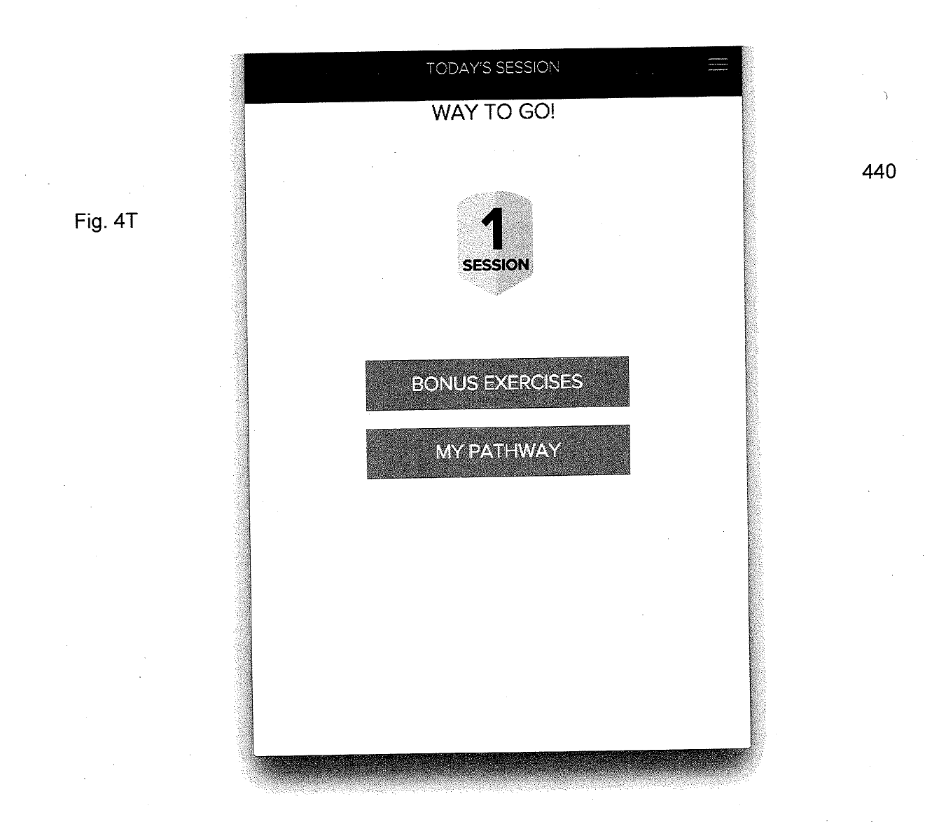

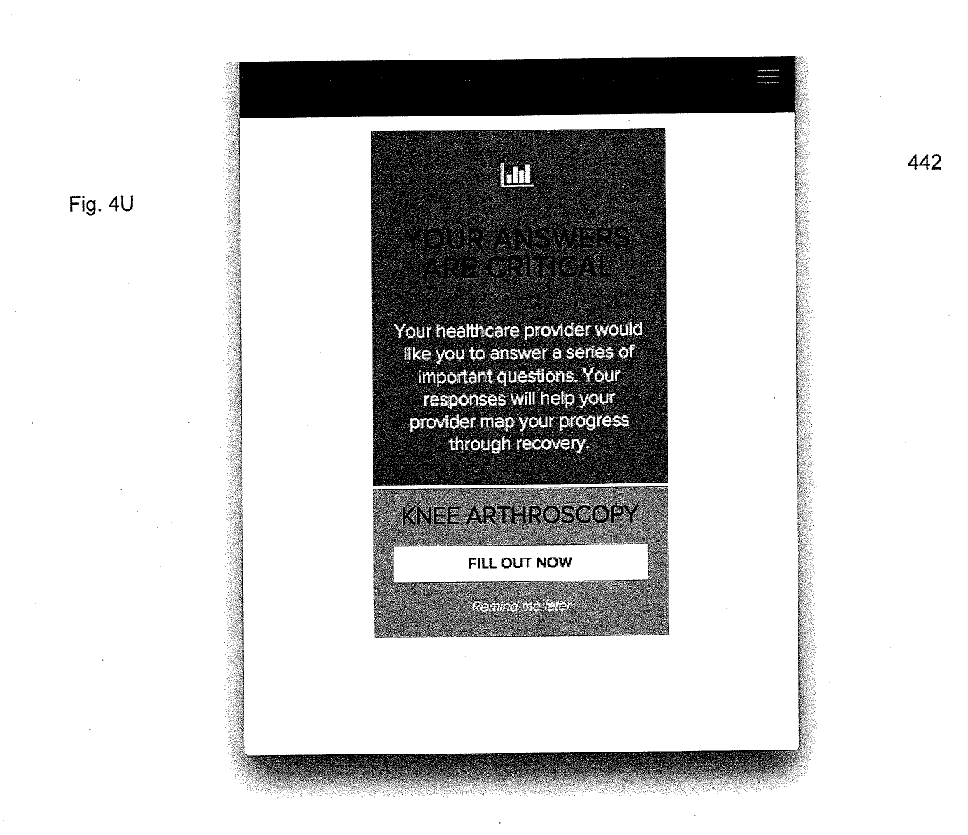

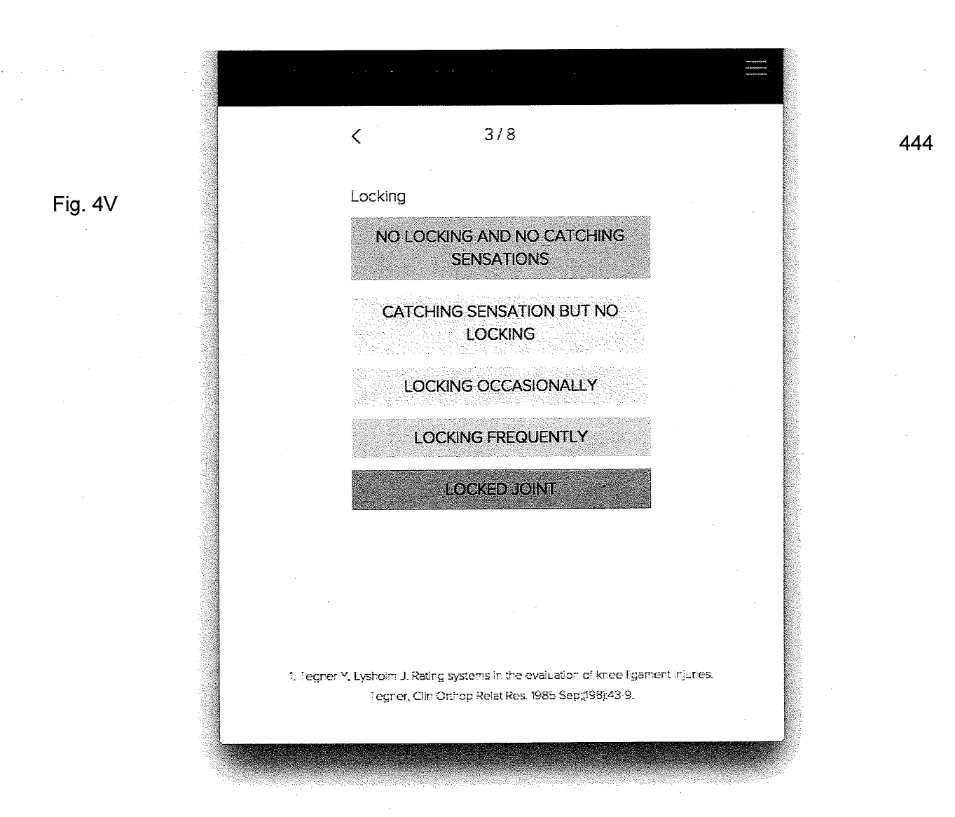

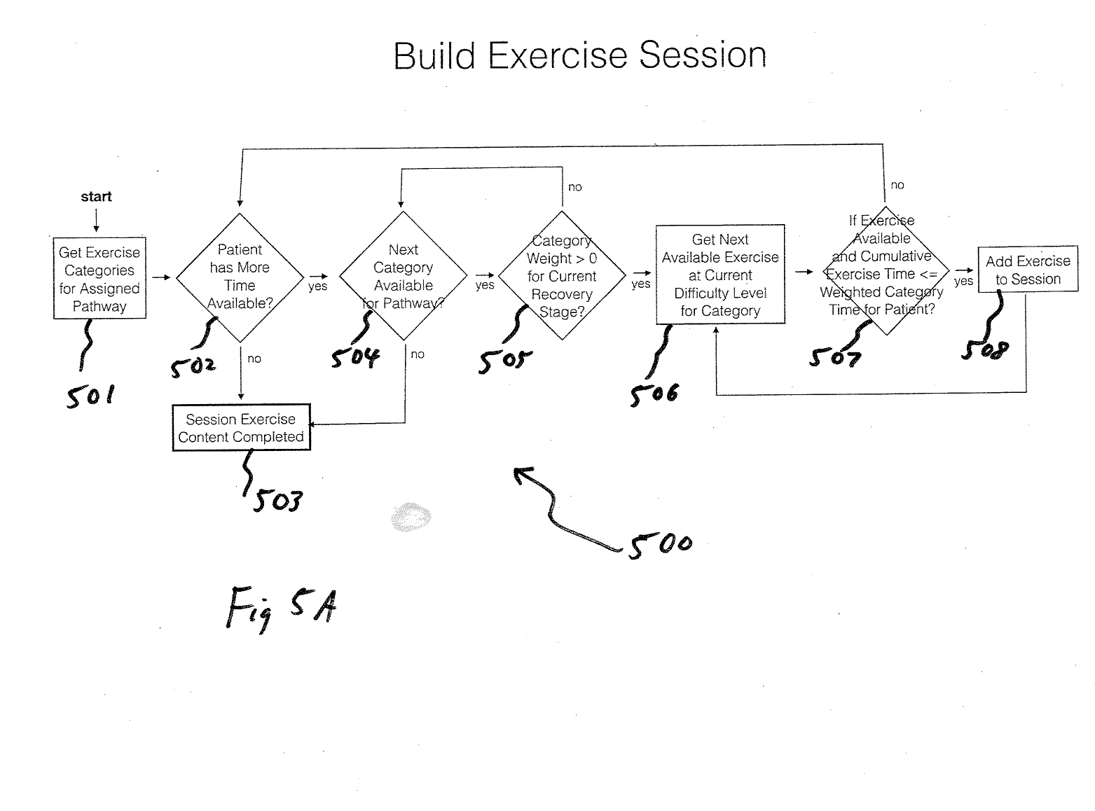

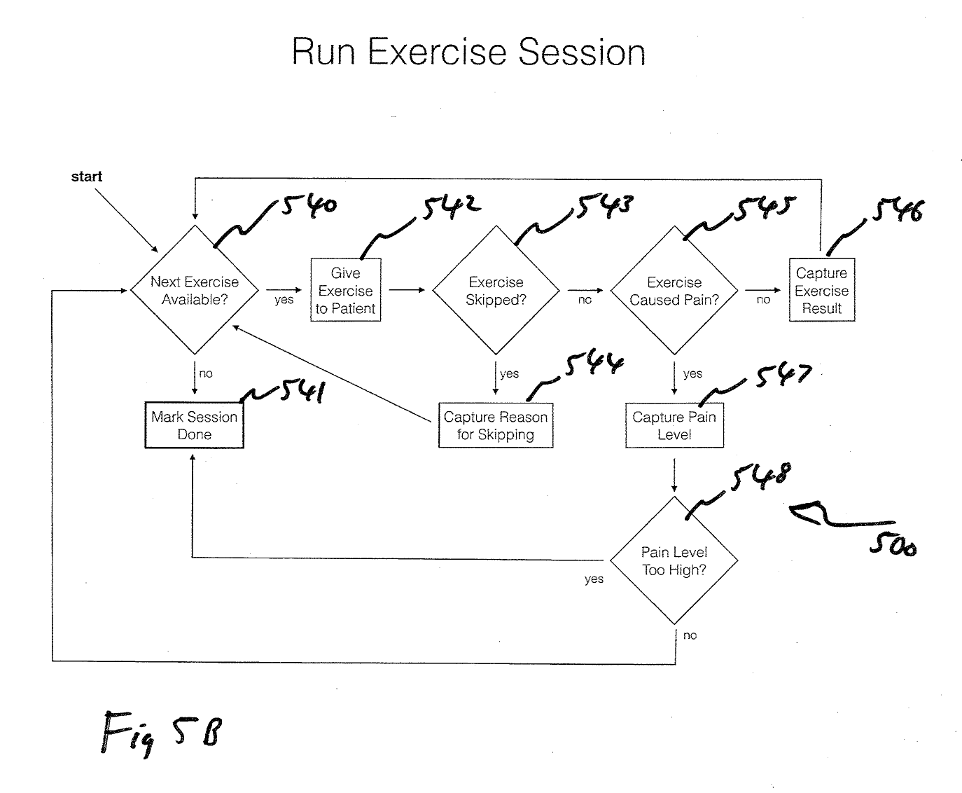

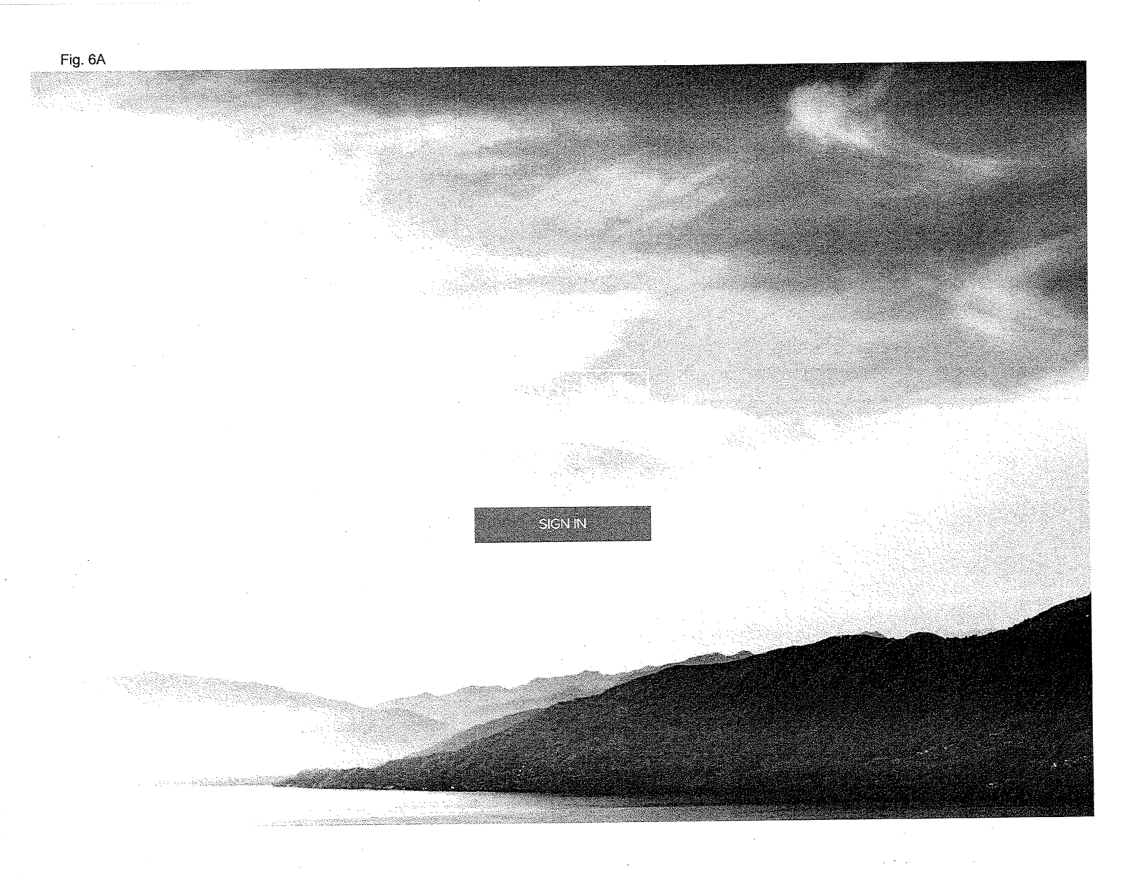

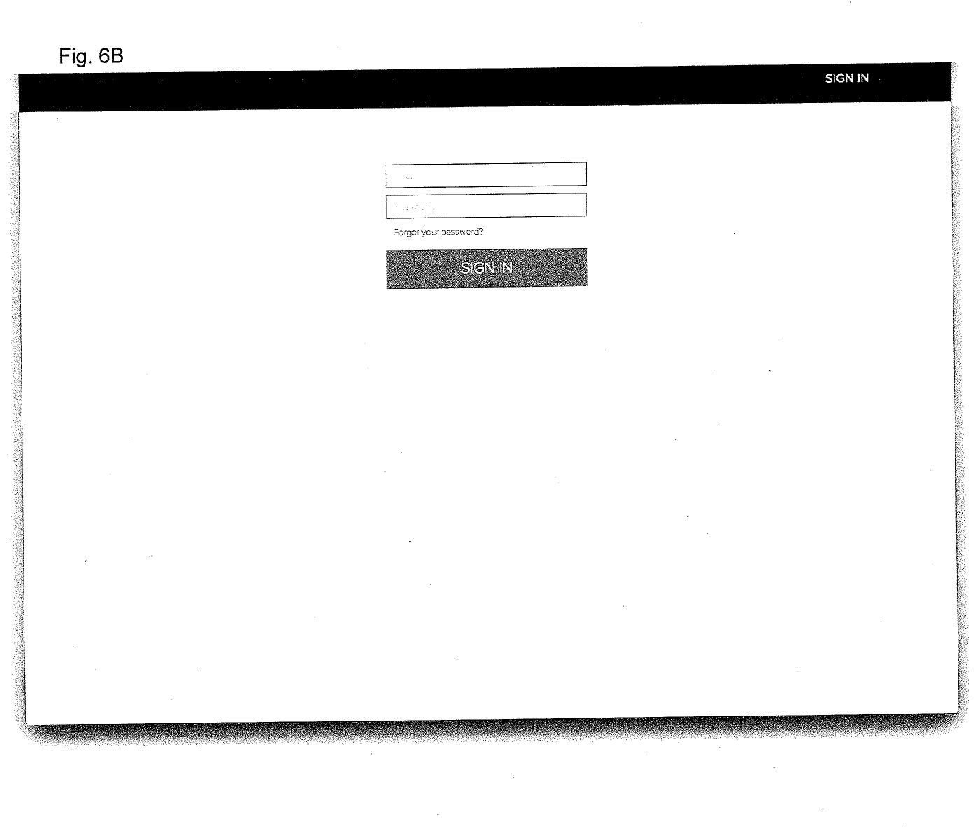

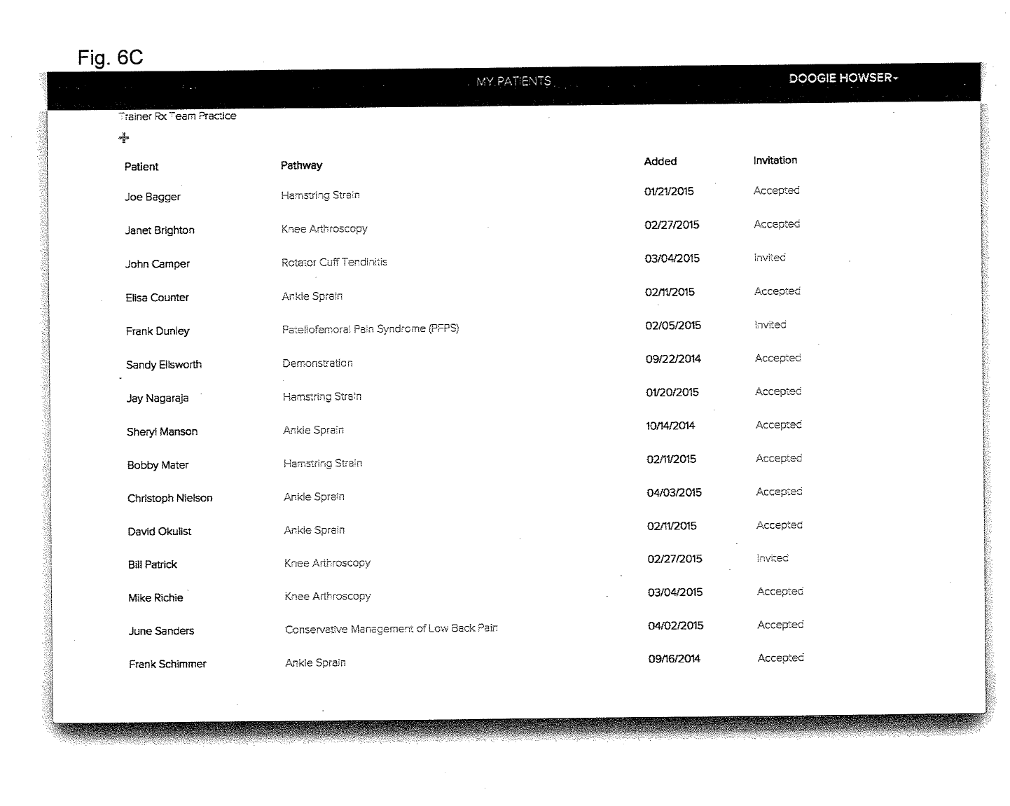

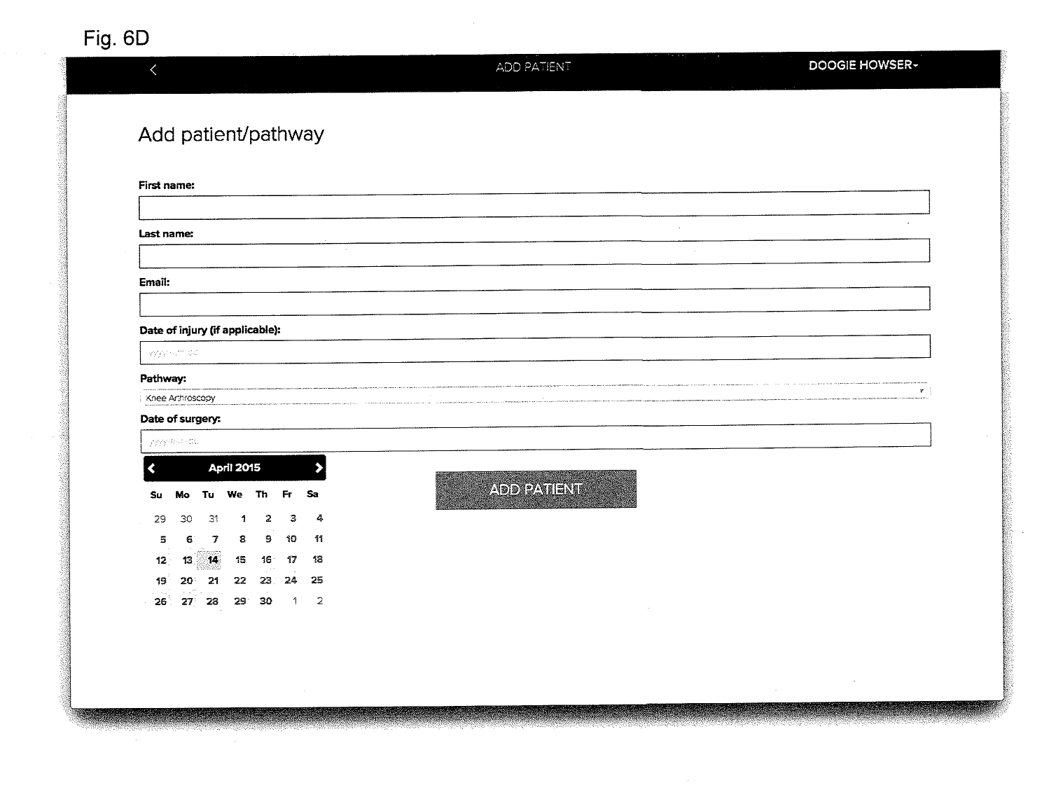

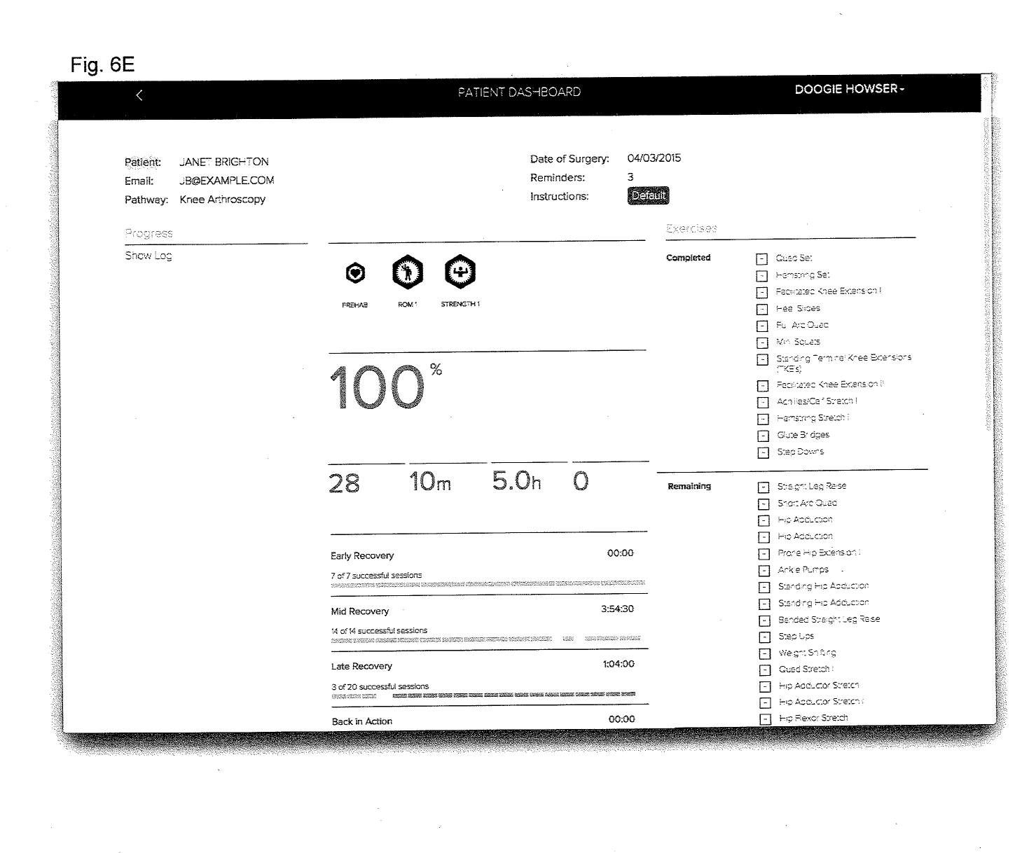

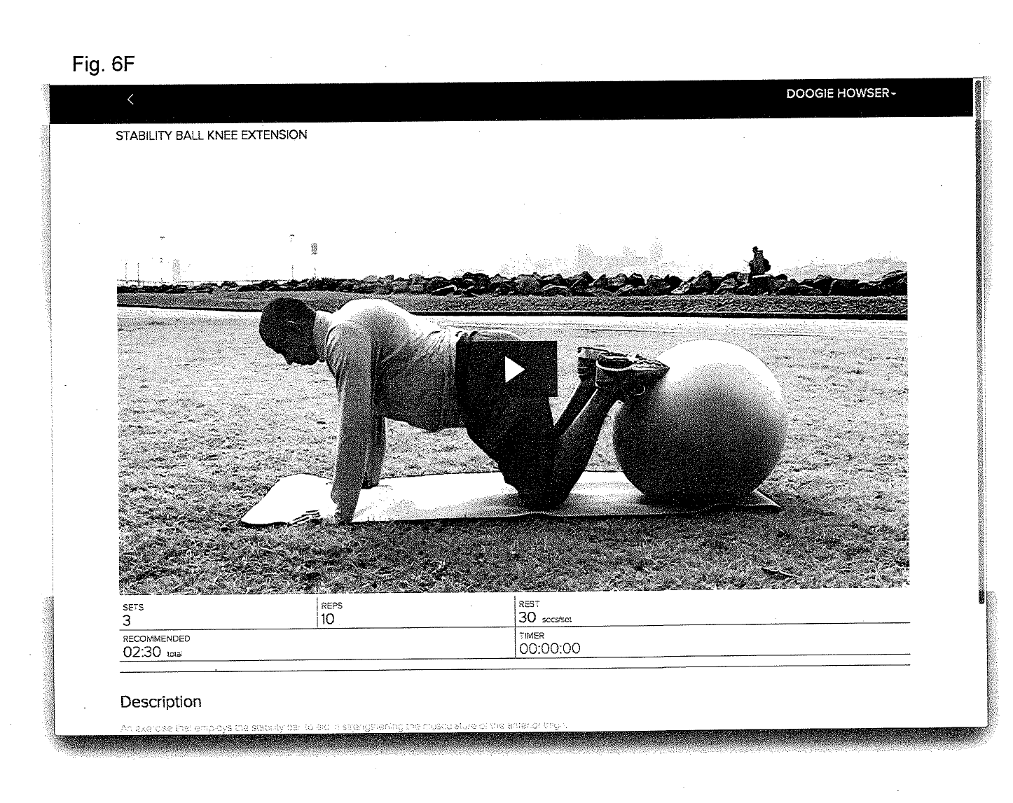

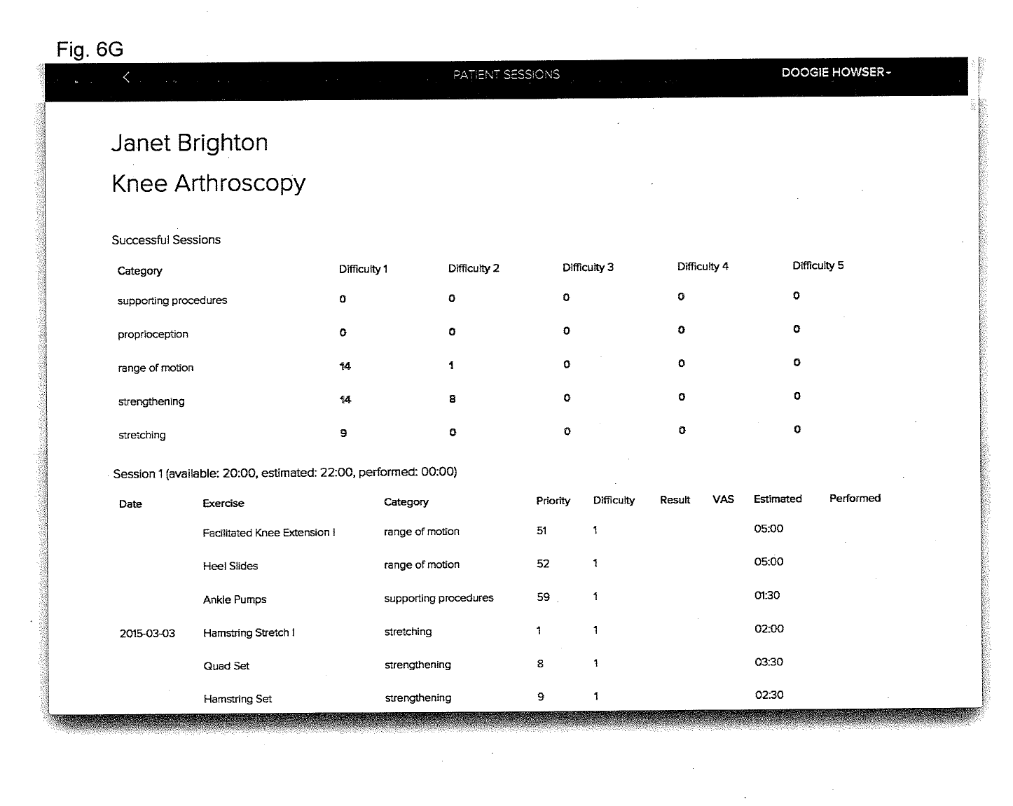

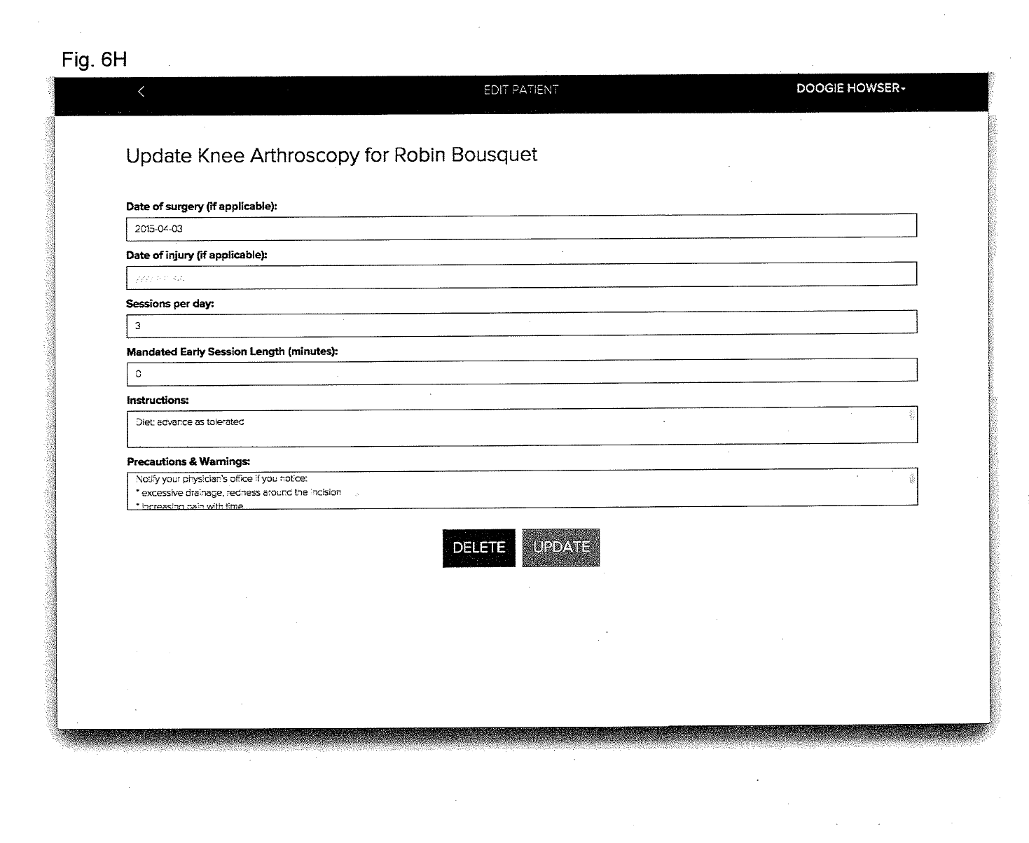

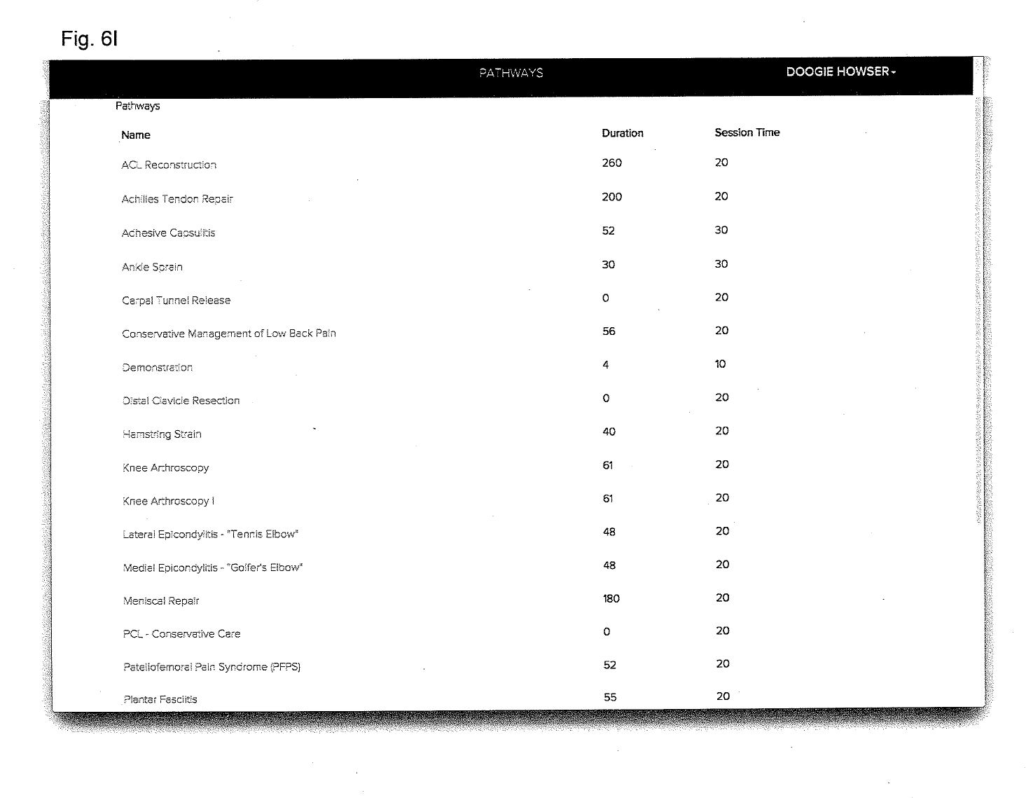

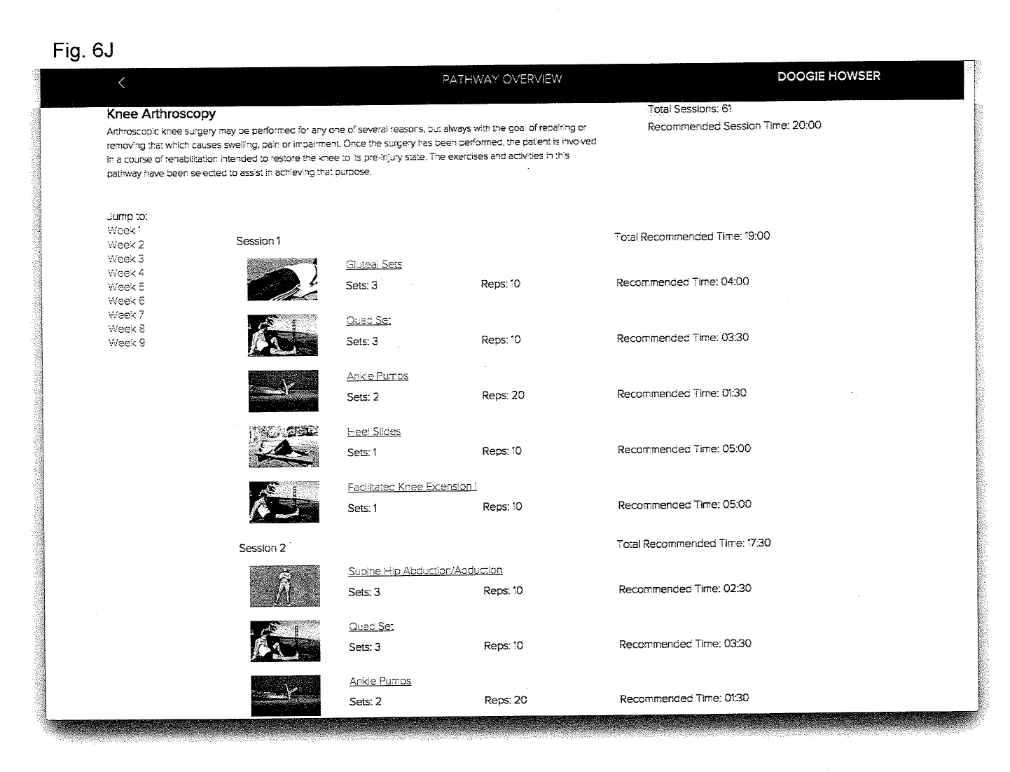

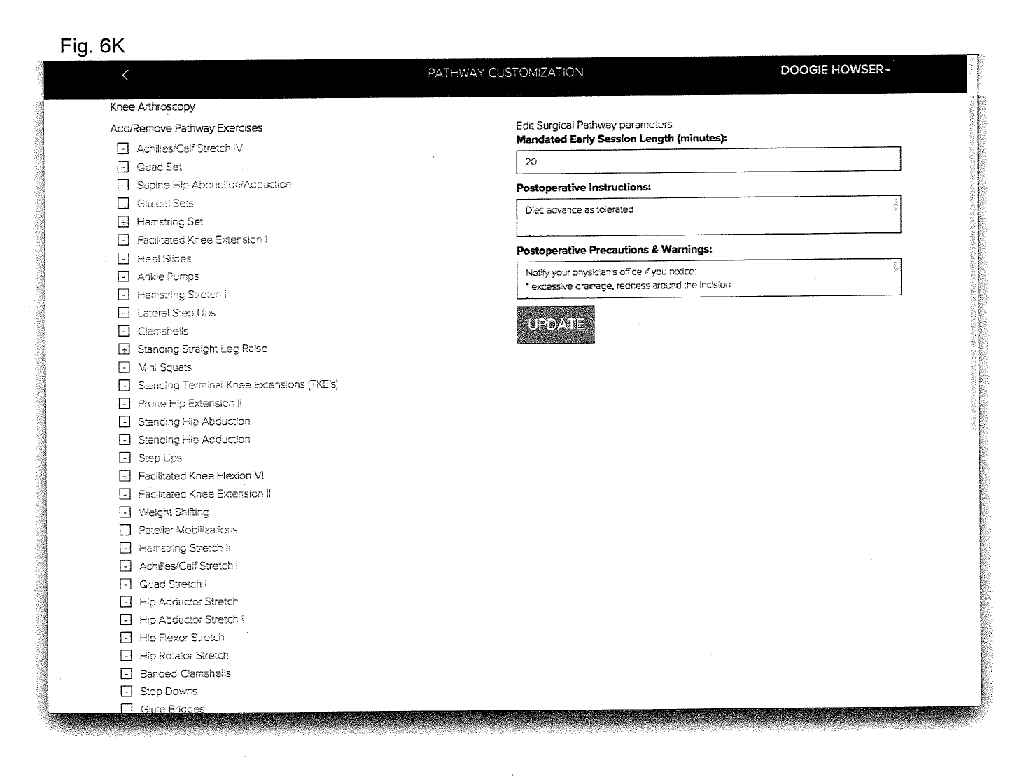

One example embodiment of the operation or process of the recovery system 100 of the present disclosure is illustrated in FIGS. 2A, 2B, 3, 4A to 4V, 5A, 5B, and 6A to 6K. More specifically, (1) FIGS. 2A and 2B are flowcharts generally illustrating the operation of this example embodiment of the recovery system from the perspective of the patient, (2) FIG. 3 is a flowchart generally illustrating the operation of this example embodiment of the recovery system from the perspective of the healthcare provider, (3) FIGS. 4A to 4V are a series of example interfaces or screen shots caused to be displayed to a patient via the patient access device by the recovery system 100, (4) FIGS. 5A and 5B are flowcharts generally illustrating the processes of the exercise selection algorithm to build an exercise session and to run or provide an exercise session that this example embodiment of the recovery system undertakes, and (5) FIGS. 6A to 6K are a series of example interfaces or screen shots caused to be displayed to a healthcare provider via the healthcare provider access device by the recovery system 100. This example embodiment of the operation or process of the recovery system 100 of the present disclosure relative to the patient is generally indicated by numeral 200 in FIGS. 2A and 2B. This example embodiment of the operation or process of the recovery system 100 of the present disclosure relative to the healthcare provider is generally indicated by numeral 300 in FIG. 3. Although this process is described with reference to the flowcharts illustrated in FIGS. 2A, 2B, 3, 5A, and 5B, it should be appreciated that many other methods of performing the acts associated with this process or method may be used. For example, the order of one or more of the steps described may be changed, or one or more steps described may be optional in accordance with the present disclosure.

As mentioned above, for purposes of simplicity and brevity, this application describes the recovery system with respect to one healthcare provider and one patient. As stated above, it should be appreciated that the recovery system of the present disclosure is meant to work with many healthcare providers, many healthcare provider access devices, with many patients, and many patient access devices, and the example embodiments herein are not meant to limit this disclosure in such manner.

In the example embodiment of FIGS. 2A, 2B, 3, 4A to 4V, 5A, 5B, and 6A to 6K, the recovery system first requires a healthcare professional to enroll a patient in or invite a patient to use the recovery system before the patient can access the recovery system. It should be appreciated that in alternative embodiments of the present disclosure, the recovery system enables a patient to use the recovery system without a healthcare professional enrolling or inviting the patient. In such alternative embodiments, either the recovery system or the patient will select the recovery pathway for the patient.

In various embodiments, as further described below, as part of the enrollment process, the recovery system obtains information about the patient from the healthcare provider. Such patient information includes but is not limited to: (1) patient identification and biographical information; (2) information regarding the patient's specific injury (and any related diseases); (3) the medical treatment that the patient has undergone (such as any surgery); and (4) the generally prescription for the recovery of the patient and more specifically the recovery pathway for the patient.

In various embodiments, the recovery system also or alternatively obtains information about the patient from one or more EHR systems. In such embodiments, the recovery system communicates with or is integrated with one or more EHR systems. In certain such embodiments, after a suitable triggering event, the recovery system securely receives patient information (in a HIPAA compliant manner) from one or more EHR systems, automatically enrolls a new patient in the recovery system, and automatically invites the patient to join the recovery system. In various embodiments, the recovery system may link an ICD-10 code to an exercise module appropriate for the specific injury. ICD and CPT codes specify diagnosis and procedures. In various embodiments, ICD-9, ICD-10, CPT and/or other coding systems are used in EHR integration messages so that the EHR system's orders can be directly translated into a specific patient recovery pathway of the recovery system. Each recovery pathway (and indirectly each exercise thereof) is thus associated with a specific diagnosis or condition, ICD-10 codes, CPT codes, or other codes in various embodiments. The recovery system thus links recovery pathways to specific codes from different coding systems in certain embodiments.

In these embodiments, the recovery system automatically creates and assigns recovery pathways for patients based on information received from the healthcare provider's EHR system. In various embodiments, the recovery system thus facilitates bi-directional and fully embedded integration with EHR systems. In various embodiments, the recovery system thus receives inbound orders or instructions to create, modify, or destroy patient recovery pathways, sends outbound status reports back to the EHR system for inclusion in the patient record, and provides or supports full web mashup for embedded use of the recovery system from within the EHR system.

Turing back to the figures, in the illustrated example embodiment, the recovery system 100 enables a healthcare provider (with an existing account) to securely sign into the recovery system 100 as indicated by block 301 of FIG. 3 and as generally shown in FIGS. 6A and 6B. As indicated above and below, all access to the recovery system 100 is protected at least by user names and passwords, and all communications with the recovery system having or related to patient information are suitably encrypted. It should be appreciated that in various embodiments, access to the recovery system is by invitation only and a healthcare provider must have an electronic invitation to join the recovery system. It should also be appreciated that healthcare providers can join individually or join as part of a group or practice. It should further be appreciated that the recovery system can vary the level of access for each healthcare provider who joins as part of a group or practice from having limited access for certain patients to having the ability to access any patient account associated with the group or practice.

If the healthcare provided has not previously accessed or joined the recovery system 100, the recovery system 100 enables the healthcare provider to create a new account as indicated by block 302 of FIG. 3. The recovery system 100 also walks the healthcare provider through an on boarding process as indicated by block 303 of FIG. 3 so that they become familiar with the various functions of the recovery system 100.

The recovery system 100 provides the healthcare provider access to a centralized list of patients assigned to the healthcare provider (or practice or group) as indicated by block 304 of FIG. 3 and as shown in FIG. 6C. Generally, the recovery system 100 enables the healthcare providers to perform various tasks including but not limited to: (a) accessing or otherwise determining specific patient details from this list; (b) adding new patients to this list as partly shown in FIG. 6D; (c) previewing existing or available recovery pathways and exercise instructions maintained by the system as partly shown in FIGS. 6F, 6I, and 6J; (d) viewing sample patient recovery pathways as partly shown in FIG. 6G; (e) managing existing patients (such as by editing patient demographics and other patient information, establishing, reviewing, or changing patient recovery pathways, completing patient recovery pathways as partly shown in FIG. 6H; (f) customizing recovery pathways per patient or for all of their patients as a template; (g) reviewing outcomes data generated by their patient's use of the recovery system as partly shown in FIG. 6E; (h) requesting new pathways and exercises to be added to the recovery system as partly shown in FIG. 6K; and (i) managing post op orders as appropriate (as indicated by block 308 of FIG. 3). In various embodiments, the recovery system 100 also enables the healthcare provider to have access to a content management system for defining and maintaining the content that they want to share with their patients related to post operative orders.

More specifically, the recovery system 100 provides a pathway dashboard interface (such as shown in FIG. 6E), which enables a healthcare provider to preview a list of available recovery pathways that are published and available for use through the recovery system 100 as indicated by block 305 of FIG. 3. The recovery system 100 enables the healthcare provider to access the recovery pathway details or information regarding the content of each specific recovery pathway (such as through interface shown in FIG. 6J) and as indicated by block 306 of FIG. 3. The recovery system 100 further enables the healthcare provider to customize the recovery pathway content for their practice (as shown in FIG. 6K). The recovery system enables the healthcare provider to save the recovery pathway customization to apply to all patients in the healthcare provider's practice.

Additionally, as part of the enrollment process and as mentioned above, in various embodiments, the recovery system enables the healthcare provider to utilize a library of existing exercise modules maintained by the recovery system to create customized protocols for the patient's recovery. The recovery system 100 enables the healthcare provider to preview specific pre-determined or pre-configured exercise content available through the recovery system 100 as indicated by block 307 of FIG. 3. The recovery system 100 further enables the healthcare provider to customize each of the specific exercise content to be used for their patients as mentioned above.

The recovery system 100 further provides a patient dashboard interface (such as the interface shown in FIG. 6F) which enables the healthcare provider to view the detailed progress of their patients through the patient's recovery pathway as indicated by block 309 of FIG. 3. This interface enables: (a) patient-healthcare provider communication; (b) individual patient recovery pathway customization; (c) review of patient-specific outcomes data; (d) review of detailed exercise logs; and (e) general status updates related to a specific patient's recovery pathway.

The recovery system 100 provides a patient log interface which enables the healthcare provider to review detailed information related to each of the patient's performance of exercises of their recovery pathway as indicated by block 310 of FIG. 3.

Turning now more specifically to FIGS. 2A, 2B, and 4A to 4V, in the illustrated example embodiment, the recovery system 100 enables each enrolled patient to use the patient access device to access and sign into the recovery system 100 as indicated by block 201 of FIG. 2A and as shown by interfaces 402 and 404 of FIGS. 4A and 4B. As indicated above, all access to the recovery system 100 is secured at least by user names and passwords, and all patient data in transit, at rest, and is use is suitably encrypted. The recovery system 100 determines if the patient is a first time user as indicated by diamond 202 of FIG. 2A.

If the patient is a first time user, the recovery system 100 enables the patient to create an account as illustrated in FIG. 205 of FIG. 2A and interface 406 of FIG. 4C. If the patient is a first time user, the recovery system 100 also provides an introduction and an on-boarding process for the patient as indicated by block 206 of FIG. 2A and as shown in example interfaces 408, 410, 412, 414, 416, 418, 420, and 422 of FIGS. 4D, 4E, 4F, 4G, 4H, 4I, 4J, and 4K. In such embodiments, the recovery system 100 accesses certain information regarding the patient (including information about the patient provided by the healthcare provider or EHR system regarding the patient and any past history of access to the recovery system), and directs the patient to view educational and on-boarding material on the patient's first visit. The on-boarding process includes the recovery system 100 exposing the patient to the various features and functions of the recovery system including the features and functions that present the patient with educational material about the patient's injury and recovery. The on-boarding process also includes the recovery system 100 asking and obtaining from the patient various information including personal system use preferences for the patient's future use of the recovery system 100 as described below. The recovery system 100 collects and stores this patient personal preference information and uses this information to customize the system's delivery of exercise sessions to the patient as well as materials and information provided to the patient during performance and management of the healthcare provider's recovery pathway for the patient. In other words, in various embodiments, the recovery system provides customized exercise sessions based on specific patient preferences (such as length and time of sessions, notifications, etc). In various embodiments, the recovery system also provides the patient personal motivational messages and awards at various points in time throughout recovery process as further discussed below.

In the illustrated example embodiment, the recovery system 100 causes the patient display device to display interface 416 of FIG. 4H which: (1) greets the patient (e.g., “Hi Chris”); (2) identifies the patient's injury and informs the patient of the patient's recovery pathway (e.g., “You have been assigned a pathway for your Hamstring Strain”); (3) informs the patient of the patient's needed time commitment for the recovery pathway (e.g., “If you can set aside time each day, you'll be on the road to recovery”); and (4) explains the flexibility of the recovery system to the patient (e.g., “Depending on how much time you have, we'll tailor your pathway to match your availability”). This illustrated example for the patient further includes the recovery system 100 causing the patient display device to display interface 418 of FIG. 4I which enables the patient to sign up for reminders that the recovery system 100 will send to the patient regarding their exercise sessions. This illustrated example process for the patient also includes the recovery system 100 causing the patient display device to display interface 420 of FIG. 4J which enables the patient to input the patient's goal(s) for the patient's recovery. This illustrated example process for the patient additionally includes the recovery system 100 causing the patient display device to display interface 422 of FIG. 4K which enables the patient to input the amount of time the patient can spend on each exercise session, and notifies the patient that they can change this as they progress with their recovery. It should be appreciated that as further explained above and below with respect to FIGS. 5A and 5B, the recovery system of the present disclosure is configured to alter the number, length, and other characteristics of each of the exercise sessions provided to the patient based on inputs from the patient (such as how much time the patient has for each exercise session each day).

If the patient is not a first time user, the recovery system 100 enables the patient to securely sign in and in this illustrated example embodiment directs the patient to a survey process if the recovery system determines that the survey process is appropriate or needed at that point in time as indicated by diamond 203 of FIG. 2A. In certain embodiments, the recovery system 100 determines if it is appropriate for the patient to answer the survey questions at predefined points during a patient's recovery process. The predefined intervals are determined by the originating author(s) of each respective particular outcome survey tool. If the recovery system determines that the patient should take a survey, the recovery system delivers the survey to the patient. In various embodiments, these surveys are not delivered as part of an exercise session, but are rather delivered as part of the sign on process. FIGS. 4U and 4V illustrate one example way the recovery system introduces and delivers these surveys to patients. During the survey process, the recovery system asks the patient various questions related to the patient's specific injury (or treatment) and obtains or collects and stores answers from the patient. In various embodiments, the recovery system uses specific questionnaires related to a patient's assigned recovery pathway to determine what survey to provide or questions to ask the patient. The recovery system scores the patient's answers based on published material in peer-reviewed journals by various authors. Each survey or set of questions may have its own defined scoring system. The recovery system then generates an outcome report or data for the patient and the healthcare provider of the patient. The healthcare provider may share this outcome report or data with an insurer for a specific patient, or, more likely, share anonymized data from a representative patient population. This data may be used to help the healthcare provider qualify for higher reimbursement rates based on proof of better outcomes performance. It should be appreciated that in various embodiments, the recovery system does not use the answers to these patient surveys to adjust the recovery pathway or select the exercises from the recovery pathway for any exercise sessions. It should be appreciated that in various alternative embodiments, the recovery system uses one or more of the answers to these patient surveys to adjust the recovery pathway and/or to select the exercises from the recovery pathway for one or more exercise sessions.

After the on-boarding process for first time patients, the survey process for existing patient (if appropriate), or after an existing patient (who does not need to take a survey) signs into the recovery system 100, the recovery system 100 enables the patient to access and see the patient's recovery pathway as indicated by block 207 of FIG. 2A, block 208 of FIG. 2A, interface 424 of FIG. 4L, and interface 426 of FIG. 4M. More specifically, the recovery system 100 displays and enables the patient to access and see: (1) the patient's overall prescribed or assigned recovery pathway as shown in interface 424 of FIG. 4L and 426 of FIG. 4M including the respective recovery stages of recovery (e.g., “early recovery,” “middle recovery,” “late recovery,” and “back in action”); (2) an overview of the patient's current progress through the prescribed or assigned recovery pathway and each of the states or stages as shown in interface 424 of FIG. 4L; and (3) up to date detailed performance statistics for the patient as shown in interface 426 of FIG. 4M including detailed descriptions of the injury and the goals for recovery at each stage. These interfaces provide the patient access to the detailed statistics related to the patient's personal progress through the healthcare provider assigned recovery pathway and to modifications made to the recovery pathway. The interface 424 of FIG. 4L enables the patient to start the day's exercise session and to access or see the recovery pathway overview and these detailed performance interfaces. While this example embodiment of the recovery system 100 uses the four stages of early recovery, mid or middle recovery, late recovery, and back in action to communicate with the patient, the present disclosure contemplates that the recovery system could employ various different stages and different quantities of stages.

In various embodiments, the recovery system 100 can provide the patient one or more exercise sessions per designated time period such as a day. Each exercise session is sometimes referred to in this application as “Today's Session” or the current session. It should be appreciated that the recovery system 100 can: (1) provide the patient any suitable number of exercise sessions per day; (2) provide the patient exercise sessions on a schedule other than a daily schedule (e.g., every other day, every third day, three times a week, four times a week, etc); and/or (3) provide different types of exercise sessions in any designated period of time, in accordance with the present disclosure. For example, if the patient indicates that the patient can only do two fifteen minute exercise sessions per day, the recovery system 100 restructures the exercise sessions based on these time limitations and more specifically the exercise selection algorithm selects the exercises from the recovery pathway for each exercise session in part based on this limitation. More specifically, in various embodiments, the recovery system does not limit the number of exercise sessions per day. Rather, the recovery system enables the patient to select a patient preference in how the patient wants to engage in the patient's recovery. The recovery system enables the patient to choose to perform some or all of the patient's exercise sessions at one or at multiple spaced apart times. For example, the recovery system enables the patient to choose to perform multiple full exercise sessions on a single day. However, in various embodiments, the determination of advancement by the recovery system is based on the performance of the first complete exercise session for the designated time period such as a day. The recovery pathways are based on a presumed and predetermined minimum quantity of successful exercise sessions. The recovery pathways are built on the presumption that more regular and appropriately lengthened exercise sessions will enable a patient to perform successful exercise sessions more frequently and thus advance at a greater pace.

In various embodiments, for post-surgical recovery pathways, the recovery system employs a predetermined quantity of exercise sessions to be performed per day during early recovery (which the individual healthcare provider is able to override or change).

In various embodiments, the recovery system employs a recovery pathway that includes one or more “prehab” exercise sessions which are performed by a patient prior to surgery or other procedure. The prehab exercise sessions can provides instructions which clarify the patient's understanding of their surgical or other procedure. The prehab exercise session can also provide exercises which prepare the patient for their surgical or other procedure.

When the patient accesses the Today's Session through interface 424 of FIG. 4L, the recovery system 100 provides the patient the appropriate exercise session (i.e., “Today's Session”) as indicated by block 210 of FIGS. 2A and 2B, and through the interface 428 of FIG. 4N. The recovery system provides the patient or displays to the patient a summary of each exercise selected by the exercise selection algorithm for the patient to perform during the exercise session as shown by interface 428 of FIG. 4N. This gives the patient a preview of the selected exercises to be performed in that exercise session.

As further explained below, the exercise of each exercise session is specifically selected by the exercise selection algorithm of the recovery system 100 to sequentially instruct, guide, and monitor the patient through the various stages of recovery, culminating with the goal of the patient's return to full physical function. The recovery system 100 selects each exercise (and characteristics of each exercise) using the exercise selection algorithm which is described above and further described below with respect to FIGS. 5A and 5B.

In various embodiments, each exercise session includes one or more exercises which the patient performs after watching one or more instructional exercise video(s) accompanied by audio and/or text instructions to understand the exercise that the patient is to perform. In various embodiments, the instructional exercise videos are instructional and are not intended to be used like a workout video. Rather, they instruct the patient on the proper technique, position, and form to use in the performance of a specific exercise.

In various embodiments, the exercise sessions are timed and include “count up” stopwatch functions (such as “count up” and “count down” functions) to aid in the patient's exercise performance.

In various embodiments, the recovery system records the time that the patient takes to perform each exercise (against the expected time to perform the exercise) as well as the pain response by the patient and the completion response by the patient. As mentioned above, in various embodiments, the recovery system captures exercise session patient activity through patient inputs using the patient interfaces provided by the recovery system (and alternatively or additionally through performance data obtained from one or more monitors such as one or more wearable devices or monitors associated with exercise equipment). In various alternative embodiments, the recovery system also or alternatively enables a patient to “log” their exercise session activity in “bulk”. In other words, the recovery system enables the patient to “log” or provide feedback for the patient's entire exercise session performance and does not require the patient to make individual inputs for (or step through) each individually displayed exercise.

In various embodiments, the recovery system enables the patient bring any concerns regarding the exercises to the attention of the patient's healthcare provider. In various embodiments, the recovery system enables the patient to “red flag” critical concerns for immediate redress by secure messaging to the patient's healthcare provider regarding each exercise. In various embodiments, the recovery system enables the patient to “red flag” critical concerns for immediate redress by secure messaging to an “on-call” healthcare provider, which enables the patient to obtain immediate assistance. In various embodiments, the recovery system enables the patient to share one or more pictures or short audio/video clips relating to any problems the patient is experiencing to enable the patient's healthcare provider to better understanding of the patient's complaints or concerns. For example, such a short an audio/video clip may be about one minute or less. However, in other embodiments, an audio/video clip can be longer, for example fifteen minutes or even thirty minutes. These audio/video instructions can bring clarity to the healthcare provider treatment and recovery concerns extending from immediate post injury and postoperative periods up to and through the return to full function, including sports functions.

In various embodiments, the recovery system collects data in a numeric graphic format for both patient and the healthcare provider, the purpose of which is to enable recovery progressions to be monitored in a dashboard configuration as mentioned above.

In various embodiments, the recovery system increases patient accountability by increasing the patient understanding of the exercises to be performed by the patient. The recovery system points out the injury imposed physical limitations to the patient that make clear which activities are acceptable and which activities are not acceptable. The recovery system provides patient specific recovery milestones that relate to the safe performance of specific activities to different recovery stages of the recovery pathway. For example, the recovery system will let a patient who is a runner know when it may be safe for the patient to try jogging around the block and running longer distances, subject to approval and permission by the patient's healthcare provider.

In the illustrated example embodiment, the interface 428 also includes bonus exercises for the patient. In other words, the recovery system 100 is configured to present the patient with opportunities to perform additional or bonus exercises during one or more of the exercise sessions based on one or more applicable factors (such as personal preferences provided by the patient) as indicated by diamond 212 of FIG. 2B. Based on the general belief that a higher level of regular and consistent time commitment yields better recovery results, the recovery system is configured to encourage patients to increase the patient's “committed” exercise time based on the patient's performance of non-bonus exercises and the patient's regular performance of additional bonus exercises. The recovery system uses this information to appropriately direct specific patients into higher performance exercises in the recovery pathways and speedier recovery.

The recovery system 100 enables the patient to start the exercise session by selecting the start session button of interface 428 of FIG. 4N. After starting the exercise session, the recovery system 100 provides or displays to the patient multimedia appropriate exercise content (under the control of the patient) as well as educational material, and performance monitoring and recording tools with each exercise as part of the provider assigned recovery pathway, as indicated by block 213 of FIG. 2B and interface 430 of FIG. 4O. In other words, the recovery system 100 guides the patient though each exercise selected for the exercise session as shown in interface 430 of FIG. 4O. For example, FIG. 4O enables the patient to watch an audio video segment that shows and tells the patient exactly how to perform the exercise (which is a stretching exercise in this illustrated example). The interface 430 provides the patient all of the needed information about the exercise (such as the number of sets, the number of seconds in each set, the rest period, a timer for conducting the exercise, a written description of the exercise, and the ability to skip the exercise if the patient needs to do so).

As further explained below, the recovery system 100 stores all important inputs by the patient during each exercise session and for or related to each exercise and uses that information for future exercise selection in the current exercise session and for future exercise sessions. More specifically, during each exercise session, the recovery system 100 and specifically the exercise selection algorithm of the recovery system 100 actively monitors the patient's progress in the performance of the current exercise session and customizes the delivery of one or more additional exercises and/or additional exercise content for the current exercise session as indicated by block 214 of FIG. 2B. In various embodiments, the exercise selection algorithm determines every exercise for the exercise session (whether or not a bonus exercise) based on monitoring the patient's performance and gathering biologic feedback from the patient as well as the recovery pathway.

The recovery system 100 detects when the patient has completed each exercise of the exercise session as indicated by block 215 of FIG. 2B, and thereafter the recovery system obtains and records the specific result to use the details from or of that exercise session to select or customize the content of the next exercise of that exercise session for the patient (if necessary). In the illustrated embodiment, the recovery system 100 obtains answers to certain questions regarding the exercise directly from the patient as illustrated in interface 432 of FIG. 4P. These questions in this illustrated embodiment include whether the exercise was easy, just right, too hard, and/or painful as illustrated in interface 432 of FIG. 4P. The recovery system 100 captures and stores the result of the patient performing the exercise and uses this information as input to drive the future selection of session exercises by the exercise selection algorithm. In other words, the recovery system 100 customizes the exercise sessions provided to the patient based on the patient response or the patient's feedback provided after each exercise. In various embodiments, the recovery system collects different patient feedback for different exercises or different types of exercise. For example, a range of motion exercise is expected to cause pain as the patient is attempting to restore full range. In the case of these types of exercises, the recovery system does not ask for a specific pain response (unless extreme) or easy/hard/just-right, but rather asks the patient one or more questions to try to determine the patient's progress in restoring the patient's full range of motion.

The recovery system 100 determines whether the exercise is finished as indicated by decision diamond 215 of FIG. 2B. If the exercise is completed, the recovery system 100 determines from the patient if the exercise caused pain as indicated by decision diamond 216 of FIG. 2B and interface 432 of FIG. 4P. If the patient indicates that the performance of the exercise caused the patient any pain, the recovery system 100 determines how much pain the exercise caused the patient using interface 434 of FIG. 4Q. The recovery system 100 captures and stores the patient's pain response(s) regarding the performance of the specific exercise as indicated by block 217 of FIG. 2B. If the patient indicates that the performance of the exercise did not cause the patient any pain, the recovery system 100 captures and stores this response to the performance of a specific exercise as indicated by block 219 of FIG. 2B. In other words, the recovery system 100 captures and stores the result of the patient performing the exercise which the recovery system subsequently uses as input to drive the future selection of session exercises by the exercise selection algorithm. In various embodiments, the exercise selection algorithm categorizes pain response into four categories including: (1) minor—pain is OK and expected and doesn't impede advancement; (2) moderate—pain is higher than normal and prevents advancement; (3) high—pain is much higher than normal and level of difficulty is reduced where possible for future exercise; and (4) extreme—pain is extreme, the exercise session is immediately ended and the recovery system instructs the patient to ice the injury area, rest, try again at a subsequent time (such as the next day) and to contact the patient's healthcare provider. It should be appreciated that, as mentioned above, different categories of exercises have different interpretations of pain response. In the example of range of motion, moderate is treated as minor for example. The recovery system thus enables specific interpretation of a patient's response based on the type of exercise performed.

If the recovery system 100 determines that the patient does not start or finish the exercise, the recovery system 100 determines the reason why the patient skipped or did not complete the exercise using interface 436 of FIG. 4R and as indicated by block 218 of FIG. 2B. The recovery system 100 uses the skipped or partially performed exercise information as input or data for the exercise selection algorithm. The recovery system 100 captures and stores the reason the patient skipped the exercise to customize the further instructions to the patient for the current exercise session. Additionally, the recovery system captures this information in analytics to help drive content changes to overall recovery pathway for the patient. In various embodiments, a skipped response is used to determine lack of exercise equipment, lack of clarity in understanding the exercise, inappropriateness of the exercise, or other fact.

As stated above, it should be appreciated that in certain embodiments, the recovery system 100 also obtains information regarding the patient's performance of the exercise from one or more monitors 120a, 120b, 120c . . . 120z generally shown in FIG. 1A. In these embodiments, the recovery system 100 captures and stores these additional results of the patient performing the exercise, which the recovery system subsequently uses as input or data to drive the future selection of session exercises by the exercise selection algorithm.

After obtaining the necessary information regarding the performed (or skipped or partially skipped exercise, the recovery system 100 determines if there are any more selected exercises in the current session as indicated by decision diamond 214 of FIG. 2B. If there are more selected exercises in the current exercise session, the recovery system 100 informs the patient using interface 438 of FIG. 4S and then the recovery system 100 repeats the process of providing the next exercise and evaluating the patient's performance of the next exercise. The recovery system 100 continues in this loop until all of the exercises of the current exercise session are completed (or skipped or partially skipped). It should be appreciated that the quantity of the exercises in the exercise session may vary during the exercise session based on the feedback from the patient. As mentioned above, the recovery system enables the logging of a full exercise session without the requirement of stepping through each individual exercise in the exercise session.

As further discussed below, the recovery system 100 determines when the patient has completed the exercises of exercise session as indicated by block 214 of FIG. 2B.

After the recovery system 100 determines that the patient has completed the exercises of exercise session, the recovery system 100 notifies the patient and asks the patient if the patient wants to perform bonus exercise or wants to see the patient's pathway as shown in interface 440 of FIG. 4T and as indicated by block 212 of FIG. 2B. If the patient wants to do one or more bonus exercises, for each bonus exercise, the recovery system 100 provides the next bonus exercise and evaluates the patient's performance of that bonus exercise in a similar manner to each of the previous exercises. The recovery system 100 continues in this loop until the bonus exercises of the current session are completed (or skipped or partially skipped).

More specifically, referring now to FIGS. 5A and 5B, the recovery system 100 employs algorithms or processes 500 and 550 respectively to build each exercise session by determining or selecting each exercise for each exercise session to be provided by the recovery system 100 from the possible available exercises of the recovery pathway at each point in time, and to run each built exercise session or provide each exercise session to the patient.

Referring specifically now to FIG. 5A, the recovery system 100 accesses the relevant data for the exercise categories from the assigned patient recovery pathway as indicated by block 501 of FIG. 5A. This includes the categories in the recovery pathway, the exercises in the recovery pathway, the levels of the exercises in the recovery pathway, and the then current level of the patient in each of the categories.

As indicated above, the recovery system initially determines the amount of time that the patient has available for each exercise session. During each exercise session, the recovery system tracks or monitors the amount of time that the patient is in or is using the exercise session. This can be done by the recovery system in any suitable manner (such as employing start and stop buttons). The recovery system can also track the amount of total time that the patient is logged into the recovery system.

It should be appreciated that the recovery system enables the patient to change the amount of time the patient has available for each exercise session at various suitable times. For instance, the recovery system enables to the patient to increase the time for one or more of their exercise sessions. It should be further appreciated that more patient time devoted to recovery (within reasonable limits) will generally lead to quicker and better recovery. Thus, in various embodiments, the recovery system entices or makes offers to the patient to increase the time the patient devoted to one or more exercise sessions (if needed) such as by offering bonus exercises. The recovery system also enables the patient to decrease the amount of time for one or more of their exercise sessions for their personal scheduling or for other reasons. It should be appreciated that in various embodiments, the recovery system suggests ideal amount of time for the exercise sessions for the patient. Some recovery pathways also are configured to have exercises that are best performed by the patient multiple times per day.

In various embodiments, the exercise selection algorithm initially determines or selects all of the exercises for the exercise session before the exercise session begins, and modifies these selections based on patient feedback as necessary. This embodiment enables the patient preview the selected exercises for the exercise session as mentioned above.

In various alternative embodiments, the exercise selection algorithm initially determines or selects all of the exercises for the exercise session before the exercise session begins, modifies these selections based on patient feedback as necessary, and also enables the patient to select the order of the exercises based on their time available or other suitable patient factors.

In other embodiments, the exercise selection algorithm determines a designated quantity of exercises (such as one) for the exercises session, and then awaits patient feedback to dynamically select each subsequent quantity of exercises.

In the embodiments where the recovery system determines all of the exercises for the exercise session before the exercise session begins, the recovery system 100 determines the amount of time the patient has indicated the patient has available for each session and determines based on an estimated amount of time the patient will use on each already selected exercise of the exercise session to determine if the patient will have a suitable amount of remaining time for any more exercises in the exercise session as indicated by decision diamond 502 of FIG. 5A.

If there is not enough remaining time, the recovery system 100 completes creating the exercise session content as indicated by block 503 of FIG. 5A.

If there is enough remaining time in the exercise session for one or more exercises, the recovery system 100 determines the next category (if any) of the recovery pathway from which to possibly select an exercise for the exercise session as indicated by decision diamond 504 of FIG. 5A. It should be appreciated that for the selection of the first exercise for the exercise session, the next category may be the first category of the recovery pathway.

If there are no further or next categories of the recovery pathway from which to select an exercise for the exercise session being built, the building of the exercise session is completed as indicated by block 503 of FIG. 5A. For example, if the exercise selection algorithm has selected one exercise from each of all four available exercise categories of the recovery pathway for the exercise session, then since there are no further categories to select exercises from in the recovery pathway, the exercise selection process is complete. It should be appreciated that the exercise selection algorithm can be configured to select more than one exercise from each available category of the recovery pathway, and that the exercise selection algorithm can be configured to select unequal or different quantities of exercises from different available categories of the recovery pathway.

It should further be appreciated that the recovery system can enable the healthcare provider to determine the quantity of exercises from each available category of the recovery pathway that the exercise selection algorithm will select for each of the exercise sessions. It should further be appreciated as mentioned above that the exercise selection algorithm may not select every exercise from every category of the recovery pathway for the exercise sessions and that the patient may complete the recovery pathway without performing one or more exercises in one or more categories.

If there is another possible category or a next category of exercises of the patient's recovery pathway to possibly select an exercise from, the exercise selection algorithm of the recovery system determines if that category is available to be selected from based on the progress of the patient through the recovery pathway. In this illustrated embodiment, the exercise selection algorithm of the recovery system determines if the category weight is greater than zero for the current recovery stage as indicated by decision diamond 505 of FIG. 5A.

It should be appreciated that each recovery stage has a designated amount of time for each category. Depending on the recovery stage, one or more of the categories in the recovery pathway may have a weight or amount of time set as zero because the recovery pathway does not want the patient to conduct any exercises in that category at that stage of recovery. For example, in the early recovery stage, the range of motion category may be set at twenty percent of the time for the exercise session, the strengthening exercise category and stretching exercise category be may each be set at forty percent of the time for the exercise session, and the proprioception category may be set at zero percent of the time for the exercise session. This weighting controls the types of exercises that the exercise selection algorithm selects for each recovery stage. It should thus be appreciated that different categories may have different weights for different stages of recovery.

If the category weight of this next possible category is not greater than zero for the current recovery stage, the exercise selection algorithm of the recovery system 100 does not select any exercise from this category, and the recovery system 100 repeats the determination of whether a next category is available as indicated by diamond 504 of FIG. 5A.

If the category weight is greater than zero for the current recovery stage, the exercise selection algorithm of the recovery system selects or obtains the next available exercise of that category of the recovery at the current difficulty level for that category as indicated by block 506 of FIG. 5A.

The exercise selection algorithm of the recovery system 100 determines if the exercise available and the cumulative estimated exercise time is less than or equal to the weighted category time for the patient as indicated by decision diamond 507 of FIG. 5A.

If not, the exercise selection algorithm of the recovery system 100 does not select any exercise from this category, and the recovery system 100 repeats the determination of whether a next category is available as indicated by diamond 504 of FIG. 5A.

If so, the recovery system 100 adds the selected exercise to the exercise session as indicated by block 508 of FIG. 5A. After doing so, the exercise selection algorithm of the recovery system 100 repeats the process of selecting or obtaining the next available exercise of that category of the recovery at the current difficulty level for that category as indicated by block 506 of FIG. 5A.

These processes are illustrated in the above referenced example of FIGS. 1D to 1U. In this example, the first exercise session is part of the early patient recovery stage. In this first exercise session (of FIG. 1 D), the total time for the exercises in the exercise session is 1050 seconds (or 17.5 minutes). The recovery system has divided the patient indicated time for each category at this stage of recovery for the patient. In this example for the first recovery stage, the recovery system has set strengthening exercises at 360 seconds, range of motion exercises at 600 seconds, and exercises from another category at 90 seconds. In this simulates example, the exercise selection algorithm has selected the available exercises from each of the respective available exercise categories of the recovery pathway based in part on the amount of time that each exercise will take and the total amount of available patient time.

In this example, the eight exercise session (of FIG. 1E) is part of the mid patient recovery stage. In this eight exercise session, the total time for the exercises in the exercise session is 1140 seconds (or 19 minutes). The recovery system has divided the patient indicated time for each category at this stage of recovery for the patient. In this example, for this exercise session, the patient has indicated that the patient can increase the amount of time dedicated to this exercise session (or that this session is within the total allotted time indicated by the patient). In this example for the mid recovery stage, the recovery system has set strengthening exercises at 450 seconds, range of motion exercises at 600 seconds, and exercises from another category at 90 seconds. The exercise selection algorithm has selected the available exercises from each of the respective available exercise categories of the recovery pathway based in part on the amount of time that each exercise will take and the total amount of available patient time.

This example of FIGS. 1D to 1U thus shows how the exercise selection algorithm works to select exercises in various embodiments of the present disclosure.

In the embodiments where the exercise selection algorithm determines a designated quantity of exercises (such as one) for the exercise session, and then awaits patient feedback to dynamically select each of the subsequent exercises of the exercise session, the above determinations are not based on estimated time amounts that the patient will need to perform the selected exercises, but rather based on actual times that the patient takes to perform the exercises. Is this case, at each step where the exercise selection algorithm uses an amount of time to make a decision, that decision is based on inputs by the patient and/or tracking by the recovery system. In this case, each time an exercise is selected, the recovery system creates the content of that exercise for the patient (instead of creating all of the content for the exercises selected for the exercise session at one time).

Turning now to FIG. 5B, the exercise selection algorithm of the recovery system 100 performs process 550 for running or providing the exercise session to the patient, for monitoring patient progress, and for obtaining patient feedback.

This process 550 includes the exercise selection algorithm of the recovery system 100 determining if any next exercise for the exercise session is available or if there are any more selected regular or bonus exercises that the exercise selection algorithm has selected for the exercise session that has not been performed by the patient as indicated by decision diamond 540 of FIG. 5B.

If not, the recovery system 100 marks the exercise session as completed as indicated by block 541 of FIG. 5B.

If so, the recovery system 100 provides, displays, or enables the patient to display the next selected exercise of the exercise session to the patient to perform as indicated by block 542 of FIG. 5B.

The recovery system 100 determines if the patient skips the selected exercise as indicated by decision diamond 543 of FIG. 5B.

If so, the recovery system 100 captures from the patient the reason that the patient skipped the selected exercise as indicated by block 544 of FIG. 5B. The recovery system then returns to determining if there are any remaining selected exercises in the exercise session for the patient to perform as indicated by diamond 540 of FIG. 5B. In various embodiments, the exercise selection algorithm of the recovery system 100 dynamically selects an alternative exercise for the patient to perform if the patient skips an exercise (using the process 500 of FIG. 5A).

If the patient did not skip the selected exercise and thus performed or partially performed the selected exercise, the recovery system 100 determines from the patient if the exercise caused any pain to the patient as indicated by decision diamond 545 of FIG. 5B.

If the selected exercise did not cause any pain to the patient, the recovery system 100 captures and stores this information and thus result that the patient performed the selected exercise without any pain as indicated by block 546 of FIG. 5B. It should be appreciated that the recovery system can capture different levels of information from the patient regarding the patient's performance of the exercise. For example, the system can capture biometric information regarding the patient's improvements (if any) such as but not limited to: (a) the range of motion; (b) strength; (c) functional movements; (d) flexibility; and (e) endurance.

The recovery system then returns to determining if there are any remaining selected exercises in the exercise session for the patient to perform as indicated by diamond 540 of FIG. 5B.

If the patient indicates that the selected exercise caused any pain to the patient, the recovery system 100 obtains from the patient the pain level and stores the pain level as indicated by block 547 of FIG. 5B. It should also be appreciated that the recovery system can capture and store any suitable level of information regarding the patient's pain.

The recovery system 100 determines if the pain level is too high or above a threshold as indicated by decision diamond 548 of FIG. 5B.

If the pain level is too high or above a threshold, the recovery system 100 marks the exercise session as completed as indicated by block 541 of FIG. 5B, and in one embodiment does not provide any further selected exercises of the exercise session to the patient to perform. The various alternatives that the recovery system can employ if the patient has too much pain are described above.

If the pain level is not too high or not above a threshold, the recovery system returns to determining if there are any remaining selected exercises in the exercise session for the patient to perform as indicated by diamond 540 of FIG. 5B.

It should be appreciated from the above that in certain embodiments, the present disclosure thus provides a patient recovery system for assisting a patient in recovery from a physical injury, where the recovery system includes at least one server configured to communicate over a data network to cause a selection of a stored pre-defined recovery pathway for the patient, the recovery pathway including a plurality of exercises for recovery from the physical injury, wherein a plurality of the exercises are initially available for selection. In these embodiments, the at least one server is configured to communicate over a data network with a patient access device to (a) cause a selection of a plurality of the available exercises of the recovery pathway for an exercise session; (b) cause the patient access device to display exercise instructional content on how to perform each of the plurality of the exercises of the exercise session; (c) cause the patient access device to obtain feedback from the patient regarding one of: (i) the patient's performance or non-performance of each of the plurality of the exercises of the exercise session, and (ii) the exercise session; (d) based on the feedback, adjust availability of the exercises in the recovery pathway for selection for a subsequent exercise session; and (e) cause the patient access device to display an indication of the patient's progress through the recovery pathway.

It should further be appreciated from the above that in certain embodiments, the present disclosure thus provides a patient recovery system for assisting a patient in recovery from a physical injury, wherein the patient recovery system includes at least one server configured to communicate over a data network to cause a selection of a stored pre-defined recovery pathway for the patient, the recovery pathway including a plurality of exercises for recovery from the physical injury, wherein a plurality of the exercises are initially available for selection. In these embodiments, the at least one server is configured to communicate over a data network with a patient access device to: (a) cause a selection of one of the available exercises of the recovery pathway for an exercise session; (b) cause the patient access device to display exercise instructional content on how to perform the selected exercise of the exercise session; (c) cause the patient access device to obtain feedback from the patient regarding the patient's performance or non-performance of the selected exercise of the exercise session; (d) based on the feedback, adjust availability of the exercises in the recovery pathway for selection for one of: (i) the rest of the exercise session, and (ii) a subsequent exercise session; and (e) cause the patient access device to display an indication of the patient's progress through the recovery pathway.

It should also be appreciated from the above, that in various embodiments: (1) the selected stored pre-defined recovery pathway can be customized; (2) the selected stored pre-defined recovery pathway can be customized by a healthcare provider; and/or (3) the selection of the stored pre-defined recovery pathway for the physical injury is from a plurality of different stored pre-defined recovery pathways for the physical injury.

It should also be appreciated from the above, that in various embodiments, the exercises of the recovery pathway are organized by categories, each category includes one or more exercises, each exercise is associated with a predefined level of difficulty for that recovery pathway, and each category is part of at least one recovery stage for the patient. It should further be appreciated from the above, that is various such embodiments: (1) the availability for selection of the plurality of the exercises of the recovery pathway for the exercise session is at least partly based on the recovery stage of the patient; (2) the availability for selection of the plurality of the exercises of the recovery pathway for the exercise session is at least partly based on the recovery stage of the patient and one of a plurality of different designated weights associated with each category; (3) the availability for selection of the plurality of the exercises of the recovery pathway for the exercise session is at least partly based on the availability of the categories to select exercises from; (4) the availability for selection of the plurality of the exercises of the recovery pathway for the exercise session is at least partly based on the level of difficulty associated with each of the exercises; (5) the availability for selection of the plurality of the exercises of the recovery pathway for the exercise session is at least partly based on a determination of the categories available to be selected from based on progress of the patient performing the exercises of the categories of the recovery pathway; (6) the selection of the plurality of the available exercises of the recovery pathway for the exercise session is at least partly based on an indicated amount of time; (7) the selection of the plurality of the available exercises of the recovery pathway for the exercise session is at least partly based on an amount of time the patient has indicated the patient has available for the exercise session; (8) the selection of the plurality of the available exercises of the recovery pathway for the exercise session is at least partly based on an estimated amount of time that will remain in the exercise session based after at least one other selected exercise is performed by the patient and based on an amount of time the patient has indicated the patient has available for the exercise session; (9) the selection of the plurality of the available exercises of the recovery pathway for the exercise session is at least partly based on an actual amount of time that remains in the exercise session after at least one other selected exercise is performed by the patient and based on an amount of time the patient has indicated the patient has available for the exercise session; and/or (10) the selection of the plurality of the available exercises of the recovery pathway for the exercise session is at least partly based on the recovery stage of the patient, a designated weight associated with each category, and an indicated amount of time.

It should also be appreciated from the above, that in various embodiments, that the recovery system includes causing the patient access device to display different possible responses in a color coded scale to designated survey questions.

It should further be appreciated from the above, that in various embodiments, the recovery system provides the patient access to an overview of as well as a detailed explanation of the patient's recovery pathway at various points in time as indicated by block 211 of FIG. 2A. The overview and detailed explanations may include: (1) a high level view of the patient's progress through their healthcare provider assigned recovery pathway; (2) a detailed view of the patient's progress through their healthcare provider assigned recovery pathway; (3) related educational material; (4) exercise equipment listing; (5) post operative instructions (as appropriate); and/or (6) instructional videos.

In various alternative embodiments and as further described below, the recovery system may also provide easy access to the tools and equipment (such as shoulder wands, pulleys, therabands, etc.) required by the patient for recovery and specifically for conducting one or more of the exercises. This equipment can aid in the rehabilitative process as well as the fitness experience by augmenting the exercise challenge. In various embodiments, the tools and equipment are associated with preset diagnosis protocols. These are defined based on the exercises that are included in the recovery pathway. For example, certain exercises require specific exercise equipment for the patient to perform them.

It should be appreciated from the above, that for each patient (such as an athlete) recovering from an injury, the recovery system and method of the present disclosure provides an intuitive, dynamic, and interactive approach to the management of the patient's recovery of that injury.

It should also be appreciated from the above, that the recovery system enhances patient compliance by offering a timed and goal-oriented progression through the patient's recovery. In various embodiments, the recovery system provides patient rewards to the patients for performing certain activities or achieving certain milestones. In certain such embodiments, the recovery system generate badges for patients based on the patient's achieving level advancement in each exercise category, completing surveys, performing prehab sessions, and completing session “streaks” (i.e., doing their exercise sessions when the patient says that the patient will do them).

In various embodiments, the recovery system provides outcome data in various different formats. In one format, the recovery system causes the patient access device to display different possible responses in a color-coded scale to designated survey questions as generally shown in FIG. 4V. The color-coded scheme is the same for different sets of questions and responses, which enables the patient to learn and become familiar with the scheme for answering subsequent survey questions. In various alternative embodiments, the recovery system can provide the questions and responses in an audio format. It should also be appreciated that audio or other types of communications can thus be used for any suitable communication functions of the recovery system.

In various alternative embodiments, the recovery system is configured to be used, linked to, or to communicate with one or more other systems or healthcare providers which provide the recovery system the selected exercises of one or more of the recovery pathways when authorized, and which obtain from the recovery system information regarding the patient's performance and patient feedback. In certain such embodiments, the recovery system uses the exercise selection algorithm to select the exercise for each exercise session. In other such embodiments, the recovery system does not use the exercise selection algorithm to select the exercise for each exercise session, but rather provides the exercises specifically provided by the other systems or by the healthcare provider. It should thus be appreciated that in certain embodiments the recovery system of the present disclosure can be configured as an exercise session provider without using the exercise selection algorithm.

It should be appreciated that the recovery system of the present disclosure can be configured to enable the patient to interact with one or more other patients who are utilizing the exercise content to achieve a similar purpose, and can, in effect, become virtual workout partners.

It should be appreciated from the above, that various embodiments of the system of the present disclosure provides the patient education and other content that helps the patient better understand the patient's injury and the steps required to recover from that injury. By empowering the patient with this knowledge, the recovery system helps to increase the patient's level of participation in the patient's own healthcare, which in turn, elevates the patient's compliance with the prescribed recovery pathway and accountability for the patient's recovery. Through making the patient a partner in the process, the recovery system also improves communication between the healthcare provider and the patient, which can work to increase the likelihood of a more positive recovery.

### Recovery System Interaction with Exercise Equipment

As mentioned above, in various embodiments, the recovery system is configured to obtain data or information from one or more monitors such as monitors: (1) worn by the patient; (2) which watch the patient perform the exercises; and/or (3) which are connected to the exercise equipment used by the patient.

### Recovery System Related Equipment

In various embodiments, the recovery system is configured to provide the patient with information regarding equipment purchase and use such as crutch fitting, ambulation, donning and doffing selected DME products (such as braces, slings, and the like), ankle brace fitting, dressing change, cryotherapy, postoperative knee brace fitting, and nutrition, and weight management.

In various embodiments, the recovery system also provides exercise modules which provide one or more links for the purchase of fitness supplies and/or durable equipment, the use of which can be demonstrated by the exercise sessions as well as educational presentations provided by the recovery system.

In various embodiments, the recovery system also provides exercise modules with one or more links for additional educational material to medical journals (such as the Journal of Arthroscopic and Related Surgery, the American Journal of Sports Medicine, and the like).

It should be appreciated that the recovery system of the present disclosure thus can relieve a healthcare provider from the burden of ordering, inventorying, dispensing, and/or billing related to these materials and information, and can do so with increased efficiency and at lower cost.

It should be understood that modifications and variations may be effected without departing from the scope of the novel concepts of the present invention, and it should be understood that this application is to be limited only by the scope of the claims.

The invention is claimed as follows:

1. A patient recovery system for assisting a patient in recovery from a physical injury, said patient recovery system comprising:
at least one server configured to communicate over a data network to cause a selection of a stored pre-defined recovery pathway for the patient, the recovery pathway including a plurality of exercises for recovery from the physical injury, wherein a plurality of the exercises are initially available for selection; and
at least one server configured to communicate over a data network with a patient access device to:
(a) cause a selection of a plurality of the available exercises of the recovery pathway for an exercise session;
(b) cause the patient access device to display exercise instructional content on how to perform each of the plurality of the exercises of the exercise session;
(c) cause the patient access device to obtain feedback from the patient regarding one of: (i) the patient's performance or non-performance of each of the plurality of the exercises of the exercise session, and (ii) the exercise session;
(d) based on the feedback, adjust availability of the exercises in the recovery pathway for selection for a subsequent exercise session; and
(e) cause the patient access device to display an indication of the patient's progress through the recovery pathway.

2. The patient recovery system of claim 1, wherein the at least one server is configured to communicate over the data network to enable the selected stored pre-defined recovery pathway to be customized.

3. The patient recovery system of claim 1, wherein the at least one server is configured to communicate over the data network with a healthcare provider access device to enable the stored pre-defined recovery pathway to be customized by a healthcare provider.

4. The patient recovery system of claim 1, wherein the at least one server is configured to communicate over the data network to enable the selection of the stored pre-defined recovery pathway for the physical injury from a plurality of different stored pre-defined recovery pathways for the physical injury.

5. The patient recovery system of claim 1, wherein the exercises of the recovery pathway are organized by categories, each category includes one or more exercises, each exercise is associated with a predefined level of difficulty for that recovery pathway, and each category is part of at least one recovery stage for the patient.

6. The patient recovery system of claim 5, wherein the availability for selection of the plurality of the exercises of the recovery pathway for the exercise session is at least partly based on the recovery stage of the patient.

7. The patient recovery system of claim 5, wherein the availability for selection of the plurality of the exercises of the recovery pathway for the exercise session is at least partly based on the recovery stage of the patient and one of a plurality of different designated weights associated with each category.

8. The patient recovery system of claim 5, wherein the availability for selection of the plurality of the exercises of the recovery pathway for the exercise session is at least partly based on the availability of the categories to select exercises from.

9. The patient recovery system of claim 5, wherein the availability for selection of the plurality of the exercises of the recovery pathway for the exercise session is at least partly based on the level of difficulty associated with each of the exercises.

10. The patient recovery system of claim 5, wherein the availability for selection of the plurality of the exercises of the recovery pathway for the exercise session is at least partly based on a determination of the categories available to be selected from based on progress of the patient performing the exercises of the categories of the recovery pathway.

11. The patient recovery system of claim 5, wherein the selection of the plurality of the available exercises of the recovery pathway for the exercise session is at least partly based on an indicated amount of time.

12. The patient recovery system of claim 5, wherein the selection of the plurality of the available exercises of the recovery pathway for the exercise session is at least partly based on an amount of time the patient has indicated the patient has available for the exercise session.

13. The patient recovery system of claim 5, wherein the selection of the plurality of the available exercises of the recovery pathway for the exercise session is at least partly based on an estimated amount of time that will remain in the exercise session based after at least one other selected exercise is performed by the patient and based on an amount of time the patient has indicated the patient has available for the exercise session.

14. The patient recovery system of claim 5, wherein the selection of the plurality of the available exercises of the recovery pathway for the exercise session is at least partly based on an actual amount of time that remains in the exercise session after at least one other selected exercise is performed by the patient and based on an amount of time the patient has indicated the patient has available for the exercise session.

15. The patient recovery system of claim 5, wherein the selection of the plurality of the available exercises of the recovery pathway for the exercise session is at least partly based on the recovery stage of the patient, a designated weight associated with each category, and an indicated amount of time.

16. The patient recovery system of claim 1, which includes causing the patient access device to display different possible responses in a color-coded scale to designated survey questions.

17. A patient recovery system for assisting a patient in recovery from a physical injury, said patient recovery system comprising:
at least one server configured to communicate over a data network to cause a selection of a stored pre-defined recovery pathway for the patient, the recovery pathway including a plurality of exercises for recovery from the physical injury, wherein a plurality of the exercises are initially available for selection; and
at least one server configured to communicate over a data network with a patient access device to:
(a) cause a selection of one of the available exercises of the recovery pathway for an exercise session;
(b) cause the patient access device to display exercise instructional content on how to perform the selected exercise of the exercise session;
(c) cause the patient access device to obtain feedback from the patient regarding the patient's performance or non-performance of the selected exercise of the exercise session;
(d) based on the feedback, adjust availability of the exercises in the recovery pathway for selection for one of: (i) the rest of the exercise session, and (ii) a subsequent exercise session; and
(e) cause the patient access device to display an indication of the patient's progress through the recovery pathway.

18. The patient recovery system of claim 17, wherein the at least one server is configured to communicate over the data network to enable the selected pre-defined recovery pathway to be customized.

19. The patient recovery system of claim 17, wherein the at least one server is configured to communicate over the data network with a healthcare provider access device to enable the pre-defined recovery pathway to be customized by a healthcare provider.

20. The patient recovery system of claim 17, wherein the at least one server is configured to communicate over the data network to enable the selection of the stored pre-defined recovery pathway for the physical injury from a plurality of different stored pre-defined recovery pathways for the physical injury.

21. The patient recovery system of claim 17, wherein the exercises of the recovery pathway are organized by categories, each category includes one or more exercises, each exercise is associated with a predefined level of difficulty for that recovery pathway, and each category is part of at least one recovery stage for the patient.

22. The patient recovery system of claim 21, wherein the availability for selection of the plurality of the exercises of the recovery pathway for the exercise session is at least partly based on the recovery stage of the patient.

23. The patient recovery system of claim 21, wherein the availability for selection of the plurality of the exercises of the recovery pathway for the exercise session is at least partly based on the recovery stage of the patient and one of a plurality of different designated weights associated with each category.

24. The patient recovery system of claim 21, wherein the availability for selection of the plurality of the exercises of the recovery pathway for the exercise session is at least partly based on the availability of the categories to select exercises from.

25. The patient recovery system of claim 21, wherein the availability for selection of the plurality of the exercises of the recovery pathway for the exercise session is at least partly based on the level of difficulty associated with each of the exercises.

26. The patient recovery system of claim 21, wherein the availability for selection of the plurality of the exercises of the recovery pathway for the exercise session is at least partly based on a determination of the categories available to be selected from based on progress of the patient performing the exercises of the categories of the recovery pathway.

27. The patient recovery system of claim 21, wherein the selection of the plurality of the available exercises of the recovery pathway for the exercise session is at least partly based on an indicated amount of time.

28. The patient recovery system of claim 21, wherein the selection of the plurality of the available exercises of the recovery pathway for the exercise session is at least partly based on an amount of time the patient has indicated the patient has available for the exercise session.

29. The patient recovery system of claim 21, wherein the selection of the plurality of the available exercises of the recovery pathway for the exercise session is at least partly based on an estimated amount of time that will remain in the exercise session based after at least one other selected exercise is performed by the patient and based on an amount of time the patient has indicated the patient has available for the exercise session.

30. The patient recovery system of claim 21, wherein the selection of the plurality of the available exercises of the recovery pathway for the exercise session is at least partly based on an actual amount of time that remains in the exercise session after at least one other selected exercise is performed by the patient and based on an amount of time the patient has indicated the patient has available for the exercise session.

31. The patient recovery system of claim 21, wherein the selection of the plurality of the available exercises of the recovery pathway for the exercise session is at least partly based on the recovery stage of the patient, a designated weight associated with each category, and an indicated amount of time.

32. The patient recovery system of claim 17, which includes causing the patient access device to display different possible responses in a color-coded scale to designated survey questions.

33. A patient recovery system for assisting a patient in recovery from a physical injury, said patient recovery system comprising:
at least one server configured to communicate over a data network with at least one patient access device and at least one healthcare provider access device to:
(a) enable a healthcare provider to enroll a patient for customized interactive exercise sessions for recovery of the physical injury incurred by the patient;
(b) enable the healthcare provider to select a recovery pathway for the patient, the recovery pathway including a plurality of exercises for recovery from the physical injury, wherein a plurality of the exercises are initially available for selection;
(c) enable the healthcare provider to monitor the patient's performance of the selected exercises of the recovery pathway;
(d) enable the patient to access each exercise session, and to watch, read or listen to exercise instructional content for each exercise of each exercise session to enable the patient to perform the exercise;
(e) enable the patient to provide feedback regarding each exercise of each exercise session; and
(f) after a first one of the exercises of a first one of the exercise sessions, change availability of at least one exercise for one of the exercise sessions based on feedback provided by the patient regarding said exercise of said exercise session.

34. The patient recovery system of claim 33 wherein the exercises of the recovery pathway are organized by categories, each category includes one or more exercises, each exercise is associated with a predefined level of difficulty for that recovery pathway, and each category is part of at least one recovery stage for the patient.

35. The patient recovery system of claim 34, wherein the availability for selection of the plurality of the exercises of the recovery pathway for the exercise session is at least partly based on the recovery stage of the patient.

36. The patient recovery system of claim 34, wherein the availability for selection of the plurality of the exercises of the recovery pathway for the exercise session is at least partly based on the availability of the categories to select exercises from.

37. The patient recovery system of claim 34, wherein the availability for selection of the plurality of the exercises of the recovery pathway for the exercise session is at least partly based on the level of difficulty associated with each of the exercises.

38. The patient recovery system of claim 34, wherein the availability for selection of the plurality of the exercises of the recovery pathway for the exercise session is at least partly based on a determination of the categories available to be selected from based on progress of the patient performing the exercises of the categories of the recovery pathway.

39. The patient recovery system of claim 34, wherein the selection of the plurality of the available exercises of the recovery pathway for the exercise session is at least partly based on an indicated amount of time.
